(19) United States
(12) Patent Application Publication
(10) Pub. No.: US 2025/0215025 A1
(43) Pub. Date: Jul. 3, 2025

(54) FLUORINE ATOM CONTAINING SILANE COMPOUND

(71) Applicant: DAIKIN INDUSTRIES, LTD., Osaka (JP)

(72) Inventors: Shinya TAKANO, Osaka (JP); Shinya HANDA, Osaka (JP); Motoshi MATSUI, Osaka (JP); Manami HARA, Osaka (JP); Hiroki KUBOTA, Osaka (JP); Takashi NOMURA, Osaka (JP); Fumihiko YAMAGUCHI, Osaka (JP)

(73) Assignee: DAIKIN INDUSTRIES, LTD., Osaka (JP)

(21) Appl. No.: 19/080,085

(22) Filed: Mar. 14, 2025

Related U.S. Application Data
(63) Continuation of application No. PCT/JP2023/040307, filed on Nov. 8, 2023.

(30) Foreign Application Priority Data
Nov. 8, 2022 (JP) 2022-179021

(51) Int. Cl. C07F 7/18; C08G 77/54; C09D 183/14

(52) U.S. Cl. CPC C07F 7/1804; C08G 77/54; C09D 183/14

(57) ABSTRACT

A fluorine atom containing silane compound represented by the formula (1). The symbol is as defined in the description.

(Rf¹)_{α1}—X^{A}—(R^{Si})_{α2} (1)

### CROSS-REFERENCE TO RELATED APPLICATIONS

This application is a Rule 53(b) Continuation of International Application No. PCT/JP2023/040307 filed Nov. 8, 2023, which claims priority based on Japanese Patent Application No. 2022-179021 filed Nov. 8, 2022, the respective disclosures of which are incorporated herein by reference in their entirety.

### TECHNICAL FIELD

The present invention relates to a fluorine atom containing silane compound.

### BACKGROUND ART

Certain types of silane compounds are known to be capable of providing excellent water- and oil-repellency, when used in surface treatment of a substrate (Patent Literature 1).

### CITATION LIST

### Patent Literature

Patent Literature 1: JP 2019-44179 A

### SUMMARY

The present disclosure provides as follows: [1] A fluorine atom containing silane compound represented by the following formula (1):

(Rf¹)_{α1}—X^{A}—(R^{Si})_{α2} (1)
wherein
Rf¹ each independently has at least one group selected from a monovalent organic group having A¹_{γ11}A²_{γ12}C— and a monovalent organic group containing a cyclic structure containing CF≡;
A1 is a fluorine atom;
A² is each independently a hydrogen atom, a chlorine atom, or a bromine atom;
γ11 is each independently 1 or 2;
γ12 is each independently 1 or 2;
the sum of γ11 and γ12 is 3;
X^{A} is each independently a single bond, an oxygen atom, or a di- to decavalent organic group;
R^{Si} is a monovalent group containing a Si atom to which a hydroxyl group or a hydrolyzable group is bonded;
α1 is an integer of 1 to 9; and
α2 is an integer of 1 to 9.

### Advantageous Effect

According to the present disclosure, there can be provided a new fluorine atom containing silane compound.

### DESCRIPTION OF EMBODIMENTS

The term “monovalent organic group” as used herein refers to a carbon containing monovalent group. The monovalent organic group is not limited, and may be a hydrocarbon group or a derivative thereof. The derivative of a hydrocarbon group refers to a group that has one or more of N, O, S, Si, amide, sulfonyl, siloxane, carbonyl, carbonyloxy, and the like at an end or in the molecular chain of the hydrocarbon group.

The term “divalent organic group” as used herein is not limited, and examples thereof include a divalent group obtained by further removing one hydrogen atom from the hydrocarbon group.

As used herein, the “hydrocarbon group” refers to a group containing carbon and hydrogen and a group in which a hydrogen atom is removed from a molecule. Such a hydrocarbon group is not limited, but examples thereof include a hydrocarbon group having 1 to 20 carbon atoms, such as an aliphatic hydrocarbon group and an aromatic hydrocarbon group. The “aliphatic hydrocarbon group” may be either linear, branched, or cyclic, and may be either saturated or unsaturated. The hydrocarbon group may contain one or more ring structures. Such a hydrocarbon group is optionally substituted with one or more substituents. Such a hydrocarbon group may have one or more of N, O, S, Si, amide, sulfonyl, siloxane, carbonyl, carbonyloxy, and the like at an end or in the molecular chain thereof.

The substituent of the “hydrocarbon group” as used herein is not limited, and examples thereof include a halogen atom; and one or more groups selected from a C₁₋₆ alkyl group, a C₂₋₆ alkenyl group, a C₂₋₆ alkynyl group, a C₃₋₁₀ cycloalkyl group, a C₃₋₁₀ unsaturated cycloalkyl group, a 5- to 10-membered heterocyclyl group, a 5- to 10-membered unsaturated heterocyclyl group, a C₆₋₁₀ aryl group, and a 5- to 10-membered heteroaryl group, each of which is optionally substituted with one or more halogen atoms.

The term “hydrolyzable group” as used herein refers to a group that can undergo a hydrolysis reaction, namely, refers to a group that can be removed from the main backbone of a compound by a hydrolysis reaction. Examples of the hydrolyzable group include —OR^{h}, —OCOR^{h}, —O—N═CR^{h2}, —NR^{h2}, —NHR^{h}, and —NCO (in these formulae, R^{h} represents a substituted or unsubstituted alkyl group having 1 to 4 carbon atoms), and —OR^{h}(that is, an alkoxy group) is preferred. Examples of R^{h} include an unsubstituted alkyl group such as a methyl group, an ethyl group, a propyl group, an isopropyl group, a n-butyl group, and an isobutyl group; and a substituted alkyl group such as a chloromethyl group. Among them, an alkyl group, in particular an unsubstituted alkyl group, is preferred, and a methyl group or an ethyl group is more preferred. In one embodiment, R^{h} is a methyl group, and in another embodiment, R^{h} is an ethyl group.

### [Fluorine Atom Containing Silane Compound]

The fluorine atom containing silane compound of the present disclosure is represented by the following formula (1).

(Rf¹)_{α1}—X^{A}—(R^{Si})_{α2} (1)
Rf¹ each independently has at least one group selected from a monovalent organic group having A¹_{γ11}A²_{γ12}C— and a monovalent organic group containing a cyclic structure containing a CF≡ group.
A¹ is a fluorine atom.
A² is each independently a hydrogen atom, a chlorine atom, or a bromine atom.

In one embodiment, A² is a hydrogen atom. In one embodiment, A² is a chlorine atom. In another embodiment, A² is a bromine atom.

A² is preferably a hydrogen atom.

In one embodiment, A¹_{γ11}A²_{γ12}C— is HF₂C—.

γ11 is each independently 1 or 2; and γ12 is each independently 1 or 2. However, the sum of γ11 and γ12 is 3.

In one embodiment, γ11 is 1. In one embodiment, γ11 is 2.

In one embodiment, γ12 is 1. In one embodiment, γ12 is 2.

The above “cyclic structure containing CF≡” is a structure in which the carbon atom has a fluorine atom and three linking parts, and the linking parts constitute part of the cyclic structure.

In one embodiment, Rf¹ is a monovalent organic group containing a cyclic structure containing CF≡, and is, for example, a monovalent organic group containing the following structure. * represents a bonding location.

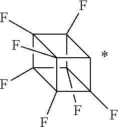 [SMILES: FC12C3C4(F)C1(F)C1(F)C2(F)C3(F)C41F]

In one embodiment, Rf¹ is a group represented by A¹_{γ11}A²_{γ12}C—X^{B}—.

A¹, A², γ11, and γ12 are the same as defined above.

X^{B} is a single bond, a divalent group containing a polysiloxane group, or a group represented by —(CR^{A1}ₑ₁H₂₋ₑ₁)ₐ₁—(CFH)_{b1}—(CH₂)_{c1}—(O)_{d1}—. Note that X^{B} is bonded to A¹_{γ11}A²_{γ12}C— on its left side and to —X^{A}— on its right side, respectively.

Specific examples of Rf¹ include the following groups. In the following formulae, * represents the bonding position with X^{A}.

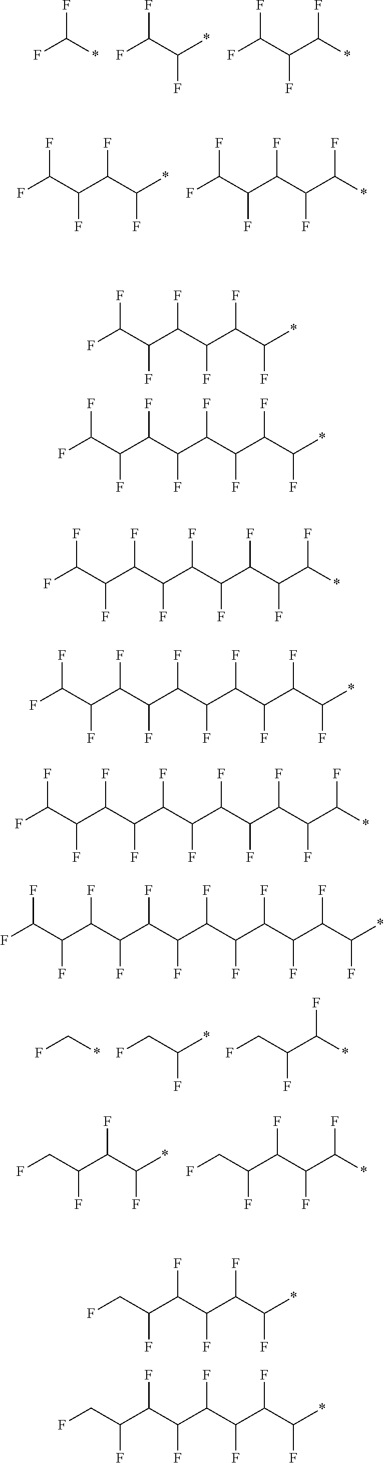

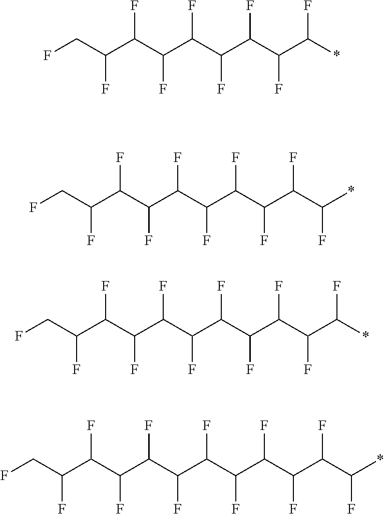 [SMILES: *C(F)C(F)C(F)C(F)C(F)C(F)C(F)C(F)CF ; *C(F)C(F)C(F)C(F)C(F)C(F)C(F)C(F)C(F)CF ; *C(F)C(F)C(F)C(F)C(F)C(F)C(F)C(F)C(F)C(F)CF ; *C(F)C(F)C(F)C(F)C(F)C(F)C(F)C(F)C(F)C(F)C(F)CF]

In X^{B}
R^{A1} is a monovalent organic group having A¹_{γ11}A²_{y12}C—;
e1 is 1 or 2;
a1 is an integer of 0 to 200;
b1 is an integer of 0 to 200;
c1 is an integer of 0 to 200;
d1 is an integer of 0 to 200; and
the occurrence order of the respective repeating units enclosed in parentheses provided with the signs a1, b1, c1, and d1 is not limited. Preferably, X^{B} does not contain a structure in which two or more oxygen atoms are continuously bonded.

In one embodiment, X^{B} is a group represented by —(CR^{A1}ₑ₁H₂₋ₑ₁)ₐ₁—(CFH)_{b1}—(CH₂)_{c1}—(O)_{d1}—.
R^{A1}, e1, a1, b1, c1, and d1 are the same as defined above. The occurrence order of the respective repeating units enclosed in parentheses provided with the signs a1, b1, c1, and d1 is not limited.

In one embodiment, R^{A1} is HCF₂— or HCF₂O—.

In one embodiment, e1 is 1, and in another embodiment, e1 is 2.

In one embodiment, a1 is 0 or 1.

In one embodiment, b1 is an integer of 0 to 6.

In one embodiment, c1 is an integer of 0 to 30.

In one embodiment, d1 is an integer of 0 to 10, and in another embodiment, d1 is an integer of 0 to 3.

In one embodiment, e1 is 1 or 2, a1 is 0 or 1, b1 is an integer of 0 to 200, c1 is an integer of 0 to 200, and d1 is an integer of 0 to 10. The occurrence order of the respective repeating units enclosed in parentheses provided with the signs a1, b1, c1, and d1 is not limited.

In one embodiment, e1 is 1 or 2, a1 is 0 or 1, b1 is an integer of 0 to 6, c1 is an integer of 0 to 30, and d1 is an integer of 0 to 3. The occurrence order of the respective repeating units enclosed in parentheses provided with the signs a1, b1, c1 and d1 is not limited.

In one embodiment, X^{B} is a group represented by —(CFH)_{b1}—(CH2)_{c1}—(O)_{d1}—.

b1, c1, and di are the same as defined above. The occurrence order of the respective repeating units enclosed in parentheses provided with the signs b1, c1, and d1 is not limited.

Preferably, b1 and c1 are the same as defined above, and d1 is an integer of 0 to 10, and more preferably, b1 is an integer of 0 to 6, c1 is an integer of 0 to 30, and d1 is an integer of 0 to 3.

In one embodiment, X^{B} is a group represented by —(CR^{A1}ₑ₁H₂₋ₑ₁)ₐ₁—(CH₂)_{c1}—. R^{A1}, e1, a1, and c1 are the same as defined above.

In one embodiment, X^{B} is a group represented by —(CH₂)_{c1}—. c1 is the same as defined above. Preferably, c1 is an integer of 0 to 30. In one embodiment, c1 is an integer of 1 to 9.

In one embodiment, c1 is an integer of 10 to 25.

In one embodiment, X^{B} is a group represented by —(CR^{A1}ₑ₁H₂₋ₑ₁)ₐ₁—O—(CH₂)_{c1}—.

R^{A1}, e1, a1, and c1 are the same as defined above.

In one embodiment, X^{B} is a group represented by —O—(CH₂)_{c1}—.

c1 is the same as defined above. Preferably, c1 is an integer of 0 to 30.

In one embodiment, X^{B} is a group represented by —(CR^{A1}ₑ₁H₂₋ₑ₁)ₐ₁—(CH₂)_{c1}—O—.

R^{A1}, e1, a1, and c1 are the same as defined above.

In one embodiment, X^{B} is a group represented by —(CH2)_{c1}—O—.

c1 is the same as defined above. In one embodiment, c1 is an integer of 0 to 30, and in one embodiment, c1 is an integer of 0 to 10.

In one embodiment, X^{B} is a group represented by —(CH₂)_{c10}—O—(CH₂)_{c10}—. c10 is each independently an integer of 0 to 200. However, the total number of carbon atoms in X^{B} is an integer of 0 to 200. For example, c10 is each independently an integer of 0 to 30.

In one embodiment, X^{B} is a divalent group containing a polysiloxane group, and contains a structure in which two silicon atoms are bonded via oxygen (—Si—O—Si—). X^{B} is preferably a group represented by —R^{k31}— (CH₂)_{g1}—SiR^{s}₂O(—SiR^{s}₂O—)ₙ₁₁SiR^{s}₂—R^{k32}—, and more preferably a group represented by (CH₂)_{g1}—SiR^{s}₂O(—SiR^{s}₂O—)ₙ₁₁SiR^{s}₂—(CH₂)_{g1}—.

R^{k31} is a single bond or a C₁₋₂₀₀ alkylene group, and is, for example, a single bond.

R^{k32} is a single bond or a C₁₋₂₀₀ alkylene group, and is, for example, a C₁₋₁₀ alkylene group.

The sum of the number of carbon atoms contained in R^{k31} and the number of carbon atoms contained in R^{k32} is 0 to 200.

g1 is each independently an integer of 0 to 30. g1 is, for example, an integer of 1 to 30, specifically, an integer of 1 to 10, and more specifically, an integer of 1 to 3. In one embodiment, g1 is 0.

R^{s} is each independently a hydrogen atom, a hydroxyl group, or a hydrocarbon group; and

n11 is an integer of 1 to 1,500.

Examples of the above hydrocarbon group may include a C₁₋₃ alkyl group.

Specifically, examples of —SiR²₂O(—SiR^{s}₂O—)ₙ₁₁SiR^{s}₂— may include a polydimethylsiloxane group and a polydiethylsiloxane group.

In one embodiment, X^{B} is a group represented by —(CH₂)_{c11}—(O(CH₂)_{c12})_{c13}—.

c11 is an integer of 0 to 200, c12 is an integer of 0 to 200, and c13 is an integer of 0 to 200. The number of carbon atoms contained in X^{B} is an integer of 0 to 200. For example, c12 and c13 are each an integer of 1 or more.

For example, c11 is an integer of 1 to 4, c12 is an integer of 1 to 10, and c13 is an integer of 1 to 150.

In one embodiment, the number of carbon atoms contained in X^{B} is an integer of 1 to 150.

In one embodiment, c11 is an integer of 0 to 20, c12 is an integer of 1 to 6, c13 is an integer of 0 to 150, preferably c13 is an integer of 1 to 50, and the number of carbon atoms contained in X^{B} is an integer of 1 to 150.

In one embodiment, c11 is an integer of 1 to 30, c12 is an integer of 1 to 3, and c13 is an integer of 2 to 150, such as an integer of 2 to 50.

In one embodiment, A¹_{γ11}A²_{γ12}C— is HCF₂—.

In one embodiment, the fluorine atom containing silane compound does not contain a —CF₃ group and a —CF₂— group.

In one embodiment, the fluorine atom containing silane compound contains a fluorine atom only in Rf¹.

α1 is an integer of 1 to 9, and α2 is an integer of 1 to 9. These α1 and α2 may vary depending on the valence of X^{A}. The sum of α1 and α2 is the same as the valence of X^{A}. For example, when X^{A} is a decavalent organic group, the sum of α1 and α2 is 10; for example, a case where α1 is 9 and α2 is 1, al is 5 and α2 is 5, or α1 is 1 and α2 is 9 can be considered. Also, when X^{A} is a divalent organic group, α1 and α2 are 1.

X^{A} is a single bond, an oxygen atom, or a di- to decavalent organic group. Note that X^{A} is bonded to Rf¹ on its left side and to R^{Si} on its right side, respectively.

X^{A} is interpreted as a linker connecting the Rf¹ moiety to the moiety that provides a binding ability to the substrate (R^{Si} moiety). Accordingly, such X^{A} may be a single bond, an oxygen atom, or any organic group as long as the compound represented by the formula (1) can stably exist.

X^{A} is each independently optionally substituted with one or more substituents selected from a fluorine atom, a C₁₋₃ alkyl group, and a C₁₋₃ fluoroalkyl group (preferably a C₁-3 perfluoroalkyl group). In one embodiment, X^{A} is unsubstituted.

The di- to decavalent organic group in X^{A} is preferably a di- to octavalent organic group. In one embodiment, such a di- to decavalent organic group is preferably a di- to tetravalent organic group, and more preferably a divalent organic group. In another embodiment, such a di- to decavalent organic group is preferably a tri- to octavalent organic group, and more preferably a tri- to hexavalent organic group.

In one embodiment, X^{A} is a single bond.

In one embodiment, X^{A} is an oxygen atom.

In one embodiment, X^{A} is a di- to decavalent organic group.

In one embodiment, X^{A} is a single bond or a divalent organic group, and α1 and α2 are 1.

In one embodiment, X^{A} is a divalent organic group, and α1 and α2 are 1.

In one embodiment, X^{A} is a tri- to hexavalent organic group, α1 is 1, and α2 is 2 to 5.

In one embodiment, X^{A} is a trivalent organic group, α1 is 1, and α2 is 2.

In one embodiment, X^{A} is a trivalent organic group, α1 is 2, and α2 is 1.

In one embodiment, X^{A} is a single bond, —(X⁵²)₁₅—, or is represented by the following formula (X^{A1}):

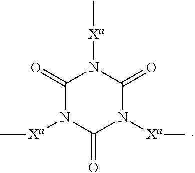

X⁵² is each independently a group selected from —O—, —S—, o-, m- or p-phenylene group, —CO—, —C(O)O—, —OC(O)—, —CONR⁵³—, —NR⁵³CO—, —O—CONR⁵³—, —NR⁵³CO—O—, —NR⁵³CONR⁵³—, —NR⁵³—, and —(CH₂)ₙ₅—.

R⁵³ is each independently a hydrogen atom or a monovalent organic group, and is preferably a hydrogen atom, a phenyl group, a C₁₋₆ alkyl group (preferably a methyl group), or an oxyalkylene containing group having 1 to 10 carbon atoms.

n5 is each independently an integer of 1 to 200. n5 is, for example, an integer of 1 to 30, specifically an integer of 1 to 20, and more specifically an integer of 1 to 15, an integer of 1 to 10, or an integer of 1 to 6, such as an integer of 1 to 3. In one embodiment, n5 is an integer of 10 to 200, such as an integer of 10 to 30. In one embodiment, n5 is an integer of 1 to 9.

l5 is an integer of 1 to 10, preferably an integer of 1 to 5, and more preferably an integer of 1 to 3.

The oxyalkylene containing group having 1 to 10 carbon atoms is a group containing a —O—C₁₋₁₀ alkylene-, and is, for example, —R⁵⁵—(—O—C₁₋₁₀ alkylen)ₙ—R⁵⁶ (wherein R⁵⁵ is a single bond or a divalent organic group, preferably a C₁₋₆ alkylene group, n is an arbitrary integer, preferably an integer of 2 to 10, and R⁵⁶ is a hydrogen atom or a monovalent organic group, preferably a C₁₋₆ alkyl group). The alkylene group may be linear or may be branched.

X^{a} is a single bond or divalent linking group directly bonded to the isocyanuric ring. X^{a} is preferably a single bond, an alkylene group, or a divalent group containing at least one bond selected from the group consisting of an ether bond, an ester bond, an amide bond, and a sulfide bond, and more preferably a single bond, an alkylene group having 1 to 10 carbon atoms, or a divalent hydrocarbon group having 1 to 10 carbon atoms and containing at least one bond selected from the group consisting of an ether bond, an ester bond, an amide bond, and a sulfide bond. X^{a} is bonded to the isocyanuric ring on its left side.

One to two groups having X^{a} are bonded to the Rf¹ group, and one to two groups having X^{a} are bonded to the R^{Si} group. The total number of groups having X^{a} is 3. In one embodiment, one group having X^{a} is bonded to the Rf¹ group and two groups having X^{a} are bonded to the R^{Si} group. In one embodiment, two groups having X^{a} are bonded to the Rf¹ group and one group having X^{a} is bonded to the R^{Si} group.

X^{a} is still more preferably a group represented by the following formula:

(CX¹²¹X¹²²)ₓ₁—(X^{a11})_{y1}—(CX¹²³X¹²⁴)_{z1}—
wherein
X¹²¹ to X¹²⁴ are each independently H, OH, or —OSi(OR¹²¹)₃ (wherein three R¹²¹ groups are each independently an alkyl group having 1 to 4 carbon atoms);
X^{a11} is —C(═O)NH—, —NHC(═O)—, —O—, —C(═O)O—, —OC(═O)—, —OC(═O)O—, —NHC(═O)NH—, —NR¹²²—, —C(═O)—NR¹²²—, —NR¹²²—C(═O)—, or S (each bond is bonded to CX¹²¹X¹²² on its left side);
R¹²² is a C₁₋₆ hydrocarbon chain, preferably a C₁₋₆ alkyl group; and
x1 is an integer of 0 to 10, y1 is 0 or 1, and z1 is an integer of 1 to 10. In another embodiment, R¹²² is a hydrogen atom.

As X^{a11}, —O—, —C(═O)O—, or —C(═O)NH— is preferred.

As X^{a}, the groups represented by the following formulae are preferred:

—(CH₂)ₘ₁₂—O—(CH₂)ₘ₁₃—
wherein m12 is an integer of 1 to 10, and m13 is an integer of 1 to 10;

(CH₂)ₘ₁₅—O—CH₂CH(OH)—(CH₂)ₘ₁₆—
wherein m15 is an integer of 1 to 10, and m16 is an integer of 1 to 10;

—(CH₂)ₘ₁₈—
wherein m18 is an integer of 1 to 10; or

(CH₂)ₘ₂₀O—CH₂CH(OSi(OCH₃)₃)—(CH₂)ₘ₂₁—
wherein m20 is an integer of 1 to 10, and m21 is an integer of 1 to 10.

X^{a} is not limited, and examples thereof include —CH₂—, —C₂H₄—, —C₃H₆—, —C₄H₃—, —C₄H₃—O—CH₂—, —CO—O—CH₂—CH(OH)—CH₂—, —S—, —NR⁵³—, —(CH₂)ₘ₂₂—C(═O)—O—(CH₂)ₘ₂₃—, —(CH₂)ₘ₂₂—O—C(═O)—(CH₂)ₘ₂₃—, —(CH₂)ₘ₂₂—C(═O)—NR⁵³—(CH₂)ₘ₂₃—, and —(CH₂)ₘ₂₂—NR⁵³—C(═O)—(CH₂)ₘ₂₃—CH₂OCH₂CH(OSi(OCH₃)₃)CH₂— (wherein R⁵³ is the same as defined above, and is preferably a hydrogen atom or a C₁₋₆ hydrocarbon chain (for example, a C₁₋₆ alkyl group, specifically a methyl group), m22 is an integer of 1 to 10, and m23 is an integer of 1 to 10).

When X^{A} is a single bond, an oxygen atom, or a divalent organic group, the formula (1) is represented by the following formula (1′).

Rf¹—X^{A}—R^{Si—} (1′)

X^{A} is preferably a single bond or a divalent organic group.

In one embodiment, X^{A} is each independently represented by —(X⁵²)₁₅—R⁵²—. R⁵² is a single bond, —(CH₂)ₜ₅—, or o-, m- or p-phenylene group, and is preferably —(CH₂)ₜ₅—. t5 is an integer of 1 to 20, preferably an integer of 2 to 6, and more preferably an integer of 2 to 3. Here, R⁵² (typically a hydrogen atom in R⁵²) is optionally substituted with one or more substituents selected from a fluorine atom, a C₁₋₃ alkyl group, and a C₁₋₃ fluoroalkyl group. In a preferred embodiment, R⁵² is not substituted with any of these groups.

For example, X^{A} may be each independently
a single bond,
—CONR⁵³—(CH₂)ₙ₅—,
—(CH₂)ₙ₅—CONR⁵³—(CH₂)ₙ₅,
—(CH₂)ₙ₅—CONR⁵³—,
—(CH₂)ₙ₅—,
—OC(═O)—(CH₂)ₙ₅—,
—(CH₂)ₙ₅—OC(═O)—(CH₂)ₙ₅—,
—C(═O)—(CH₂)ₙ₅—,
—(CH₂)ₙ₅—C(═O)—(CH₂)ₙ₅—,
—C(═O)—(CH₂)ₙ₅—, or
—(CH₂)ₙ₅—C(═O)—(CH₂)ₙ₅—. R⁵³ and n5 are each the same as defined above.

In one embodiment, X^{A} may be each independently
a single bond,
—CONR⁵³—(CH₂)ₙ₅—,
—OC(═O)—(CH₂)ₙ₅—, or
—C(═O)—(CH₂)ₙ₅—.

In one embodiment, X⁵² is each independently a group selected from —S—, o-, m- or p-phenylene group, —CO—, —C(O)O—, —OC(O)—, —CONR⁵³—, —O—CONR⁵³—, —NR⁵³CO—, —O—CONR⁵³—, —NR⁵³CO—O—, and —NR⁵³—.

In one embodiment, X⁵² is —(CH₂)ₙ₅—CONR⁵³—.

In one embodiment, examples of X^{A} include a group represented by the following formula.

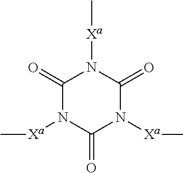

R^{Si} is a monovalent group containing a Si atom to which a hydroxyl group or a hydrolyzable group is bonded.

R^{Si} is a group represented by the following formula (S1), (S2), (S3), (S4), or (S5):

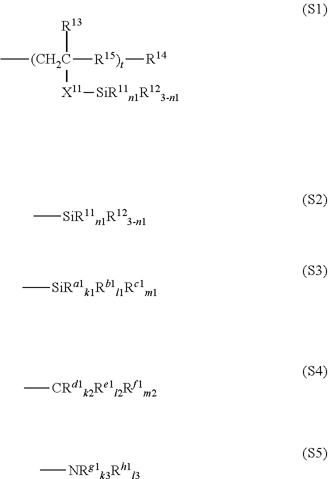

R¹¹ is each independently a hydroxyl group or a hydrolyzable group.

R₁₁ is preferably, each independently, a hydrolyzable group.

R¹² is each independently a monovalent organic group. R12 does not contain a hydrolyzable group.

In R¹², the monovalent organic group is preferably a C₁₋₂₀ alkyl group, more preferably a C₁₋₆ alkyl group, and still more preferably a methyl group.

n1 is each independently an integer of 0 to 3 for each (SiR¹¹ₙ₁R¹²₃₋ₙ₁) unit. In the formula (S1), at least two (SiR¹¹ₙ₁R¹²₃₋ₙ₁) units with n1 of 1 to 3 are present. In other words, in the formula (S1), at least two Si atoms to which a hydroxyl group or a hydrolyzable group is bonded are present.

n1 is each independently an integer of preferably 1 to 3, more preferably 2 to 3, and still more preferably 3 for each (SiR¹¹ₙ₁R¹²₃₋ₙ₁) unit.

In the above formula, X¹¹ is each independently a single bond or a divalent organic group. Such a divalent organic group is preferably —R²⁸—Oₓ—R²⁹— (wherein R²⁸ and R²⁹ are each independently a single bond or a C₁₋₂₀ alkylene group, and x is 0 or 1). Such a C₁₋₂₀ alkylene group may be linear or may be branched, and is preferably linear. Such a C1-2o alkylene group is preferably a C₁₋₁₀ alkylene group, more preferably a C₁₋₆ alkylene group, and still more preferably a C₁₋₃ alkylene group.

In one embodiment, X¹¹ is each independently a —C₁₋₆ alkylene-O—C₁₋₆ alkylene- or a —O—C₁₋₆ alkylene-.

In a preferred embodiment, X¹¹ is each independently a single bond or a linear C₁₋₆ alkylene group, preferably a single bond or a linear C₁₋₃ alkylene group, more preferably a single bond or a linear C₁₋₂ alkylene group, and still more preferably a linear C₁₋₂ alkylene group.

R¹³ is each independently a hydrogen atom or a monovalent organic group. Such a monovalent organic group is preferably a C₁₋₂₀ alkyl group.

In a preferred embodiment, R¹³ is each independently a hydrogen atom or a linear C₁₋₆ alkyl group, preferably a hydrogen atom or a linear C₁₋₃ alkyl group, and preferably a hydrogen atom or a methyl group.

R¹⁵ is each independently a single bond, an oxygen atom, a C₁₋₆ alkylene group, or a C₁₋₆ alkyleneoxy group.

In one embodiment, R¹⁵ is each independently an oxygen atom, a C₁₋₆ alkylene group, or a C₁₋₆ alkyleneoxy group.

In a preferred embodiment, R¹⁵ is a single bond. t is each independently an integer of 2 or more.

In a preferred embodiment, t is each independently an integer of 2 to 10, preferably an integer of 2 to 6.

R¹⁴ is each independently a hydrogen atom, a halogen atom, or —X^{1l}—SiR¹¹ₙ₁R¹²₃₋ₙ₁. Such a halogen atom is preferably an iodine atom, a chlorine atom, or a fluorine atom, and more preferably a fluorine atom. In a preferred embodiment, R¹⁴ is a hydrogen atom.

In one embodiment, the formula (S1) is the following formula (S1-a):

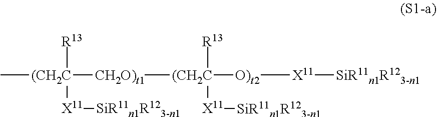

wherein
R¹¹, R¹², R¹³, X¹¹, and n1 have the same definition as described for the above formula (S1);
t1 and t2 are each independently an integer of 1 or more, preferably an integer of 1 to 10, and more preferably an integer of 2 to 10, such as an integer of 1 to 5 or an integer of 2 to 5; and
the occurrence order of the respective repeating units enclosed in parentheses provided with ti and t2 is not limited in the formula.

In a preferred embodiment, the formula (S1) is the following formula (S1-b):

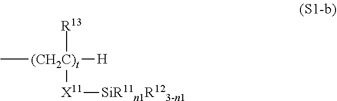

wherein R¹¹, R¹², R¹³, X¹¹, n1, and t have the same definition as described for the above formula (S1).

In a preferred embodiment, in the formula (S2), the Si atom in —SiR¹¹ₙ₁R¹²₃₋ₙ₁ does not form a siloxane bond.

In one embodiment, in the formula (S2), at least two Si atoms to which a hydroxyl group or a hydrolyzable group is bonded are present.

R^{a1} is each independently —Z¹—SiR²¹ₚ₁R²²_{q1}R²³ᵣ₁.

Z¹ is each independently an oxygen atom or a divalent organic group. Note that the structure denoted as Z¹ hereinafter is bonded to (SiR²¹ₚ₁R²²_{q1}R²³ᵣ₁) on its right side.

In a preferred embodiment, Z¹ is a divalent organic group.

In a preferred embodiment, Z¹ does not include a group that forms a siloxane bond with the Si atom to which Z¹ is bonded. Preferably, in the formula (S3), (Si—Z¹—Si) does not contain a siloxane bond.

Z¹ is preferably a C₁₋₆ alkylene group, —(CH₂)_{z1}—O—(CH₂)_{z2}— (wherein z1 is an integer of 0 to 6, such as an integer of 1 to 6, and z2 is an integer of 0 to 6, such as an integer of 1 to 6), or —(CH₂)_{z3}-phenylene-(CH₂)_{z4}— (wherein z3 is an integer of 0 to 6, such as an integer of 1 to 6, and z4 is an integer of 0 to 6, such as an integer of 1 to 6). Such a C₁₋₆ alkylene group may be linear or may be branched, and is preferably linear. These groups are optionally substituted with, for example, one or more substituents selected from a fluorine atom, a C₁₋₆ alkyl group, a C₂₋₆ alkenyl group, and a C₂₋₆ alkynyl group, and are preferably unsubstituted.

In a preferred embodiment, Z¹ is a C₁₋₆ alkylene group or —(CH₂)_{z3}-phenylene-(CH₂)_{z4}—, preferably -phenylene-(CH₂)_{z4}—.

In another preferred embodiment, Z¹ is a C₁₋₃ alkylene group. In one embodiment, Z¹ may be —CH₂CH₂CH₂—. In another embodiment, Z¹ may be —CH₂CH₂—.

R²¹ is each independently —Z^{1′}—SiR^{21′}_{p1′}R^{22′}_{q1′}R^{23′}_{r1′}.

Z^{1′} is each independently an oxygen atom or a divalent organic group. Note that the structure denoted as Z^{1′} hereinafter is bonded to (SiR^{21′}_{p1′}R^{22′}_{q1′}R^{23′}_{r1′}) on its right side.

In a preferred embodiment, Z^{1′} is a divalent organic group.

In a preferred embodiment, Z^{1′} does not include a group that forms a siloxane bond with the Si atom to which Z^{1′} is bonded. Preferably, in the formula (S3), (Si—Z¹—Si) does not contain a siloxane bond.

Z^{1′} is preferably a C₁₋₆ alkylene group, —(CH₂)_{z1′}—O—(CH₂)_{z2′}— (wherein z1′ is an integer of 0 to 6, such as an integer of 1 to 6, and z2′ is an integer of 0 to 6, such as an integer of 1 to 6), or —(CH₂)_{z3′}-phenylene-(CH₂)_{z4′}— (wherein z3′ is an integer of 0 to 6, such as an integer of 1 to 6, and z4′ is an integer of 0 to 6, such as an integer of 1 to 6). Such a C₁₋₆ alkylene group may be linear or may be branched, and is preferably linear. These groups are optionally substituted with, for example, one or more substituents selected from a fluorine atom, a C₁₋₆ alkyl group, a C₂₋₆ alkenyl group, and a C₂₋₆ alkynyl group, and are preferably unsubstituted.

In a preferred embodiment, Z^{1′} is a C₁₋₆ alkylene group or —(CH₂)_{z3′}-phenylene-(CH₂)_{z4′}—, preferably -phenylene-(CH₂)_{z4′}—.

In another preferred embodiment, Z^{1′} is a C₁₋₃ alkylene group. In one embodiment, Z^{1′} may be —CH₂CH₂CH₂—. In another embodiment, Z^{1′} may be —CH₂CH₂—.

R^{21′} is each independently —Z^{1″}—SiR^{22″}_{q1″}R^{23″}_{r1″}.

Z^{1″} is each independently an oxygen atom or a divalent organic group. Note that the structure denoted as Z^{1″} hereinafter is bonded to (SiR^{22″}_{q1″}R^{23″}_{r1″}) on its right side.

In a preferred embodiment, Z^{1″} is a divalent organic group.

In a preferred embodiment, Z^{1″} does not include a group that forms a siloxane bond with the Si atom to which Z^{1″} is bonded. Preferably, in the formula (S3), (Si—Z^{1″}—Si) does not contain a siloxane bond.

Z^{1″} is preferably a C₁₋₆ alkylene group, —(CH₂)_{z1″}—O—(CH₂)_{z2″}— (wherein z1″ is an integer of 0 to 6, such as an integer of 1 to 6, and z2″ is an integer of 0 to 6, such as an integer of 1 to 6), or —(CH₂)_{z3″}-phenylene-(CH₂)_{z4″}— (wherein z3″ is an integer of 0 to 6, such as an integer of 1 to 6, and z4″ is an integer of 0 to 6, such as an integer of 1 to 6). Such a C₁₋₆ alkylene group may be linear or may be branched, and is preferably linear. These groups are optionally substituted with, for example, one or more substituents selected from a fluorine atom, a C₁₋₆ alkyl group, a C₂₋₆ alkenyl group, and a C₂₋₆ alkynyl group, and are preferably unsubstituted.

In a preferred embodiment, Z^{1″} is a C₁₋₆ alkylene group or —(CH₂)_{z3″}-phenylene-(CH₂)_{z4″}—, preferably -phenylene-(CH₂)_{z4″}—. When Z^{1″} is such a group, light resistance, in particular ultraviolet resistance, can be further enhanced.

In another preferred embodiment, Z^{1″} is a C₁₋₃ alkylene group. In one embodiment, Z^{1″} may be —CH₂CH₂CH₂—. In another embodiment, Z^{1″} may be —CH₂CH₂—.

R^{22″} is each independently a hydroxyl group or a hydrolyzable group.

R^{22″} is preferably, each independently, a hydrolyzable group.

R^{23″} is each independently a monovalent organic group. Such a monovalent organic group is a monovalent organic group excluding the above hydrolyzable group.

In R^{23″}, the monovalent organic group is preferably a C₁₋₂₀ alkyl group, more preferably a C₁₋₆ alkyl group, and still more preferably a methyl group.

q1″ is each independently an integer of 0 to 3, and r1″ is each independently an integer of 0 to 3. Note that the sum of q1″ and r1″ is 3 in the (SiR^{22″}_{q1″}R^{23″}_{r1″}) unit.

q1″ is each independently an integer of preferably 1 to 3, more preferably 2 to 3, and still more preferably 3 for each (SiR²²_{q1″}R^{23″}_{r1″}) unit.

R^{22′} is each independently a hydroxyl group or a hydrolyzable group.

R^{22′} is preferably, each independently, a hydrolyzable group.

R^{23′} is each independently a monovalent organic group. Such a monovalent organic group is a monovalent organic group excluding the above hydrolyzable group.

In R^{23′}, the monovalent organic group is preferably a C₁₋₂₀ alkyl group, more preferably a C₁₋₆ alkyl group, and still more preferably a methyl group.

p1′ is each independently an integer 0 to 3, q1′ is each independently an integer of 0 to 3, and r1′ is each independently an integer of 0 to 3. Note that the sum of p′, q1′, and r1′ is 3 in the (SiR^{21′}_{p1′}R^{22′}_{q1′}R^{23′}_{r1′}) unit.

In one embodiment, p1′ is 0.

In one embodiment, p1′ may be each independently an integer of 1 to 3, an integer of 2 to 3, or 3 for each (SiR^{21′}_{p1′}R^{22′}_{q1′}R^{23′}_{r1′}) unit. In a preferred embodiment, p1′ is 3.

In one embodiment, q1′ is each independently an integer of 1 to 3, preferably an integer of 2 to 3, and more preferably 3 for each (SiR^{21′}_{p1′}R^{22′}_{q1′}R^{23′}_{r1′}) unit.

In one embodiment, p1′ is 0, and q1′ is each independently an integer of 1 to 3, preferably an integer of 2 to 3, and still more preferably 3 for each (SiR^{21′}_{p1′}R^{22′}_{q1′}R^{23′}_{r1′}) unit.

R²² is each independently a hydroxyl group or a hydrolyzable group.

R²² is preferably, each independently, a hydrolyzable group.

R²³ is each independently a monovalent organic group.

Such a monovalent organic group is a monovalent organic group excluding the above hydrolyzable group.

In R²³, the monovalent organic group is preferably a C₁₋₂₀ alkyl group, more preferably a C₁₋₆ alkyl group, and still more preferably a methyl group.

p1 is each independently an integer 0 to 3, ql is each independently an integer of 0 to 3, and r1 is each independently an integer of 0 to 3. Note that the sum of p1, q1, and r1 is 3 in the (SiR²¹ₚ₁R²²_{q1}R²³ᵣ₁) unit.

In one embodiment, p1 is 0.

In one embodiment, p1 may be each independently an integer of 1 to 3, an integer of 2 to 3, or 3 for each (SiR²¹ₚ₁R²²_{q1}R²³ᵣ₁) unit. In a preferred embodiment, p1 is 3.

In one embodiment, q1 is each independently an integer of 1 to 3, preferably an integer of 2 to 3, and more preferably 3 for each (SiR²¹ₚ₁R²²_{q1}R²³ᵣ₁) unit.

In one embodiment, p1 is 0, and q1 is each independently an integer of 1 to 3, preferably an integer of 2 to 3, and still more preferably 3 for each (SiR²¹ₚ₁R²²_{q1}R²³ᵣ₁) unit.

R^{b1} is each independently a hydroxyl group or a hydrolyzable group.

R^{b1} is preferably, each independently, a hydrolyzable group.

R^{c1} is each independently a monovalent organic group. Such a monovalent organic group is a monovalent organic group excluding the above hydrolyzable group.

In R^{c1}, the monovalent organic group is preferably a C₁₋₂₀ alkyl group, more preferably a C₁₋₆ alkyl group, and still more preferably a methyl group.

k1 is each independently an integer 0 to 3, 11 is each independently an integer of 0 to 3, and m1 is each independently an integer of 0 to 3. Note that the sum of k1, 11, and m1 is 3 in the (SiR^{a1}ₖ₁R^{b1}₁₁R^{c1}ₘ₁) unit.

In one embodiment, k1 is each independently an integer of 1 to 3, preferably 2 or 3, and more preferably 3 for each (SiR^{a1}ₖ₁R^{b1}₁₁R^{c1}ₘ₁) unit. In a preferred embodiment, k1 is 3.

In the formula (S3), at least two Si atoms to which a hydroxyl group or a hydrolyzable group is bonded are present.

In a preferred embodiment, in the end moiety of the formula (S3), at least two Si atoms to which a hydroxyl group or a hydrolyzable group is bonded are present.

In a preferred embodiment, the group represented by the formula (S3) has any one of —Z¹—SiR²²_{q1}R²³ᵣ₁ (wherein q1 is an integer of 1 to 3, preferably 2 or 3, and more preferably 3, and r1 is an integer of 0 to 2), —Z^{1′}—SiR^{22′}_{q1′}R^{23′}_{r1′} (wherein q1′ is an integer of 1 to 3, preferably 2 or 3, and more preferably 3, and r1′ is an integer of 0 to 2), and —Z^{1″}—SiR^{22″}_{g1″}R^{23″}_{r1″} (wherein q1″ is an integer of 1 to 3, preferably 2 or 3, and more preferably 3, and r1″ is an integer of 0 to 2). Z¹, Z^{1′}, Z^{1″}, R²², R²³, R^{22′}, R^{23′}, R^{22″}, and R^{23″} are the same as defined above.

In a preferred embodiment, when R^{21′} is present in the formula (S3), q1″ is an integer of 1 to 3, preferably 2 or 3, and more preferably 3 in at least one, preferably all of R^{21′} groups.

In a preferred embodiment, when R²¹ is present in the formula (S3), p1′ is 0, and q1′ is an integer of 1 to 3, preferably 2 or 3, and more preferably 3 in at least one, preferably all of R²¹ groups.

In a preferred embodiment, when R^{a1} is present in the formula (S3), p1 is 0, and q1 is an integer of 1 to 3, preferably 2 or 3, and more preferably 3 in at least one, preferably all of R^{a1} groups.

In a preferred embodiment, in the formula (S3), k1 is 2 or 3, preferably 3, p¹ is 0, and q1 is 2 or 3, preferably 3.

R^{d1} is each independently —Z²—CR³¹ₚ₂R³²_{q2}R³³ᵣ₂.

Z² is each independently a single bond, an oxygen atom, or a divalent organic group. Note that the structure denoted as Z² hereinafter is bonded to (CR³¹ₚ₂R³²_{q2}R³³ᵣ₂) on its right side.

In a preferred embodiment, Z² is a divalent organic group.

In a preferred embodiment, Z² does not contain a siloxane bond.

Z² is preferably a C₁₋₆ alkylene group, —(CH₂)_{z5}—O—(CH₂)_{z6}— (wherein z5 is an integer of 0 to 6, such as an integer of 1 to 6, and z6 is an integer of 0 to 6, such as an integer of 1 to 6), or —(CH₂)_{z7}-phenylene-(CH₂)_{z8}— (wherein z7 is an integer of 0 to 6, such as an integer of 1 to 6, and z8 is an integer of 0 to 6, such as an integer of 1 to 6). Such a C₁₋₆ alkylene group may be linear or may be branched, and is preferably linear. These groups are optionally substituted with, for example, one or more substituents selected from a fluorine atom, a C₁₋₆ alkyl group, a C₂₋₆ alkenyl group, and a C₂₋₆ alkynyl group, and are preferably unsubstituted.

In a preferred embodiment, Z² is a C₁₋₆ alkylene group or —(CH₂)_{z7}-phenylene-(CH₂)_{z8}—, preferably -phenylene-(CH₂)_{z}—. When Z² is such a group, light resistance, in particular ultraviolet resistance, can be further enhanced.

In another preferred embodiment, Z² is a C₁₋₃ alkylene group. In one embodiment, Z² may be —CH₂CH₂CH₂—. In another embodiment, Z² may be —CH₂CH₂—.

R³1 is each independently —Z^{2′}—CR^{32′}_{q2′}R^{33′}_{r2′}.

Z^{2′} is each independently a single bond, an oxygen atom, or a divalent organic group. Note that the structure denoted as Z^{2′} hereinafter is bonded to (CR^{32′}_{q2′}R^{33′}_{r2′}) on its right side.

In a preferred embodiment, Z^{2′} does not contain a siloxane bond.

Z^{2′} is preferably a C₁₋₆ alkylene group, —(CH₂)_{z5′}—O—(CH₂)_{z6′}— (wherein z5′ is an integer of 0 to 6, such as an integer of 1 to 6, and z6′ is an integer of 0 to 6, such as an integer of 1 to 6), or —(CH₂)_{z7′}-phenylene-(CH₂)_{z8′}— (wherein z7′ is an integer of 0 to 6, such as an integer of 1 to 6, and z8′ is an integer of 0 to 6, such as an integer of 1 to 6). Such a C₁₋₆ alkylene group may be linear or may be branched, and is preferably linear. These groups are optionally substituted with, for example, one or more substituents selected from a fluorine atom, a C₁₋₆ alkyl group, a C₂₋₆ alkenyl group, and a C₂₋₆ alkynyl group, and are preferably unsubstituted.

In a preferred embodiment, Z^{2′} is a C₁₋₆ alkylene group or (CH₂)_{z7′}-phenylene-(CH₂)_{z8′}—, preferably -phenylene-(CH₂)_{z8′}—. When Z^{2′} is such a group, light resistance, in particular ultraviolet resistance, can be further enhanced.

In another preferred embodiment, Z^{2′} is a C₁₋₃ alkylene group. In one embodiment, Z^{2′} may be —CH₂CH₂CH₂—. In another embodiment, Z^{2′} may be —CH₂CH₂—.

R^{32′} is each independently —Z³—SiR³⁴ₙ₂R³⁵₃₋ₙ₂.

Z³ is each independently a single bond, an oxygen atom, or a divalent organic group. Note that the structure denoted as Z³ hereinafter is bonded to (SiR³⁴ₙ₂R³⁵₃₋ₙ₂) on its right side.

In one embodiment, Z³ is an oxygen atom.

In one embodiment, Z³ is a divalent organic group.

In a preferred embodiment, Z³ does not contain a siloxane bond.

Z³ is preferably a C₁₋₆ alkylene group, —(CH₂)_{z5″}—O—(CH₂)_{z6″}— (wherein z5″ is an integer of 0 to 6, such as an integer of 1 to 6, and z6″ is an integer of 0 to 6, such as an integer of 1 to 6), or —(CH₂)_{z7″}-phenylene-(CH₂)_{z8″}— (wherein z7″ is an integer of 0 to 6, such as an integer of 1 to 6, and z8″ is an integer of 0 to 6, such as an integer of 1 to 6). Such a C₁₋₆ alkylene group may be linear or may be branched, and is preferably linear. These groups are optionally substituted with, for example, one or more substituents selected from a fluorine atom, a C₁₋₆ alkyl group, a C₂₋₆ alkenyl group, and a C₂₋₆ alkynyl group, and are preferably unsubstituted.

In a preferred embodiment, Z³ is a C₁₋₆ alkylene group or —(CH₂)_{z7″}-phenylene-(CH₂)_{z8″}—, preferably -phenylene-(CH₂)_{z8″}—. When Z³ is such a group, light resistance, in particular ultraviolet resistance, can be further enhanced.

In another preferred embodiment, Z³ is a C₁₋₃ alkylene group. In one embodiment, Z³ may be —CH₂CH₂CH₂—. In another embodiment, Z³ may be —CH₂CH₂—.

R³⁴ is each independently a hydroxyl group or a hydrolyzable group.

R³⁴ is preferably, each independently, a hydrolyzable group.

R³⁵ is each independently a monovalent organic group. Such a monovalent organic group is a monovalent organic group excluding the above hydrolyzable group.

In R³⁵, the monovalent organic group is preferably a C₁₋₂₀ alkyl group, more preferably a C₁₋₆ alkyl group, and still more preferably a methyl group.

In the above formula, n2 is each independently an integer of 0 to 3 for each (SiR³⁴ₙ₂R³⁵₃₋ₙ₂) unit. In the end moiety of the formula (S4), at least two (SiR³⁴ₙ₂R³⁵₃₋ₙ₂) units with n2 of 1 to 3 are present. In other words, in the end moiety of the formula (S4), at least two Si atoms to which a hydroxyl group or a hydrolyzable group is bonded are present.

n2 is each independently an integer of preferably 1 to 3, more preferably 2 to 3, and still more preferably 3 for each (SiR³⁴ₙ₂R³⁵₃₋ₙ₂) unit.

R^{33′} is each independently a hydrogen atom, a hydroxyl group, or a monovalent organic group. Such a monovalent organic group is a monovalent organic group excluding the above hydrolyzable group.

In R^{33′}, the monovalent organic group is preferably a C₁₋₂₀ alkyl group or —(C₃H₂ₛ)ₜ₁—(O—CₛH₂ₛ)ₜ₂—H (wherein s is an integer of 1 to 6, preferably an integer of 2 to 4, t1 is 1 or 0, preferably 0, and t2 is an integer of 1 to 20, preferably an integer of 2 to 10, and more preferably an integer of 2 to 6), more preferably a C₁₋₂₀ alkyl group, still more preferably a C₁₋₆ alkyl group, and particularly preferably a methyl group.

In one embodiment, R^{33′} is a hydroxyl group.

In another embodiment, R^{33′} is a monovalent organic group, preferably a C1-2o alkyl group, and more preferably a C₁₋₆ alkyl group.

q2′ is each independently an integer of 0 to 3, and r2′ is each independently an integer of 0 to 3. Note that the sum of q2′ and r2′ is 3 in the (CR^{32′}_{q2′}R^{33′}_{r2′}) unit.

q2′ is each independently an integer of preferably 1 to 3, more preferably 2 to 3, and still more preferably 3 for each (CR^{32′}_{q2′}R^{33′}_{r2′}) unit.

R³² is each independently —Z³—SiR³⁴ₙ₂R³⁵₃₋ₙ₂. Such —Z³—SiR³⁴ₙ₂R³⁵₃₋ₙ₂ has the same definition as described for R^{32′}.

R³³ is each independently a hydrogen atom, a hydroxyl group, or a monovalent organic group. Such a monovalent organic group is a monovalent organic group excluding the above hydrolyzable group.

In R³³, the monovalent organic group is preferably a C₁₋₂₀ alkyl group or —(C₃H₂ₛ)ₜ₁—(O—C₃H₂ₛ)ₜ₂—H (wherein s is each independently an integer of 1 to 6, preferably an integer of 2 to 4, t1 is 1 or 0, preferably 0, and t2 is an integer of 1 to 20, preferably an integer of 2 to 10, and more preferably an integer of 2 to 6), more preferably a C₁₋₂₀ alkyl group, still more preferably a C₁₋₆ alkyl group, and particularly preferably a methyl group.

In one embodiment, R³³ is a hydroxyl group.

In another embodiment, R³³ is a monovalent organic group, preferably a C₁₋₂₀ alkyl group, and more preferably a C₁₋₆ alkyl group.

p2 is each independently an integer of 0 to 3, q2 is each independently an integer of 0 to 3, and r2 is each independently an integer of 0 to 3. Note that the sum of p², q2, and r2 is 3 in the (CR³¹ₚ₂R³²_{q2}R³³ᵣ₂) unit.

In one embodiment, p2 is 0.

In one embodiment, p2 may be each independently an integer of 1 to 3, an integer of 2 to 3, or 3 for each (CR³¹ₚ₂R³²_{q2}R³³ᵣ₂) unit. In a preferred embodiment, p2 is 3.

In one embodiment, q2 is each independently an integer of 1 to 3, preferably an integer of 2 to 3, and more preferably 3 for each (CR³¹ₚ₂R³²_{q2}R³³ᵣ₂) unit.

In one embodiment, p2 is 0, and q2 is each independently an integer of 1 to 3, preferably an integer of 2 to 3, and still more preferably 3 for each (CR³¹ₚ₂R³²_{q2}R³³ᵣ₂) unit.

R^{e1} is each independently —Z³—SiR³⁴ₙ₂R³⁵₃₋ₙ₂. Such —Z³—SiR³⁴ₙ₂R³⁵₃₋ₙ₂ has the same definition as described for R^{32′}.

R^{f1} is each independently a hydrogen atom, a hydroxyl group, or a monovalent organic group. Such a monovalent organic group is a monovalent organic group excluding the above hydrolyzable group.

In R^{f1}, the monovalent organic group is preferably a C₁₋₂₀ alkyl group or —(C₃H₂ₛ)ₜ₁—(O—C₃H₂ₛ)ₜ₂—H (wherein s is each independently an integer of 1 to 6, preferably an integer of 2 to 4, t1 is 1 or 0, preferably 0, and t2 is an integer of 1 to 20, preferably an integer of 2 to 10, and more preferably an integer of 2 to 6), more preferably a C₁₋₂₀ alkyl group, still more preferably a C₁₋₆ alkyl group, and particularly preferably a methyl group.

In one embodiment, Rf¹ is a hydroxyl group.

In another embodiment, Rf¹ is a monovalent organic group, preferably a C₁₋₂₀ alkyl group, and more preferably a C₁₋₆ alkyl group.

k2 is each independently an integer 0 to 3, 12 is each independently an integer of 0 to 3, and m2 is each independently an integer of 0 to 3. Note that the sum of k2, 12, and m2 is 3 in the (CR^{d1}ₖ₂R^{e1}₁₂R^{f1}ₘ₂) unit.

In one embodiment, in each end moiety of the formula (S4), when (SiR³⁴ₙ₂R³⁵₃₋ₙ₂) units with n2 of 1 to 3, preferably 2 or 3, and more preferably 3 are present, (SiR³⁴ₙ₂R³⁵₃₋ₙ₂) units is 2 or more, such as 2 to 27, preferably 2 to 9, more preferably 2 to 6, still more preferably 2 to 3, and particularly preferably 3.

In a preferred embodiment, when R^{32′} is present in the formula (S4), n2 is an integer of 1 to 3, preferably 2 or 3, and more preferably 3 in at least one, preferably all of R^{32′} groups.

In a preferred embodiment, when R³² is present in the formula (S4), n2 is an integer of 1 to 3, preferably 2 or 3, and more preferably 3 in at least one, preferably all of R³² groups.

In a preferred embodiment, when R^{e1} is present in the formula (S4), n2 is an integer of 1 to 3, preferably 2 or 3, and more preferably 3 in at least one, preferably all of R^{a1} groups.

In a preferred embodiment, in the formula (S4), k2 is 0, l2 is 2 or 3, preferably 3, and n2 is 2 or 3, preferably 3.

R^{g1} and R^{h1} are each independently —Z⁴—SiR¹¹ₙ₁R¹²₃₋ₙ₁, —Z⁴—SiR^{a1}ₖ₁R^{b1}₁₁R^{c1}ₘ₁, or —Z⁴—CR^{d1}ₖ₂R^{e1}₁₂R^{f1}ₘ₂. Here, R¹¹, R¹², R^{a1}, R^{b2}, R^{c1}, R^{d1}, R^{e1}, R^{f1}, n1, k1, l1, m1, k2, l2, and m2 are the same as defined above.

In a preferred embodiment, R^{g1} and R^{h1} are each independently —Z⁴—SiR¹¹ₙ₁R¹²₃₋ₙ₁.

Z⁴ is each independently a single bond, an oxygen atom, or a divalent organic group. Note that the structure denoted as Z⁴ hereinafter is bonded to (SiR^{1l}ₙ₁R¹²₃₋ₙ₁) on its right side.

In one embodiment, Z⁴ is an oxygen atom.

In one embodiment, Z⁴ is a divalent organic group.

In a preferred embodiment, Z⁴ does not contain a siloxane bond.

Z⁴ is preferably a C₁₋₆ alkylene group, —(CH₂)_{z5″}—O—(CH₂)z_{6″}— (wherein z5″ is an integer of 0 to 6, such as an integer of 1 to 6, and z6″ is an integer of 0 to 6, such as an integer of 1 to 6), or —(CH₂)_{z7″}-phenylene-(CH₂)_{z8″}— (wherein z7″ is an integer of 0 to 6, such as an integer of 1 to 6, and z8″ is an integer of 0 to 6, such as an integer of 1 to 6). Such a C₁₋₆ alkylene group may be linear or may be branched, and is preferably linear. These groups are optionally substituted with, for example, one or more substituents selected from a fluorine atom, a C₁₋₆ alkyl group, a C₂₋₆ alkenyl group, and a C₂₋₆ alkynyl group, and are preferably unsubstituted.

In a preferred embodiment, Z⁴ is a C₁₋₆ alkylene group or —(CH₂)_{z7″}-phenylene-(CH₂)_{z8″}—, preferably -phenylene-(CH₂)_{z8″}—. When Z⁴ is such a group, light resistance, in particular ultraviolet resistance, can be further enhanced.

In another preferred embodiment, Z⁴ is a C₁₋₃ alkylene group. In one embodiment, Z⁴ may be —CH₂CH₂CH₂—. In another embodiment, Z⁴ may be —CH₂CH₂—.

In a preferred embodiment, the formulae (S1), (S2), (S3), (S4), and (S5) do not contain a siloxane bond.

In one embodiment, R^{Si} is a group represented by the formula (S3), (S4), or (S5).

In one embodiment, R^{Si} is a group represented by the formula (S3) or (S4).

In one embodiment, R^{Si} is a group represented by the formula (S4) or (S5).

In one embodiment, R^{Si} is a group represented by the formula (S1). In a preferred embodiment, the formula (S1) is a group represented by the formula (S1-b). In a preferred embodiment, in the formula, R¹³ is a hydrogen atom, X11 is a single bond or —R²⁸—Oₓ—R²⁹— (wherein R²⁸ and R²⁹ are each independently a single bond or a C₁₋₂₀ alkylene group, and x is 0 or 1), and nl is 1 to 3, preferably 2 to 3, and still more preferably 3.

In one embodiment, R^{Si} is a group represented by the formula (S2). In a preferred embodiment, the formula (S2) is —Si^{R11}₂R¹² or —SiR¹¹₃.

In one embodiment, R^{Si} is a group represented by the formula (S3). In a preferred embodiment, the formula (S3) is —SiR^{a1}₂R^{c1} or —SiR^{a1}₃, R^{a1} is —Z¹—SiR²²_{q1}R²³ᵣ₁, Z¹ is a C₁₋₆ alkylene group, —(CH₂)_{z1}—O—(CH₂)_{z2}— (wherein z1 is an integer of 0 to 6, such as an integer of 1 to 6, and z2 is an integer of 0 to 6, such as an integer of 1 to 6), or —(CH₂)_{z3}-phenylene-(CH₂)_{z4}— (wherein z3 is an integer of 0 to 6, such as an integer of 1 to 6, and z4 is an integer of 0 to 6, such as an integer of 1 to 6), preferably a C₁₋₆ alkylene group, and q1 is 1 to 3, preferably 2 to 3, and still more preferably 3.

In one embodiment, R^{Si} is a group represented by the formula (S4). In a preferred embodiment, the formula (S4) is —CR^{e1}₂R^{f1} or —CR^{e1}₃, R^{e1} is —Z³—SiR³⁴ₙ₂R³⁵₃₋ₙ₂, Z³ is a C₁₋₆ alkylene group, —(CH₂)_{z5″}—O—(CH₂)_{z6″}— (wherein z5″ is an integer of 0 to 6, such as an integer of 1 to 6, and z6″ is an integer of 0 to 6, such as an integer of 1 to 6), or —(CH₂)_{z7″}-phenylene-(CH₂)_{z8″}— (wherein z7″ is an integer of 0 to 6, such as an integer of 1 to 6, and z8″ is an integer of 0 to 6, such as an integer of 1 to 6), preferably a C₁₋₆ alkylene group, and n2 is 1 to 3, preferably 2 to 3, and still more preferably 3.

In one embodiment, R^{Si} is a group represented by the formula (S5). In a preferred embodiment, R^{g1} and R^{h1} are —Z⁴—SiR¹¹ₙ₁R¹²₃₋ₙ₁, Z⁴ is a C₁₋₆ alkylene group, —(CH₂)_{z5″}—O—(CH₂)_{z6″}— (wherein z5″ is an integer of 0 to 6, such as an integer of 1 to 6, and z6″ is an integer of 0 to 6, such as an integer of 1 to 6), or —(CH₂)_{z7″}-phenylene-(CH₂)_{z8″}— (wherein z7″ is an integer of 0 to 6, such as an integer of 1 to 6, and z8″ is an integer of 0 to 6, such as an integer of 1 to 6), preferably a C₁₋₆ alkylene group, and n1 is 1 to 3, preferably 2 to 3, and still more preferably 3.

The fluorine atom containing silane compound represented by the above formula (1) is not limited, and it may have a number average molecular weight of 1×10² to 1×10⁵. It is preferable that the fluorine atom containing silane compound represented by the above formula (1) has a number average molecular weight of preferably 100 to 30,000, and more preferably 100 to 10,000, from the viewpoint of friction durability. Note that such a “number average molecular weight” is defined as a value obtained by ¹H-NMR measurement.

Examples of the fluorine atom containing silane compound represented by the formula (1) include those with the following structures.

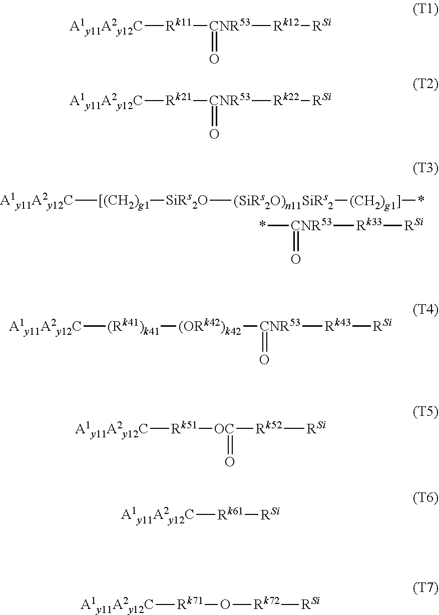

A¹, A², γ11, and γ12 are the same as defined above.

Preferably, A¹_{γ11}A²_{y12}C— is HF₂C—.

R⁵³ is a hydrogen atom or a monovalent organic group.

Examples thereof include a hydrogen atom and a methyl group.

R^{Si} is the same as defined above.

In the formula (T1), A¹_{γ11}A²_{y12}C—R^{k11}— and —C(═O)NR⁵³—R^{k12}— correspond to Rf¹ and X^{A}, respectively.

R^{k11} is a single bond or a C₁₋₉ alkylene group, and is, for example, a single bond.

R^{k12} is a single bond or a C₁₋₃₀ alkylene group, and is, for example, a C₁₋₁₀ alkylene group.

In the formula (T2), A¹_{y11}A²_{y12}C—R^{k21}— and —C(═O)NR⁵³—R^{k22}— correspond to Rf¹— and —X^{A}—, respectively.

R^{k21} is a single bond or a C₁₀₋₂₀₀ alkylene group, and is, for example, a C₁₀₋₃₀ alkylene group.

R^{k22} is a single bond or a C₁₋₂₀₀ alkylene group, and is, for example, a C₁₋₁₀ alkylene group.

In the formula (T3), A¹_{y11}A²_{y12}C—[(CH₂)_{g1}—SiR^{s}₂O—(SiR^{s}₂O)ₙ₁₁—SiR^{s}₂—(CH₂)_{g1}]— and —C(═O)NR⁵³—R^{k33}— correspond to Rf¹— and —X^{A}—, respectively.

g1 is each independently an integer of 0 to 30.

R^{k33} is a single bond or a C₁₋₂₀₀ alkylene group, and is, for example, a C₁₋₁₀ alkylene group.

However, the sum of the number of carbon atoms and g1 is 0 to 200.

R^{s} and n11 are the same as defined above.

In the formula (T4), A¹_{γ11}A²_{γ12}C—(R^{k41})ₖ₄₁—(OR^{k42})ₖ₄₂— and —C(═O)NR⁵³—R^{k43}— correspond to Rf¹ and X^{A}, respectively.

R^{k41} and R^{k42} are each a single bond or an alkylene group.

k41 is 0 or 1.

k42 is an integer of 0 to 150.

The number of carbon atoms contained in —(R^{k41})ₖ₄₁—(OR^{k42})ₖ₄₂— is an integer of 1 to 150.

R^{k43} is a single bond or a C₁₋₂₀ alkylene group, and is, for example, a C₁₋₁₀ alkylene group.

R^{k41} is a single bond or a C₁₋₂₀ alkylene group, such as a methylene group or an ethylene group, k41 is 1, R^{k42} is a C₁₋₆ alkylene group, such as an ethylene group, and k42 is an integer of 1 to 50.

In the formula (T5), A¹_{y11}A²_{y12}C—R^{k51}— and —OC(═O)NR⁵³—R^{k52}— correspond to Rf¹ and X^{A}, respectively.

R^{k51} is a single bond or a C₁₋₂₀₀ alkylene group, and is, for example, a single bond or a C₁₋₁₀ alkylene group.

R^{k52} is a single bond or a C₁₋₂₀₀ alkylene group, and is, for example, a C₁₀₋₃₀ alkylene group.

In the formula (T6), A¹_{y11}A²_{y12}C—R^{k61}— corresponds to Rf¹.

R^{k61} is a C₁₋₂₀₀ alkylene group, and is, for example, a C₁₋₃₀ alkylene group.

In the formula (T7), A¹_{y11}A²_{y12}C—R^{k71}—O—R^{k72}— corresponds to Rf¹.

R^{k71} and R^{k72} are each independently a single bond or a C₁₋₂₀₀ alkylene group. However, the total number of carbon atoms in R^{k71} and R^{k72} is an integer of 0 to 200. For example, R^{k71} and R^{k72} are each independently a single bond or a C₁₋₃₀ alkylene group.

Specific examples of the fluorine atom containing silane compound represented by the formula (1) include those with the following structures.

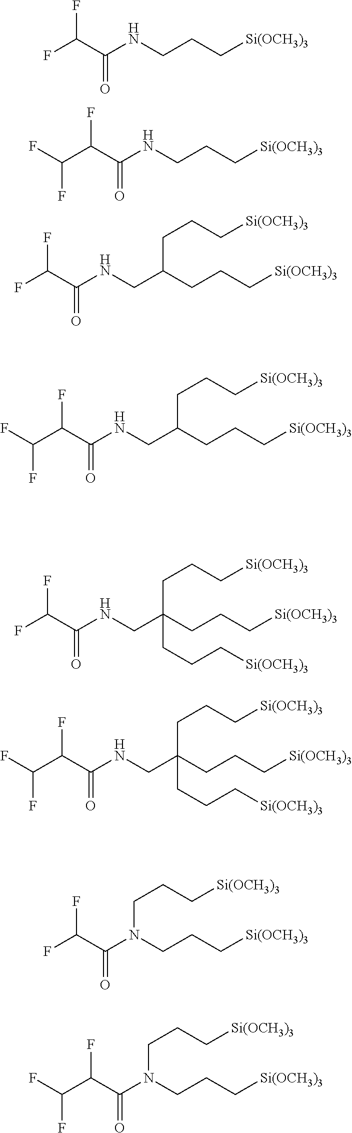

Other specific examples of the fluorine atom containing silane compound represented by the formula (1) include those with the following structures. In the following formulae, n is preferably 1 or more, more preferably 4 or more, and particularly preferably 8 or more. In addition, n is preferably 50 or less, more preferably 40 or less, and particularly preferably 30 or less. Furthermore, n is preferably 1 or more and 50 or less, more preferably 4 or more and 40 or less, and particularly preferably 8 or more and 30 or less.

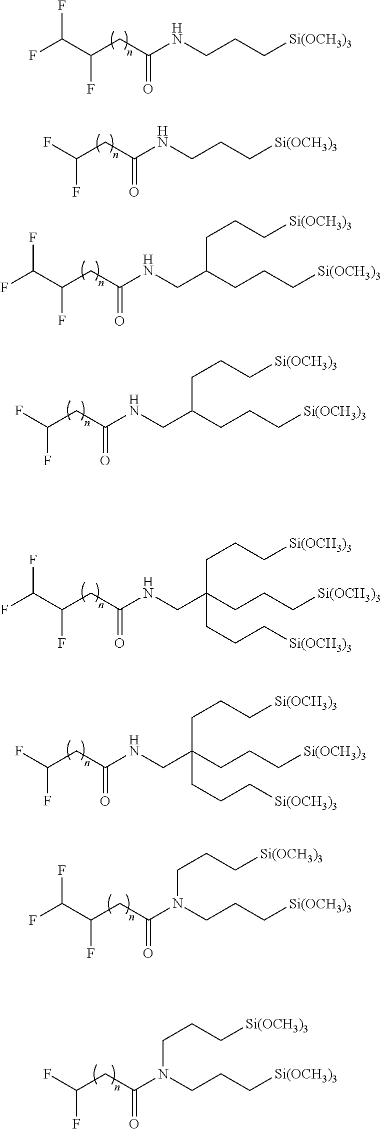

Still other specific examples of the fluorine atom containing silane compound represented by the formula (1) include those with the following structures. In the formulae below, n is preferably 1 or more, more preferably 4 or more, and particularly preferably 8 or more. Also, n is preferably 50 or less, more preferably 40 or less, and particularly preferably 30 or less. Furthermore, n is preferably 1 or more and 50 or less, more preferably 4 or more and 40 or less, and particularly preferably 8 or more and 30 or less.

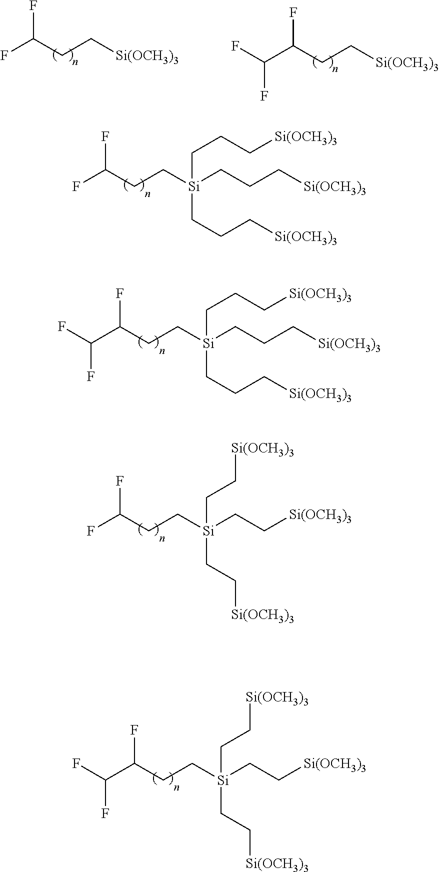

Yet other specific examples of the fluorine atom containing silane compound represented by the formula (1) include those with the following structures. In the formulae below, n is preferably 0 or more, more preferably 3 or more, and particularly preferably 8 or more. Besides, n is preferably 50 or less, more preferably 40 or less, and particularly preferably 30 or less. Further, n is preferably 0 or more and 50 or less, more preferably 3 or more and 40 or less, and particularly preferably 8 or more and 30 or less.

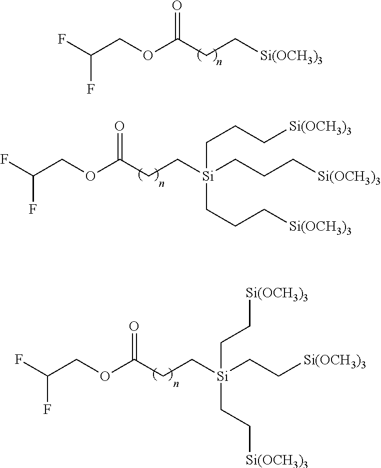

### [Production Method]

Hereinafter, a method for producing the fluorine atom containing silane compound of the present disclosure will be described. Note that the method for producing the fluorine atom containing silane compound of the present disclosure is not limited to the method below. Also, HF₂C— or H₂FC— may be used as A¹_{γ11}A²_{γ12}C—, but it is not limited to these structures.

As a method for producing a group containing A¹_{γ11}A²_{γ12}C—, such as a group containing HF₂C— (difluoromethyl group) or H₂FC— (fluoromethyl group), there are two methods: one is to derive it from a compound having HF₂C— or H₂FC—, and the other is to fluorinate a functional group and introduce it.

### (Production Method 1)

The present production method includes the following step.

Step (I): A compound (11): A¹_{γ11}A²_{γ12}C—R^{j11}—NH₂ is used as a raw material and mixed with an isocyanate compound (12): O═C═N—R^{j12}—R^{Si} to produce a fluorine atom containing silane compound (13).

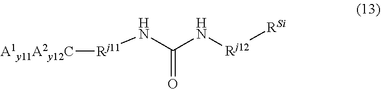

R¹¹ is a single bond or an alkylene group, such as a C₁₋₃₀ alkylene group, and specifically a methylene group, an ethylene group, a propylene group, a butylene group, a pentylene group, a hexylene group, a heptylene group, an octylene group, a nonylene group, a decylene group, an undecylene group, a dodecylene group, a tridecylene group, a tetradecylene group, a pentadecylene group, a hexadecylene group, a heptadecylene group, an octadecylene group, a nonadecylene group, and an eicosadecylene group.

Specific examples of the compound (11) may include difluoromethylamine, difluoroethylamine, difluoropropylamine, monofluoromethylamine, monofluoroethylamine, and monofluoropropylamine.

R^{j12} is a single bond or an alkylene group, and is, for example, an alkylene group, and specifically a C₁₋₃₀ alkylene group.

Specific examples of the isocyanate compound (12) may include 3-(trimethoxysilyl)propyl isocyanate.

R^{Si} is the same as defined above. For example, R^{Si} is represented by the formula (S2).

The above reaction may be performed in a solvent. The solvent is preferably one that can dissolve the compound (11) to the compound (13). The solvent may be used alone as one type, or may be used in combination of two or more types.

The solvent is, for example, a non-fluorinated solvent or a fluorinated solvent.

Examples of the non-fluorinated solvent may include a S atom containing solvent, an amide solvent, an ester solvent, a ketone solvent, an ether solvent, a halogen containing solvent, and a hydrocarbon solvent.

Examples of the S atom containing solvent may include dimethyl sulfoxide, sulfolane, dimethyl sulfide, and carbon disulfide.

Examples of the amide solvent may include N-methylpyrrolidone, N,N-dimethylformamide, dimethylacetamide, and hexamethylphosphoric triamide.

Examples of the ester solvent may include methyl acetate, ethyl acetate, propyl acetate, n-butyl acetate, isopropyl acetate, isobutyl acetate, cellosolve acetate, propylene glycol methyl ether acetate, carbitol acetate, diethyl oxalate, ethyl pyruvate, ethyl 2-hydroxybutyrate, ethyl acetoacetate, amyl acetate, methyl lactate, ethyl lactate, methyl 3-methoxypropionate, ethyl 3-methoxypropionate, methyl 2-hydroxyisobutyrate, and ethyl 2-hydroxyisobutyrate.

Examples of the ketone solvent may include acetone, methyl ethyl ketone, methyl isobutyl ketone, 2-hexanone, cyclohexanone, methyl amino ketone, and 2-heptanone.

Examples of the ether solvent may include diethyl ether, tetrahydrofuran, cyclopentyl methyl ether, ethylene glycol, monoglyme, and diglyme.

Examples of the halogen containing solvent may include dichloromethane and chloroform.

Examples of the hydrocarbon solvent may include pentane, hexane, heptane, benzene, and toluene.

The fluorinated solvent is a solvent containing one or more fluorine atoms. Examples of the fluorinated solvent may include a compound in which at least one of the hydrogen atoms of a hydrocarbon is replaced by a fluorine atom, such as a hydrofluorocarbon, a hydrochlorofluorocarbon, and a perfluorocarbon; and a hydrofluoroether. Here, the term “hydrocarbon” refers to a compound that contains only carbon and hydrogen atoms.

Examples of the hydrofluorocarbon may include bis(trifluoromethyl)benzene, specifically 1,3-bis(trifluoromethyl)benzene (m-XHF), 1,1,1,2,2,3,3,4,4,5,5,6,6-tridecafluorooctane, C₆F₁₃CH₂CH₃ (for example, Asahiklin® AC-6000 manufactured by AGC Inc.), and 1,1,2,2,3,3,4-heptafluorocyclopentane (for example, Zeorora® H manufactured by ZEON Corporation).

Examples of the hydrochlorofluorocarbon may include HCFC-225 (for example, Asahiklin AK-225 manufactured by AGC Inc.) and HFO-1233zd(Z) (for example, Celefin 1233Z manufactured by Central Glass Co., Ltd.).

Examples of the perfluorocarbon may include perfluorohexane, perfluoromethylcyclohexane, perfluoro-1,3-dimethylcyclohexane, and perfluorobenzene.

Examples of the hydrofluoroether may include an alkyl perfluoroalkyl ether (the perfluoroalkyl group and the alkyl group may be linear or branched) such as perfluoropropyl methyl ether (C₃F₇OCH₃) (for example, Novec® 7000 manufactured by Sumitomo 3M Limited), perfluorobutyl methyl ether (C₄F₉OCH₃) (for example, Novec® 7100 manufactured by Sumitomo 3M Limited), perfluorobutyl ethyl ether (C₄F₉OC₂H₅) (for example, Novec® 7200 manufactured by Sumitomo 3M Limited), and perfluorohexyl methyl ether (C₂F₅CF(OCH₃)C₃F₇) (for example, Novec® 7300 manufactured by Sumitomo 3M Limited), and CF₃CH₂OCF₂CHF₂ (for example, Asahiklin® AE-3000 manufactured by AGC Inc.).

Among the fluorinated solvents listed above, m-XHF, HFE7100, HFE7200, HFE7300, AC-6000, perfluorohexane, and perfluorobenzene are preferred.

The solvent is preferably at least one selected from the group consisting of diethyl ether, tetrahydrofuran, cyclopentyl methyl ether, ethylene glycol, dichloromethane, chloroform, benzene, toluene, and 1,3-bis(trifluoromethyl)benzene, and is more preferably at least one selected from the group consisting of dichloromethane, chloroform, toluene, and 1,3-bis(trifluoromethyl)benzene.

The reaction temperature is not limited. For example, the reaction temperature may be 0 to 100° C., 0 to 50° C., or 0 to 30° C.

### (Production Method 2)

In the present production method, a carbonyl group (—C(═O)—) containing compound is allowed to react with an olefin (—CH═CH₂) containing amine compound, thereby producing an olefin containing amide compound, from which the fluorine atom containing silane compound of the present disclosure can be synthesized. For example, an amide compound containing an olefin at an end is allowed to react with a compound represented by the following formula:

HSiR^{j27}ₘ₃R^{j28}₃₋ₘ₃
wherein
R^{j27} is each independently a hydroxyl group or a hydrolyzable group;
R^{j28} is each independently a monovalent organic group; and
m3 is 1 to 3,
   thereby obtaining the fluorine atom containing silane compound. The monovalent organic group does not contain a hydrolyzable group.

The olefin containing amine compound is a compound having H₂N- and —CH═CH₂, and is, for example, H₂N(CH₂)ₓ₃₁Q((CH₂)ₓ₃₂CH═CH₂)ₓ₃₃R^{x3}ₓ₃₄ (wherein x31 and x32 are each an integer of 0 to 6, x33 is an integer of 1 or more, x34 is an integer of 0 or more, the sum of x33 and x34 sum is the valence of Q−1, Q is N, Si, or C, and R^{x3} is a hydrogen atom, a hydroxyl group, or a monovalent organic group).

Examples of the olefin containing amine compound include allylamine, diallylamine, 2-allylpent-4-en-1-amine (H₂NCH₂CH(CH₂CH═CH₂)₂), and 2,2-diallylpent-4-en-1-amine (H₂N—CH₂C(CH₂CH═CH₂)₃).

The carbonyl group containing compound is a compound containing A¹_{γ11}A²_{γ12}C— and a C(═O) group. Examples of the carbonyl group containing compound may include the compounds obtained by the Synthesis Methods 1, 3 to 6 described below, or a compound represented by the following formula (21).

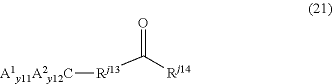

In the formula (21), R^{j13} is a single bond or alkylene group, and is, for example, a single bond; and R^{jl4} is a hydroxyl group, a fluorine atom, a chlorine atom, or a —O-lower alkyl group (that is, an alkoxide group), and is, for example, a hydrogen atom, a methoxide group, or an ethoxide group, and specifically, a hydrogen atom or a methoxide group.

Specific examples of the compound of the formula (21) may include difluoroacetic acid, methyl difluoroacetate, ethyl difluoroacetate, monofluoroacetic acid, methyl monofluoroacetate, and ethyl monofluoroacetate.

When the carbonyl group containing compound has acid chloride (C(═O)Cl), the olefin containing amide compound can be obtained by allowing it to react with a trialkylamine. Examples of the trialkylamine may include triethylamine.

When the carbonyl group containing compound has a carboxylic acid, the olefin containing amide compound can be obtained by allowing it to react with a condensing agent.

As the condensing agent, it is preferable to use 1-(3-dimethylaminopropyl)-3-ethylcarbodiimide (EDC), 1-(3-dimethylaminopropyl)-3-ethylcarbodiimide hydrochloride (EDC-HCl), N,N′-dicyclohexylcarbodiimide (DCC), 1-[bis(dimethylamino)methylene]-1H-1,2,3-triazolo[4,5-b]pyridinium 3-oxide hexafluorophosphate (HATU), 1-[bis(dimethylamino)methylene]-1H-benzotriazolium 3-oxide hexafluorophosphate (HBTU), 1-[bis(dimethylamino)methylene]-1H-1,2,3-triazolo[4,5-b]pyridinium 3-oxide tetrafluoroborate (TATU), 1-[bis(dimethylamino)methylene]-1H-benzotriazolium 3-oxide tetrafluoroborate (TBTU), (1-cyano-2-ethoxy-2-oxoethylideneaminooxy)dimethylaminomorpholinocarbenium hexafluorophosphate (COMU), 0-[(ethoxycarbonyl)cyanomethyleneamino]-N,N,N′,N′-tetramethyluronium hexafluorophosphate (HOTU), 1H-benzotriazol-1-yloxytripyrrolidinophosphonium hexafluorophosphate (PyBOP), 1H-benzotriazol-1-yloxytris(dimethylamino)phosphonium hexafluorophosphate (BOP), bromotripyrrolidinophosphonium hexafluorophosphate (PyBroP), diphenylphosphoryl azide (DPPA), 4-(4,6-dimethoxy-1,3,5-triazin-2-yl)-4-methylmorpholinium chloride (DMT-MM), 1-hydroxybenzotriazole (HOBt), or 1-hydroxy-7-azabenzotriazole (HOAt), and it is preferable to use 1-(3-dimethylaminopropyl)-3-ethylcarbodiimide hydrochloride, N,N′-dicyclohexylcarbodiimide, or 1-hydroxybenzotriazole. Furthermore, 4-dimethylaminopyridine (DMAP) or the like may be added as a catalyst.

When the carbonyl group containing compound has an ester, the olefin containing amide compound can be obtained by allowing it to react in the presence of a base.

As the base, it is preferable to use 1,5,7-triazabicyclo[4.4.0]dec-5-ene (TBD), 1,2,4-triazole, 1,8-diazabicyclo[5.4.0]-7-undecene (DBU), sodium methoxide, or sodium tert-butoxide, and it is more preferable to use 1,5,7-triazabicyclo[4.4.0]dec-5-ene.

The reaction temperature is not limited. For example, the reaction temperature may be 0 to 150° C., 0 to 100° C., or 0 to 50° C.

The solvent to be used can be the same as in Production Method 1. Preferably, the solvent is acetonitrile, dichloromethane, chloroform, toluene, diethyl ether, or tetrahydrofuran. The reaction may also be carried out with no solvent.

### (Production Method 3)

In the present production method, an olefin group containing compound is used as a raw material to produce a fluorine atom containing silane compound.

The olefin group containing compound is a compound having A¹_{γ11}A²_{γ12}C— and an olefin group (—CH═CH₂). Examples of the olefin group containing compound may include the compounds obtained by the Synthesis Methods 2 to 6 described below.

For example, by a method including: allowing an olefin group to react with HSiM₃ (M is each independently a halogen atom or a C₁₋₆ alkoxy group) and further allowing the resulting compound to react with a compound represented by the formula: Hal-J-CH═CH₂ (wherein J represents Mg, Cu, Pd, or Zn, and Hal represents a halogen atom), and if desired,
a compound represented by the formula: R^{c1}_{h′}L (wherein R^{c1} is the same as defined above, L represents a group that can be bonded to R^{c1}, and h′ is an integer of 1 to 3), thereby obtaining the following compound:

A¹_{γ11}A²_{γ12}C—R^{j21}—CH₂CH₂—SiR^{c1}ₘ₁(CH═CH₂)_{k′}

(—R^{j21}—CH₂CH₂— corresponds to X^{B}. For example, —R^{j21}—CH₂CH₂— is an alkylene group, such as a C₁₋₃₀ alkylene group, and specifically a C₁₀₋₂₅ alkylene group. m1 is the same as defined above, and the sum of m1 and k′ is 3); and
allowing the above compound to react with HSiM₃ (wherein M is each independently a halogen atom or a C₁₋₆ alkoxy group), and if desired,
a compound represented by the formula: R²³_{i′}L′ (wherein R²³ is the same as defined above, L′ represents a group that can be bonded to R²³, and i′ is an integer of 1 to 3), and if desired,
a compound represented by the formula: R²⁴_{j′}L″ (wherein R²⁴ is the same as defined above, L″ represents a group that can be bonded to R²⁴, and j′ is an integer of 1 to 3), the following formula:

A¹_{γ11}A²_{γ12}C—R^{j22}—R^{Si}

(R^{j22} is a divalent organic group, and corresponds to —R^{j21}—CH₂CH₂—. R^{Si} is the same as defined above) can be produced. Note that the above description can be applied to other olefin group containing compounds as well.

### (Production Method 4)

In the present production method, a carbonyl group containing compound is allowed to react with an amine containing silane compound, thereby producing a fluorine atom containing silane compound.

The carbonyl group containing compound is a compound containing A¹_{γ11}A²_{γ12}C— and C(═O). Examples of the carbonyl group containing compound may include the compounds obtained by the Synthesis Methods 1, 3 to 6 described below, or a compound represented by the following formula (21).

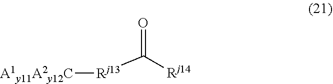

For example, A¹_{γ11}A²_{γ12}C— is HF₂C—. R^{j13} and R^{j14} are the same as defined above.

The amine containing silane compound is a compound having a H₂N— group and a R^{Si} group. Examples of the amine containing silane compound may include H₂N—R^{j23}—R^{Si}, and specific examples thereof may include aminopropyltrimethoxysilane. R^{j23} is an alkylene group, such as a C₁₋₄ alkylene group, specifically a methylene group, an ethylene group, or a propylene group; and R^{Si} is the same as defined above, and for example, R^{Si} is represented by the formula (S2).

The fluorine atom containing silane compound is, for example, A¹_{γ11}A²_{γ12}C—R^{j24}—C(═O)NHR^{j23}—R^{Si}. A¹_{γ11}A²_{γ12}C—R^{j24}— corresponds to Rf¹—. R^{j24} is an alkylene group, such as a C₁₋₄ alkylene group, and specifically a methylene group, an ethylene group, or a propylene group.

The reaction temperature is preferably 0° C. to 150° C., and more preferably 20° C. to 100° C.

The solvent to be used can be the same as in Production Method 1, and preferably, toluene, dichloromethane, chloroform, methanol, or ethanol can be used.

### (Production Method 5)

In the present production method, an olefin group containing compound is allowed to react, thereby producing a fluorine atom containing silane compound.

Specifically, the olefin group containing compound is allowed to react with a compound represented by the following formula:

HSiR^{j25}ₘ₃R^{j26}₃₋ₘ₃
wherein
R^{j25} is each independently a hydroxyl group or a hydrolyzable group;
R^{j26} is each independently a monovalent organic group; and
m3 is 1 to 3,
   thereby obtaining the fluorine atom containing silane compound. Note that the above description can be applied to other olefin group containing compounds as well.

The olefin group containing compound is a compound having A¹_{y11}A²_{γ12}C— and an olefin group. Examples of the olefin group containing compound may include the compounds obtained by the Synthesis Methods 2 to 6 described below.

The reaction temperature is preferably −20° C. to 150° C., and more preferably 0° C. to 100° C.

The solvent to be used can be the same as in Production Method 1, and preferably, toluene, dichloromethane, chloroform, methanol, ethanol, diethyl ether, or cyclopentyl methyl ether can be used.

### (Synthesis Method 1)

In the present method, a compound (31) having a group containing A¹_{γ11}A²_{γ12}C— and a hydroxyl group: A¹_{γ11}A²_{γ12}C—R^{j33}—OH is used as a raw material to synthesize a carbonyl group containing compound.

The group containing A¹_{γ11}A²_{γ12}C— includes, for example, HF₂C—.

R^{j33} is an alkylene group, such as a C₁₋₃₀ alkylene group.

Specific examples of the compound (31) may include difluoroethanol, difluoropropanol, difluorobutanol, monofluoroethanol, monofluoropropanol, and monofluorobutanol.

The hydroxyl group of the compound (31) is converted to -OTf (Tf is a trifluoromethylsulfonyl group) by a conventional method, thereby obtaining a compound (32): A¹_{γ11}A²_{γ12}C—R^{j33}—OTf.

The present method includes the following step (I′). (I′): The above compound (32) is mixed with a compound (33) having a reactive group to obtain a carbonyl group containing compound (34).

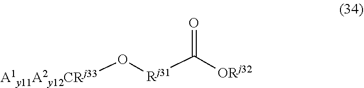

Here, examples of the reactive group may include a hydroxyl group, a carboxyl group, Cl, F, and an ester group in which a carboxyl group is esterified.

Specific examples of the compound (33) having a reactive group may include: a compound having a hydroxyl group at an end, such as tert-butyl 9-hydroxy-4,7-dioxanonanoate, tert-butyl 12-hydroxy-4,7,10-trioxadodecanoate, and tert-butyl 1-hydroxy-3,6,9,12-tetraoxapentadecan-15-oate; and a compound having a carboxyl group at an end, such as 10-hydroxydecanoic acid, 11-hydroxyundecanoic acid, 12-hydroxydodecanoic acid, 13-hydroxytridecanoic acid, 14-hydroxytetradecanoic acid, 15-hydroxypentadecanoic acid, 16-hydroxyhexadecanoic acid, 17-hydroxyheptadecanoic acid, 18-hydroxyoctadecanoic acid, 19-hydroxynonadecanoic acid, 20-hydroxyeicosanoic acid, 21-hydroxyheneicosanoic acid, 22-hydroxydocosanoic acid, 23-hydroxytricosanoic acid, 24-hydroxytetracosanoic acid, 25-hydroxypentacosanoic acid, and 30-hydroxytriacontanoic acid; and methyl esters and acid chlorides thereof.

R^{j31} is a divalent organic group, and is, for example, a group having a polyether group or an alkylene group, and specifically, a —(R^{j35}O)ₙ—R^{j36}— group or a C₁₋₃₀ alkylene group.

R^{j35} is a C₁₋₃ alkylene group, such as an ethylene group, and R^{j36} is a C₁₋₃ alkylene group, such as an ethylene group.

n is an integer of 2 to 150, such as an integer of 2 to 50.

R^{j32} is a lower alkyl group, such as a methyl group, an ethyl group, a propyl group, a butyl group, or a tert-butyl group, and is specifically a methyl group or a tert-butyl group.

The reaction temperature is not limited. For example, the reaction can be performed at a reaction temperature of −80 to 200° C., such as −50 to 100° C., and specifically −20 to 50° C.

The solvent to be used can be the same one as in Production Method 1.

### (Synthesis Method 2)

In the present method, a compound (31) having a group containing A¹_{γ11}A²_{γ12}C— and a hydroxyl group: A¹_{γ11}A²_{γ12}C—R^{j33}—OH is used as a raw material to synthesize an olefin containing compound. Each sign is the same as defined above.

The hydroxyl group of the compound (31) is converted to —OTf (Tf is a trifluoromethylsulfonyl group) by a conventional method to produce a compound (32): A¹_{γ11}A²_{γ12}C—R^{j33}—OTf.

The present method includes the following step (I′). (I′): The above compound (32) is mixed with a compound (35) having a reactive group: HO—R^{j31}—CH═CH₂ to obtain an olefin containing compound (36).

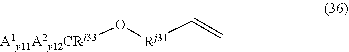

R^{j33} and R^{j31} are the same as defined above.

The reaction temperature and the solvent are the same as defined in Production Method 2.

### (Synthesis Method 3)

In the present method, a compound (41) in which a group containing A¹_{γ11}A²_{γ12}C— and a trialkylsilyl group are bonded: A¹_{γ11}A²_{y12}C—SiR^{j403} is used as a raw material. The group containing A¹_{γ11}A²_{γ12}C— includes, for example, HF₂C—.

R^{j40} is each independently a lower alkyl group, such as a C₁₋₃ alkyl group.

Examples of the compound (41) may include difluoromethyltrimethylsilane.

The compound (41) is allowed to react with a compound (42) having a leaving group: X—R^{j41}—Z in the presence of a metal catalyst to obtain A¹_{γ11}A²_{γ12}C—R^{j41}—Z.

R^{j41} is an alkylene group, such as a C₁₋₃₀ alkylene group, and specifically a C₁₀₋₂₅ alkylene group.

Z is a reactive group. For example, Z is —C(═O) OR^{j42} (R^{j42} is, for example, a hydrogen atom or a methyl group), or —CH═CH₂. That is, by the above reaction, a compound (43) containing a carbonyl group at an end or a compound (43′) containing an olefin is synthesized.

X is Cl, Br, I, OTs (where Ts is a p-toluenesulfonyl group), OMs (where Ms is a mesyl group), and is preferably Br and I.

The metal catalyst is at least one selected from Pd, Cu, Ni Pt, and Ag, preferably at least one selected from Pd and Cu. The metal catalyst may be a simple substance of the metal, may be a metal salt, or may be a complex having a ligand.

In one embodiment, a simple substance of the metal is used as the metal catalyst.

In one embodiment, a metal salt is used as the metal catalyst. The metal salt is preferably copper(I) chloride, copper(II) chloride, copper(I) bromide, copper(II) bromide, copper(I) iodide, copper(II) iodide, silver(I) chloride, silver(I) bromide, or silver(I) iodide, and more preferably copper(I) chloride, copper(I) bromide, or copper(I) iodide.

In one embodiment, a complex having a ligand is used as the metal catalyst. It is preferable that such a ligand is a phosphine atom containing ligand, an olefin group containing ligand, or a nitrogen atom containing ligand.

Examples of the ligand may include triphenylphosphine (that is, PPh₃), tri-t-butylphosphine (that is, P(t-Bu)₃), tri-n-butylphosphine (that is, P(n-Bu)₃), tri(ortho-tolyl)phosphine (that is, P(o-Tol)₃), (C₆F₅)₃P (that is, Tpfpp), (C₆F₅)₂PCH₂CH₂P(C₅F₅)₂) (that is, Dfppe), 1,2-bis(diphenylphosphino)ethane (that is, dppe), 1,3-bis(diphenylphosphino)propane (that is, dppp), 1,1′-bis(diphenylphosphino)ferrocene (that is, dppf), (S)-2,2′-bis(diphenylphosphino)-1,1′-binaphthyl (that is, (S)-BINAP), 1,5-cyclooctadiene (that is, COD), bipyridine (that is, bpy), phenanthroline (that is, phen), or salts thereof.

Examples of the metal catalyst may include a Pd simple substance, Pd(dba)₂, Pd(dba)₃, a Cu simple substance, copper(I) chloride, copper(I) bromide, and copper(I) iodide, and the metal catalyst is preferably Pd(dba)₂, Pd(dba)₃, or copper(I) iodide. Here, “dba” means dibenzylideneacetone.

The metal catalyst may be included in an amount of 0.01 moles or more, 0.1 moles or more, 0.2 moles or more, 0.5 moles or more, 1 mole or more, 2 moles or more, or 3 moles or more based on 1 mole of the compound (42) having a leaving group, for example. The metal catalyst may be included in an amount of 10 moles or less or 8 moles or less based on 1 mole of the compound (42), for example. The metal catalyst may be included in an amount of, for example, 0.01 to 10 moles, 0.05 to 10 moles, 1 to 10 moles, 2 to 10 moles, or 3 to 8 moles based on 1 mole of the compound (42), for example.

In one embodiment, when the metal catalyst is copper(I) iodide, that metal catalyst may be included in an amount of 0.1 to 10 moles or 0.5 to 2 moles based on the compound (42).

In one embodiment, when the metal catalyst is Pd(dba)₂, that metal catalyst may be included in an amount of 0.01 to 1 mole or 0.05 to 0.5 moles based on the compound (42).

The above metal catalyst may be a metal catalyst precursor into which a ligand is introduced at the time of reaction. Examples of the metal catalyst precursor may include one having at least one selected from the group consisting of Pd, Pt, Cu, Ag Zn, and Mg. Examples of the ligand may include triphenylphosphine, tri-t-butylphosphine, tri-n-butylphosphine, tri(ortho-tolyl)phosphine, (C₆F5)₃P, (C₆F5)₂PCH₂CH₂P(C₅F5) 2,1,2-bis(diphenylphosphino) ethane, 1,3-bis(diphenylphosphino)propane, 1,1′-bis(diphenylphosphino)ferrocene, (S)-2,2′-bis(diphenylphosphino)-1,1′-binaphthyl, 1,5-cyclooctadiene, bipyridine, and phenanthroline.

The reaction temperature is not limited. For example, the reaction temperature may be 0 to 200° C., 0 to 150° C., or 20 to 100° C.

For the solvent, the same one as in Production Method 1 can be used. Preferably, dimethyl sulfoxide, sulfolane, N-methylpyrrolidone, N,N-dimethylformamide, and dimethylacetamide can be used.

### (Synthesis Method 4)

In the present method, a compound (51) in which a group containing A¹_{γ11}A²_{γ12}C— and a trialkylsilyl group are bonded is used as a raw material. A¹_{γ11}A²_{γ12}C— is, for example, BrF₂C—. Examples of the compound include bromofluoromethyltrimethylsilane (BrF₂C-TMS).

The compound (51) is allowed to react with a nucleophile (52) having a heteroatom:
Nu-H (where Nu is a nucleophile, and is, for example, R^{j50}O—, R^{j50}S—, or R^{j502}N—. R^{j50} is each independently a C₁₋₃ alkyl group)
   in the presence of a base, thereby deriving a compound having a carbonyl group at an end (a carbonyl group containing compound) or a compound having an olefin at an end (an olefin group containing compound).

Examples of the base may include ammonia, sodium hydroxide, potassium hydroxide, and an organic amine such as triethylamine and diethylamine. The base may be dissolved in water and used as an aqueous solution. As the base, it is preferable to use sodium hydroxide or potassium hydroxide.

The reaction temperature is not limited. For example, the reaction temperature may be -20 to 100° C., -10 to 80° C., or −10 to 50° C.

As the solvent, the same one as in Production Method 1 can be used. The solvent is preferably acetonitrile, dichloromethane, chloroform, toluene, diethyl ether, tetrahydrofuran, dimethyl sulfoxide, N-methylpyrrolidone, N,N-dimethylformamide, or dimethylacetamide.

### (Synthesis Method 5)

In the present method, fluorination of a compound having a formyl group is performed to form HF₂C—, synthesizing the following formula:

HCF₂—R^{j60}-A^{j61}
wherein
R^{j60} is a divalent organic group, and is, for example, a C₁₋₂₀ alkylene group;
A^{j61} is —COOH, —COOR^{j62}, —COCl, or —CH═CH₂; and
R^{j62} is a lower alkyl group, such as a C₁₋₃ alkyl group.

By the above reaction, a carbonyl group containing compound or an olefin group containing compound can be synthesized.

Examples of the compound having a formyl group may include H(C═O)—R^{j60}-A^{j61}.

Examples of the fluorinating agent include N,N-diethylaminosulfur trifluoride (DAST), bis(2-methoxyethyl)aminosulfur trifluoride (Deoxo-Fluor®), morpholinosulfur trifluoride (MOST), 2,2-difluoro-1,3-dimethylimidazolidine (DFI), 2-chloro-N,N-diethyl-1,1,2-trifluoroethanamine (Yarovenko reagent), N,N-diethyl-α,α-difluoro-3-methylbenzenemethanamine (DFMBA), (diethylamino)difluorosulfonium tetrafluoroborate (XtalFluor-E®), and sulfonium difluoro-4-morpholinyl-tetrafluoroborate (XtalFluor-M®).

In one embodiment, it is preferable to use DAST as the fluorinating agent. By using DAST, the difluoromethylation reaction of the formyl group can proceed selectively.

In one embodiment, it is preferable to use Deoxo-Fluor or MOST as the fluorinating agent. By using Deoxo-Fluor or MOST, the difluoromethylation reaction can be carried out under heating conditions.

The reaction temperature is not limited. For example, the reaction temperature may be −20 to 200° C., −10 to 150° C., or 0 to 10° C.

The solvent to be used can be the same one as in Production Method 1. The solvent is preferably acetonitrile, dichloromethane, chloroform, toluene, diethyl ether, or tetrahydrofuran. The reaction may also be carried out with no solvent.

### (Synthesis Method 6)

In the present method, a fluorinating agent is used to perform fluorination of a hydroxyl group, thereby synthesizing a H₂FC— group or a —CFH— group. For example, H₂CF—R^{j60}-A^{j61} is synthesized by a reaction with HO—R^{j60}-A^{j61}, and R′—CFH—R^{j60}-A^{j61} is synthesized by a reaction with R′—CH(OH)—R^{j60}-A^{j61}.

R^{j60} is a divalent organic group, and is, for example, a C₁₋₂₀ alkylene group.

A^{j61} is —COOH, —COOR^{j62}, —COCl, or —CH═CH₂.

R^{j62} is a lower alkyl group, such as a C₁₋₃ alkyl group.

By the above reaction, a carbonyl group containing compound or an olefin group containing compound can be synthesized.

Examples of the fluorinating agent include sulfur tetrafluoride (SF₄), N,N-diethylaminosulfur trifluoride (DAST), bis(2-methoxyethyl)aminosulfur trifluoride (Deoxo-Fluor®), morpholinosulfur trifluoride (MOST), 2,2-difluoro-1,3-dimethylimidazolidine (DFI), 2-chloro-N,N-diethyl-1,1,2-trifluoroethanamine (FAR, Yarovenko reagent), (diethylamino)difluorosulfonium tetrafluoroborate (XtalFluor-E (R)), sulfonium difluoro-4-morpholinyl-tetrafluoroborate (XtalFluor-M®), hexafluoropropenediethylamine, triethylamine trihydrofluoride, triethylamine pentahydrofluoride, pyridinium pentafluoroiodide-hydrogenfluoride complex, N,N′-difluoro-2,2′-bipyridinium bis(tetrafluoroborate), 4-tert-butyl-2,6-dimethylphenylsulfur trifluoride (FLUOLEAD™), and 2-chloro-1,3-bis(2,6-diisopropylphenyl)-1H-imidazole chloride (PhenoFluor™).

In one embodiment, it is preferable to use triethylamine trihydrofluoride, triethylamine pentahydrofluoride, or pyridinium pentafluoroiodide-hydrogenfluoride complex as the fluorinating agent. The use of complexes allows for easy handling of hydrogen fluoride.

In one embodiment, it is preferable to use DAST as the fluorinating agent. By using DAST, the reaction can proceed at a relatively low temperature.

In one embodiment, it is preferable to use 4-tert-butyl-2,6-dimethylphenylsulfur trifluoride (FLUOLEAD™) as the fluorinating agent. The use of 4-tert-butyl-2,6-dimethylphenylsulfur trifluoride (FLUOLEAD™) allows for easier handling in the air.

The reaction temperature is not limited. The reaction temperature may be, for example, -20 to 200° C., -10 to 150° C., or 0 to 10° C.

The solvent used can be the same one as in Production Method 1. The solvent is preferably acetonitrile, dichloromethane, chloroform, toluene, diethyl ether, or tetrahydrofuran. The reaction may also be carried out without solvent.

Note that the compound having a fluoromethyl group or a difluoromethyl group at an end can also be produced from a fluorine containing olefin compound.

Examples of the fluorine containing olefin compound include fluoroethylene, 1,1-difluoroethylene, 1,2-difluoroethylene, trifluoroethylene, 2,3,3-trifluoro-1-propene, and 2,3,4,4-tetrafluoro-1-propene. The compound having a fluoromethyl group or a difluoromethyl group can be obtained by polymerizing a fluorine containing olefin compound as described above, performing a radical reaction, or adding an alcohol or the like to a fluorine containing olefin compound.

### INTERMEDIATES

Intermediates produced in the production of the fluorine atom containing silane compound will be described.

Formula (2a):

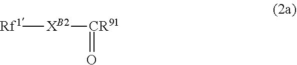

Rf¹′— is each independently A¹¹_{γ11}A¹²_{γ12}C— or a cyclic structure containing CF≡. Each sign is the same as defined above.

X^{B2} is a single bond, an oxygen atom, or a divalent organic group, and is preferably (CH₂)_{c21}, (CH₂)_{c22}—O—(CH₂)_{c23}, or a divalent group containing a polysiloxane group.

c21, c22, and c23 are each independently an integer of 0 to 200. However, the sum of c22 and c23 is an integer of 0 to 200.

Rf^{1′}—X^{B2}— corresponds to Rf¹.

R⁹¹ is a hydroxyl group, —F, —Cl, or a —O—C₁₋₃ alkyl group (specifically, a methoxy group or an ethoxy group). In one embodiment, R⁹¹ is a hydroxyl group. In one embodiment, R⁹¹ is —F. In one embodiment, R⁹¹ is —Cl. In one embodiment, R⁹¹ is a —O-lower alkyl group.

—C(═O)— is included in X^{A}.

In the formula (2a), for example, X^{B2} is a single bond and R⁹¹ is a hydrogen atom. In another example, X^{B2} is a divalent organic group and R⁹¹ is a hydrogen atom.

Formula (2b):

Rf^{1′}—X^{B3}—X^{A3}—CH═CH (2b)
Rf^{1′} is the same as defined above.

X^{B3} is (CH₂)_{c12}—O—(CH₂)_{c13} or a divalent group containing a polysiloxane group.

c11, c12, and c13 are each independently an integer of 0 to 200, provided that the sum of c12 and c13 is an integer of 0 to 200.

Rf^{1′}—X^{B3}— corresponds to Rf¹.

X^{A3} is each independently a single bond or C(═O)NR⁵³—(CH₂)_{c14}.

R⁵³ is a hydrogen atom or a monovalent organic group. In one embodiment, R⁵³ is a hydrogen atom. X^{A3} is included in X^{A}.

c14 is an integer of 0 to 30.

In one embodiment, —X^{A3}—CH₂CH₂— is X^{A}.

Formula (2c):

Rf^{1′}—X^{B4}—X^{A4}—Si(X^{A5}—CH═CH₂)_{δ3}R⁹⁵_{3-δ3} (2c)

The formula (2c) is a precursor of a compound containing the group represented by the formula (S2) or (S3).

Rf^{1′} is the same as defined above.

X^{B4} is (CH₂)_{c11}, (CH₂)_{c12}—O—(CH₂)_{c13}, or a divalent group containing a polysiloxane group.

c11, c12, and c13 are each independently an integer of 0 to 200. However, the sum of c12 and c13 is an integer of 0 to 200.

Rf^{1′}—X^{B4}— corresponds to Rf¹.

X^{A4} is each independently a single bond or C(═O)NR⁵³—(CH₂)^{c15}. R⁵³ is the same as defined above. c15 is an integer of 0 to 30. X^{A4} corresponds to X^{A}.

X^{A5} is each independently a single bond or a divalent organic group. —X^{A}₅—CH₂CH₂— corresponds to —Z¹—.

R⁹⁵ is each independently a hydrogen atom, a hydroxyl group, or a monovalent organic group. In one embodiment, R⁹⁵ is each independently a hydroxyl group or a monovalent organic group. The monovalent organic group does not include —X^{A5}—CH═CH₂. R⁹⁵ corresponds to R^{b1} or R^{c1}.

δ3 is an integer of 1 to 3 and corresponds to k1.

Formula (2d):

Rf^{1′}—X^{B4}—X^{A4}—C(X^{A6}—CH═—CH₂)_{δ4}R⁹⁶_{3-δ4} (2d)

The formula (2d) is a precursor of a compound containing the group represented by the formula (S4).

Rf^{1′} is the same as defined above.

X^{B4} is (CH₂)_{c11}, (CH₂)_{c12}—O—(CH₂)_{c13} or a divalent group containing a polysiloxane group.

c11, c12 and c13 are each independently an integer of 0 to 200.

Rf^{1′}—X^{B4}— corresponds to Rf¹.

X^{A4} is the same as defined above. X^{A4} corresponds to X^{A}.

X^{A6} is each independently a single bond, an oxygen atom, or a divalent organic group. —X^{A6}—CH₂CH₂— corresponds to Z³.

Based on —X^{A5}—CH₂CH₂—, R^{e1} is formed.

R⁹⁶ is each independently a hydrogen atom, a hydroxyl group, or a monovalent organic group, provided that the monovalent organic group does not include —X^{A6}—CH═CH₂. R⁹⁶ corresponds to R^{f1}.

δ4 is an integer of 1 to 3 and corresponds to 12.

Formula (2e):

Rf^{1′}—X^{B4}—X^{A4}—NR⁹⁷₂ (2e)

Rf^{1′} is the same as defined above.

X^{B4} is (CH₂)_{c11}, (CH₂)_{c12}—O—(CH₂)_{c13}, or a divalent group containing a polysiloxane group.

c11, c12, and c13 are each independently an integer of 0 to 200.

Rf^{1′}—X^{B4}— corresponds to Rf¹.

X^{A4} is the same as defined above. X^{A4} corresponds to X^{A}.

R⁹⁷ is each independently represented by —R⁹²—CH═CH₂ or —R⁹⁴-Q^{A1}(R⁹²—CH═CH₂)^{δ31}R⁹³_{δ32}.

R⁹² is a single bond, an oxygen atom, or a divalent organic group. —R⁹²—CH₂CH₂— derived from R⁹²—CH═CH₂ corresponds to, for example, Z¹ in the formula (S3), or Z² or Z³ in the formula (S4).

R⁹⁴ is a single bond, an oxygen atom, or a divalent organic group;

Q^{A1} is each independently N, Si, or C;

R⁹³ is a hydrogen atom, a hydroxyl group, or a monovalent organic group;

δ31 and δ32 are each independently an integer of 1 or more; and

the sum of δ31 and δ32 is the valence of Q^{A1}—1.

Formula (2f):

Rf^{1′}—X^{B5}—X^{A7}—NR⁵³—R⁹⁸ (2f)

Rf^{1′} is the same as defined above.

X^{B5} is represented by (CH₂)_{c11}, (CH₂)_{c12}—O—(CH₂)_{c13}, or a divalent group containing a polysiloxane group.

c11, c12 and c13 are each independently an integer of 0 to 200.

Rf^{1′}—X^{B5}— corresponds to Rf¹.

X^{A7} is a single bond or C(═O).

R⁹⁸ is represented by —R⁹²—CH═CH₂ or —R⁹⁴-Q^{A1}(R⁹²—CH═CH₂)_{δ31}R⁹³_{δ32}.

R⁹² is a single bond, an oxygen atom, or a divalent organic group.

R⁹⁴ is a single bond, an oxygen atom, or a divalent organic group.

Q^{A1} is each independently N, Si, or C.

R⁹³ is a hydrogen atom, a hydroxyl group, or a monovalent organic group.

δ31 and δ32 are each independently an integer of 1 or more.

The sum of δ31 and δ32 is the valence of Q^{A1}−1.

In one embodiment, X^{A7}—NR⁵³ corresponds to X^{A}. R⁵³ is the same as defined above.

In one embodiment, R⁹⁸ is represented by —R⁹²—CH═CH₂. In this case, X^{A7}—NR⁵³—R⁹⁸ corresponds to X^{A}.

In one embodiment, R⁹⁸ is represented by —R⁹⁴-Q^{A1} (R⁹²—CH═CH₂)_{δ31}R⁹³_{δ32}. In this case, X^{A7}—NR⁵³—R⁹⁴ corresponds to X^{A}.

Formula (2g):

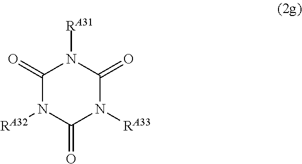

R^{A31} is represented by —Rf¹, and Rf¹ is the same as defined above.

R^{A32} is represented by —X^{A31}—CH═CH₂ or —X^{A33}-Q^{A2}(X^{A32}—CH═CH₂)_{δ41}R³⁶_{δ42}.

R^{A33} is represented by —Rf¹, —X^{A31}—CH═CH₂, or —X^{A33}-Q^{A2}(X^{A32}—CH═CH₂)_{δ41}R³⁶_{δ42}.

X^{A31}, X^{A32}, and X^{A}₃₃ are each independently a single bond, an oxygen atom, or a divalent organic group.

Q^{A2} is each independently N, Si, or C.

A group in which at least one of X^{A31}—CH₂CH₂ and X^{A33} is bonded to an isocyanuric ring corresponds to X^{A} in the formula (1). X^{A32}—CH₂CH₂ corresponds to Z¹ in the formula (S3) when Q^{A2} is Si, to Z³ in the formula (S4) when Q^{A2} is C, and to Z⁴ in the formula (S5) when QA² is N.

R³⁶ is a hydrogen atom, a hydroxyl group, or a monovalent organic group.

δ41 and δ42 are each independently an integer of 1 or more. The sum of 541 and 542 is the valence of Q^{A2}−1.

### [Surface-Treating Agent]

The surface-treating agent of the present disclosure will be described below.

The surface-treating agent of the present disclosure contains at least one fluorine atom containing silane compound represented by the formula (1).

The surface-treating agent of the present disclosure may further contain a condensed product of the fluorine atom containing silane compound.

In one embodiment, the surface-treating agent of the present disclosure contains at least one of the fluorine atom containing silane compound and a compound composed of a condensed product in which at least part of the fluorine atom containing silane compound is condensed.

The surface-treating agent of the present disclosure may contain a solvent, a (non-reactive) silicone compound that may be understood as a silicone oil (hereinafter, referred to as “silicone oil”), an amine compound, an alcohol, a catalyst, a surfactant, a polymerization inhibitor, a sensitizer, and the like.

In one embodiment, the surface-treating agent of the present disclosure contains a compound represented by R⁹⁰—OH.

R⁹⁰ is a monovalent organic group, preferably a C1-2o alkyl group or a C₃₋₂₀ alkylene group, and these groups are optionally substituted with one or more substituents. Examples of the substituents may include a hydroxyl group and —OR⁹⁰¹ (where R⁹⁰¹ is a C₁₋₁₀ alkyl group, preferably a C₁₋₃ alkyl group, such as a methyl group).

In one embodiment, the surface-treating agent of the present disclosure may contain a solvent selected from compounds represented by R⁸¹OR⁸², R⁸³ₙ₈C₆H₆₋ₙ₈, R⁸⁴R⁸⁵R⁸⁶Si—(O—SiR⁸⁷R⁸⁸)ₘ₈—R⁸⁹, and (OSiR⁸⁷R⁸⁸)ₘ₉,
wherein
R⁸¹ to R⁸⁹ are each independently a monovalent organic group having 1 to 10 carbon atoms,
m8 is an integer of 1 to 6,
m9 is an integer of 3 to 8, and
n8 is an integer of 0 to 6.

The monovalent organic group having 1 to 10 carbon atoms may be linear or may be branched, and may further contain a cyclic structure.

In one embodiment, the monovalent organic group having 1 to 10 carbon atoms may contain an oxygen atom, a nitrogen atom, or a halogen atom.

In another embodiment, the monovalent organic group having 1 to 10 carbon atoms does not contain a halogen atom.

In a preferred embodiment, the monovalent organic group having 1 to 10 carbon atoms is a hydrocarbon group optionally substituted with a halogen, and preferably a hydrocarbon group not substituted with a halogen.

In one embodiment, the hydrocarbon group is linear.

In another embodiment, the hydrocarbon group is branched.

In another embodiment, the hydrocarbon group contains a cyclic structure.

In one embodiment, the solvent is R⁸¹OR⁸².

R⁸¹ and R⁸² may be, each independently, preferably a hydrocarbon group having 1 to 8 carbon atoms, and more preferably a C₁₋₆ alkyl group or a C₅₋₈ cycloalkyl group.

In one embodiment, the solvent is R⁸³ₙ₈C₆H₆₋ₙ₈.

C₆H₆₋ₙ₈ is an n8-valent benzene ring. That is, R⁸³ₙ₈C₆H₆₋ₙ₈ is benzene substituted with n8 R⁸³ groups.

R⁸³ may be each independently a halogen, or a C₁₋₆ alkyl group optionally substituted with a halogen.

n8 is preferably an integer of 1 to 3.

In one embodiment, the solvent is R⁸⁴R⁸⁵R⁸⁶Si—(O—SiR⁸⁷R⁸⁸)ₘ₈—R⁸⁹.

In one embodiment, the solvent is (OSiR⁸⁷R⁸⁸)ₘ₉. (OSiR⁸⁷R⁸⁸)ₘ₉ is a cyclic siloxane formed by multiple OSiR⁸⁷R⁸⁸ units bonded in a cyclic form.

R⁸⁴ to R⁸⁹ are each independently a hydrogen atom or a C₁₋₆ alkyl group, preferably a C₁₋₆ alkyl group, more preferably a C₁₋₃ alkyl group, and still more preferably a methyl group.

m8 is preferably an integer of 1 to 6, more preferably an integer of 1 to 5, and still more preferably 1 to 2.

m9 is preferably an integer of 3 to 6, and more preferably an integer of 3 to 5.

In one embodiment, the solvent is hexamethyldisiloxane, hexaethyldisiloxane, octamethyltrisiloxane, octamethylcyclotetrasiloxane, or decamethylcyclopentasiloxane.

In one embodiment, examples of the solvent include: aliphatic hydrocarbons such as hexane, cyclohexane, heptane, octane, nonane, decane, undecane, dodecane, and mineral spirits; aromatic hydrocarbons such as benzene, toluene, xylene, naphthalene, and solvent naphtha; esters such as methyl acetate, ethyl acetate, propyl acetate, n-butyl acetate, isopropyl acetate, isobutyl acetate, cellosolve acetate, propylene glycol methyl ether acetate, carbitol acetate, diethyl oxalate, ethyl pyruvate, ethyl 2-hydroxybutyrate, ethyl acetoacetate, amyl acetate, methyl lactate, ethyl lactate, methyl 3-methoxypropionate, ethyl 3-methoxypropionate, methyl 2-hydroxyisobutyrate, and ethyl 2-hydroxyisobutyrate; ketones such as acetone, methyl ethyl ketone, methyl isobutyl ketone, 2-hexanone, cyclohexanone, methyl amino ketone, and 2-heptanone; glycol ethers such as ethyl cellosolve, methyl cellosolve, methyl cellosolve acetate, ethyl cellosolve acetate, propylene glycol monomethyl ether, propylene glycol monoethyl ether, propylene glycol monobutyl ether, propylene glycol monomethyl ether acetate, propylene glycol monoethyl ether acetate, propylene glycol monobutyl ether acetate, dipropylene glycol dimethyl ether, and ethylene glycol monoalkyl ether; alcohols such as methanol, ethanol, iso-propanol, n-butanol, isobutanol, tert-butanol, sec-butanol, 3-pentanol, octyl alcohol, 3-methyl-3-methoxybutanol, and tert-amyl alcohol; glycols such as ethylene glycol and propylene glycol; cyclic ethers such as tetrahydrofuran, tetrahydropyran, and dioxane; amides such as N,N-dimethylformamide, N,N-dimethylacetamide, and N-methylpyrrolidone; ether alcohols such as methyl cellosolve, cellosolve, isopropyl cellosolve, butyl cellosolve, and diethylene glycol monomethyl ether; diethylene glycol monoethyl ether acetate; ethers such as cyclopentyl methyl ether; siloxanes such as hexamethyldisiloxane, hexaethyldisiloxane, octamethyltrisiloxane, octamethylcyclotetrasiloxane, and decamethylcyclopentasiloxane; and fluorine containing solvents such as 1,1,2-trichloro-1,2,2-trifluoroethane, 1,2-dichloro-1,1,2,2-tetrafluoroethane, dimethyl sulfoxide, 1,1-dichloro-1,2,2,3,3-pentafluoropropane (HCFC 225), ZEORORA H, 1,3-bis(trifluoromethyl)benzene, HFE 7100, HFE 7200, HFE 7300, CF₃CH₂OH, CF₃CF₂CH₂OH, and (CF₃)₂CHOH. Alternatively, the solvent may be a mixed solvent of two or more of such solvents.

The silicone oil is not limited, and examples thereof include a compound represented by the following general formula (3):

R^{1a}—(SiR^{3a}₂—O)_{f1}—SiR^{3a}₂—R^{1a} (3)
wherein
R^{1a} is each independently a hydrogen atom or a hydrocarbon group,
R^{3a} is each independently a hydrogen atom or a hydrocarbon group, and
f1 is 2 to 3,000.

R^{3a} is each independently a hydrogen atom or a hydrocarbon group. Such a hydrocarbon group is optionally substituted.

R^{3a} is, each independently, preferably an unsubstituted hydrocarbon group or a hydrocarbon group substituted with a halogen atom. Such a halogen atom is preferably a fluorine atom.

R^{3a} is, each independently, preferably a C₁₋₆ alkyl group or aryl group optionally substituted with a halogen atom, and more preferably a C₁₋₆ alkyl group or aryl group.

The C₁₋₆ alkyl group may be linear or may be branched, and is preferably linear. The C₁₋₆ alkyl group is preferably a C₁₋₃ alkyl group, and more preferably a methyl group.

The aryl group is preferably a phenyl group.

In one embodiment, R^{3a} is each independently a C₁₋₆ alkyl group, preferably a C₁₋₃ alkyl group, and more preferably a methyl group.

In another embodiment, R^{3a} is a phenyl group.

In another embodiment, R^{3a} is a methyl group or a phenyl group, and preferably a methyl group.

R^{1a} is each independently a hydrogen atom or a hydrocarbon group, and is the same as defined for R^{3a}.

R^{1a} is, each independently, preferably a C₁₋₆ alkyl group or aryl group optionally substituted with a halogen atom, and more preferably a C₁₋₆ alkyl group or aryl group.

In one embodiment, R^{1a} is each independently a C₁₋₆ alkyl group, preferably a C₁₋₃ alkyl group, and more preferably a methyl group.

In another embodiment, R^{1a} is a phenyl group.

In another embodiment, R^{1a} is a methyl group or a phenyl group, and preferably a methyl group.

f1 is 2 to 1,500. f1 may be preferably 5 or more, more preferably 10 or more, and still more preferably 15 or more, such as 30 or more or 50 or more. f1 may be preferably 1,000 or less, more preferably 500 or less, still more preferably 200 or less, and even more preferably 150 or less, such as 100 or less or 80 or less.

f1 may be preferably 5 to 1,000, more preferably 10 to 500, still more preferably 15 to 200, and even more preferably 15 to 150.

Examples of another silicone oil include a compound represented by the following (3b):

R^{1a}—R^{S12}—R^{3a} (3b)
wherein
R^{1a} is each independently a hydrocarbon group,
R^{3a} is each independently a hydrocarbon group,
R^{S12} is —R^{S1}—SiR²₂—,
R^{S1} is each independently a group represented by the following formula:

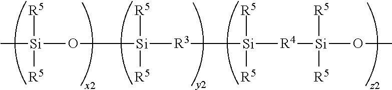

wherein
R³ is each independently a C₁₋₁₂ alkylene group, —R⁶—O—R⁶—, —R⁸—R⁷—R⁸, —R⁸—R⁷—R⁹—R⁷—R⁸—, —R⁸—R⁷—R⁹—R⁶—R⁹—R⁷—R⁸—, or —R⁹—R⁶—R⁹—R⁷—R⁹—R⁶—R⁹—,
R⁴ is each independently a C₁₋₁₂ alkylene group, —R⁶—O—R⁶—, —R⁸—R⁷—R⁸, —R⁸—R⁷—R⁹—R⁷—R⁸—, —R⁸—R⁷—R⁹—R⁶—R⁹—R⁷—R⁸—, or —R⁹—R⁶—R⁹—R⁷—R⁹—R⁶—R⁹—,
R⁶ is each independently a C₁₋₆ alkylene group,
R⁷ is each independently an optionally substituted phenylene group or naphthylene group,
R⁸ is each independently a single bond or a C₁₋₆ alkylene group,
R⁹ is each independently a single bond or an oxygen atom,
R⁵ is each independently a hydrocarbon group,
x2 is an integer of 0 to 200,
y2 is an integer of 0 to 200,
z2 is an integer of 0 to 200,
y2+z2 is 1 or more, and
the occurrence order of the respective repeating units enclosed in parentheses provided with x2, y2, or z2 is not limited in the formula, and
R² is each independently a hydrocarbon group.

The silicone oil may have an average molecular weight of 500 to 100,000, preferably 1,000 to 10,000. The molecular weight of the silicone oil may be measured using GPC.

As the silicone oil, a linear or cyclic silicone oil in which f1 in —(SiR^{3a}₂—O)_{f1}— is 30 or less can be used, for example. The linear silicone oil may be a so-called straight silicone oil or modified silicone oil. Examples of the straight silicone oil include dimethyl silicone oil, methyl phenyl silicone oil, and methyl hydrogen silicone oil. Examples of the modified silicone oil include those obtained by modifying a straight silicone oil with alkyl, aralkyl, polyether, higher fatty acid ester, fluoroalkyl, amino, epoxy, carboxyl, alcohol, or the like. Examples of the cyclic silicone oil include cyclic dimethylsiloxane oil.

The silicone oil may be contained in an amount of, for example, 0 to 50% by mass, preferably 0.001 to 30% by mass, and more preferably 0.1 to 5% by mass based on the surface-treating agent of the present disclosure.

In one embodiment, in the composition of the present disclosure, such a silicone oil may be contained in an amount of, for example, 0 to 300 parts by mass, preferably 0 to 100 parts by mass, more preferably 0 to 50 parts by mass, and still more preferably 0 to 10 parts by mass, based on 100 parts by mass in total of the compound of the present disclosure (in the case of two or more types, the total thereof, and the same applies below).

The silicone oil contributes to improving the surface lubricity of the surface-treating layer.

Examples of the alcohol include alcohols having 1 to 6 carbon atoms and optionally substituted with one or more fluorine atoms, such as methanol, ethanol, iso-propanol, tert-butanol, CF₃CH₂OH, CF₃CF₂CH₂OH, and (CF₃)₂CHOH. These alcohols added to the surface-treating agent improves the stability of the surface-treating agent.

Examples of the catalyst include acids (for example, acetic acid, hydrochloric acid, nitric acid, sulfuric acid, phosphoric acid, sulfonic acid, p-toluenesulfonic acid, trifluoroacetic acid, and the like), bases (for example, sodium hydroxide, potassium hydroxide, ammonia, triethylamine, diethylamine, and the like), transition metals (for example, Ti, Ni, Sn, Zr, Al, B, Si, Ta, Nb, Mo, W, Cr, Hf, V, and the like), and sulfur containing compounds or nitrogen containing compounds having an unshared electron pair in the molecular structure (for example, sulfoxide compounds, aliphatic amine compounds, aromatic amine compounds, phosphoric acid amide compounds, amide compounds, and urea compounds).

Examples of the aliphatic amine compounds may include diethylamine and triethylamine. Examples of the aromatic amine compounds may include aniline and pyridine.

In a preferred embodiment, the transition metal is contained as a transition metal compound represented by M-R, wherein M is a transition metal atom and R is a hydrolyzable group. By making the transition metal compound a compound in which a transition metal and a hydrolyzable group are bonded, the transition metal atom can be contained in the surface-treating layer more efficiently, and the friction durability and chemical resistance of the surface-treating layer can be further improved.

The above hydrolyzable group means a group that can undergo a hydrolysis reaction in the same manner as the hydrolyzable group with respect to the above fluorine atom containing silane compound, that is, means a group that can be removed from the transition metal atom by a hydrolysis reaction. Examples of the hydrolyzable group include —OR^{m}, —OCOR^{m}, —O—N═CR^{m}₂, —NR^{m}₂, —NHR^{m}, —NCO, and a halogen (in these formulae, R^{m} represents a substituted or unsubstituted C₁₋₄ alkyl group).

In a preferred embodiment, the hydrolyzable group is —OR^{m}, and preferably methoxy or ethoxy. By using an alkoxy group as the hydrolyzable group, the transition metal atom can be contained in the surface-treating layer more efficiently, and the friction durability and chemical resistance of the surface-treating layer can be further improved.

In one embodiment, the above hydrolyzable group may be the same as the hydrolyzable group contained in the fluorine atom containing silane compound described above. By making the hydrolyzable groups in the fluorine atom containing silane compound and the transition metal compound the same group, even when such hydrolyzable groups are mutually exchanged, its effect can be minimized.

In another embodiment, the above hydrolyzable group may be different from the hydrolyzable group contained in the fluorine atom containing silane compound described above. By making the hydrolyzable groups in the fluorine atom containing silane compound and the transition metal compound different, the reactivity of hydrolysis can be controlled.

In one embodiment, the above hydrolyzable group and the hydrolyzable group contained in the fluorine atom containing silane compound described above may be mutually interchanged in the surface-treating agent.

In a preferred embodiment, the transition metal compound is Ta(OR^{m})₅, and may be preferably Ta(OCH₂CH₃)₅.

The catalyst may be contained in an amount of, for example, 0.0002% by mass or more based on the entirety of the surface-treating agent. The catalyst may be contained in an amount of preferably 0.02% by mass or more, and more preferably 0.04% by mass or more, based on the entirety of the surface-treating agent. The catalyst may be contained in an amount of, for example, 10% by mass or less based on the entirety of the surface-treating agent, and in particular, it is contained in an amount of 1% by mass or less. The surface-treating agent of the present disclosure can contribute to the formation of a surface-treating layer with better durability when the catalyst is contained in the concentration as described above.

The content of the catalyst is preferably 0 to 10% by mass, more preferably 0 to 5% by mass, and particularly preferably 0 to 1% by mass, based on the fluorine atom containing silane compound of the present disclosure.

The catalyst promotes hydrolysis and dehydration condensation of the fluorine atom containing silane compound of the present disclosure, and promotes formation of a layer formed of the surface-treating agent of the present disclosure.

Examples of other components include, in addition to those described above, tetraethoxysilane, methyltrimethoxysilane, 3-aminopropyltrimethoxysilane, 3-glycidoxypropyltrimethoxysilane, and methyltriacetoxysilane.

The surface-treating agent of the present disclosure may contain, in addition to the components described above, trace amounts of Pt, Rh, Ru, 1,3-divinyltetramethyldisiloxane, triphenylphosphine, NaCl, KCl, silane condensation product, and the like as impurities.

In one embodiment, the surface-treating agent of the present disclosure is for a dry coating method, preferably for vacuum deposition.

In one embodiment, the surface-treating agent of the present disclosure is for a wet coating method, preferably for dip coating.

The surface-treating agent of the present disclosure can be formed into pellets by impregnating a porous material such as a porous ceramic material or a metal fiber such as a fiber obtained by, for example, solidifying steel wool in a cotton-like form therewith. Such pellets can be used in, for example, vacuum deposition.

### [Article]

Hereinafter, the article of the present disclosure will be described.

The article of the present disclosure includes a substrate and a layer (surface-treating layer) on the substrate surface, the layer being formed of the surface-treating agent of the present disclosure.

The substrate usable in the present disclosure may be composed of any suitable material such as glass, resin (which may be natural or synthetic resin such as a commonly used plastic material), metal, ceramics, semiconductors (such as silicon and germanium), fiber (such as woven fabric and nonwoven fabric), fur, leather, wood, pottery, stone, building materials, and sanitary articles.

For example, when the article to be produced is an optical member, the material constituting the surface of the substrate may be a material for an optical member, such as glass or a transparent plastic. When the article to be produced is an optical member, some layer (or film), such as a hard coat layer or an antireflection layer, may be formed on the surface (the outermost layer) of the substrate. The antireflection layer may be any of a single-layer antireflection layer and a multi-layer antireflection layer.

Examples of inorganic substances usable in the antireflection layer include SiO₂, SiO, ZrO₂, TiO₂, TiO, Ti₂O₃, Ti₂O₅, Al₂O₃, Ta₂O₅, Ta₃O₅, Nb₂O₅, HfO₂, Si₃N₄, CeO₂, MgO, Y₂O₃, SnO₂, MgF₂, and WO₃. One of these inorganic substances may be used singly, or two or more types thereof may be used in combination (for example, as a mixture). In the case of a multi-layer antireflection layer, it is preferable to use SiO₂ and/or SiO for the outermost layer thereof. When the article to be produced is an optical glass component for a touch panel, a part of the surface of the substrate (glass) may have a transparent electrode such as a thin film in which indium tin oxide (ITO), indium zinc oxide, or the like is used. The substrate, according to its specific configuration or the like, may have an insulating layer, an adhesive layer, a protecting layer, a decorated frame layer (I—CON), an atomizing film layer, a hard coating layer, a polarizing film, a phase difference film, a liquid crystal display module, or the like.

The shape of the substrate is not limited, and may be, for example, in the form of a plate, a film, or the like. The surface region of the substrate on which a surface-treating layer is to be formed may be at least a portion of the substrate surface, and may be suitably determined according to the application, specific configuration, and the like of an article to be produced.

In one embodiment, the substrate, or at least the surface portion thereof, may be composed of a material originally having a hydroxyl group. Examples of the material include glass, as well as metal (in particular, base metal) where a natural oxidized film or a thermal oxidized film is formed on the surface, ceramics, and semiconductors. Alternatively, when the substrate has an insufficient amount of hydroxyl groups or when the substrate originally has no hydroxyl group as in resin and the like, a pre-treatment may be performed on the substrate to thereby introduce or increase hydroxyl groups on the surface of the substrate. Examples of such a pre-treatment include a plasma treatment (for example, corona discharge) and ion beam irradiation. The plasma treatment can be suitably utilized to not only introduce or increase hydroxyl groups on the substrate surface, but also clean the substrate surface (remove foreign matter and the like).

Another example of such a pre-treatment is a method wherein a monolayer of a surface adsorbent having a carbon-carbon unsaturated bonding group is formed on the surface of the substrate by a LB method (a Langmuir-Blodgett method), a chemical adsorption method, or the like beforehand, and thereafter cleaving the unsaturated bond under an atmosphere containing oxygen, nitrogen, or the like.

In another embodiment, the substrate, or at least the surface portion thereof, may be composed of a material comprising another reactive group such as a silicone compound having one or more Si—H groups or alkoxysilane.

In a preferred embodiment, the substrate is glass. As the glass, sapphire glass, soda-lime glass, alkali aluminosilicate glass, borosilicate glass, alkali-free glass, crystal glass, and quartz glass are preferred, and chemically tempered soda-lime glass, chemically tempered alkali aluminosilicate glass, and chemically bonded borosilicate glass are particularly preferred.

In one embodiment, the article of the present disclosure may include a silicon oxide containing intermediate layer between the glass and the surface-treating layer. By providing such an intermediate layer, the adhesion between the glass and the surface-treating layer is improved, and the durability is improved.

In a preferred embodiment, the intermediate layer may contain an alkali metal in addition to silicon oxide.

Examples of the alkali metal include lithium, sodium, and potassium. The alkali metal is preferably sodium.

The thickness of the intermediate layer is not limited, and it is preferably 1 to 200 nm, and particularly preferably 1 to 20 nm. By setting the thickness of the intermediate layer to the lower limit value of the above range or more, the improvement effect of adhesion by the intermediate layer becomes greater.

The concentration of alkali metal atoms in the intermediate layer can be measured by various surface analyzers, such as TOF-SIMS, XPS (X-ray photoelectron spectroscopy), and XRF (X-ray fluorescence analysis).

The proportion of alkali metal atoms in all atoms of the entire intermediate layer can be obtained by XPS depth profile analysis by ion sputtering, which is performed by alternately repeating XPS measurements and etching of the surface by ion sputtering using an ion gun built into the XPS device.

In the intermediate layer, the average value of the concentration of alkali metal in the area with a depth of 1 nm or less from the surface in contact with the surface-treating layer is determined by obtaining the depth profile of the concentration of alkali metal atoms by TOF-SIMS (time-of-flight secondary ion mass spectrometry) depth profile analysis by ion sputtering, and then calculating the average value of the concentration of alkali metal atoms in the profile. The TOF-SIMS depth profile analysis by ion sputtering is performed by alternately repeating TOF-SIMS measurements and etching of the surface by ion sputtering using an ion gun built into the TOF-SIMS device.

The article of the present disclosure can be produced by forming a layer of the surface-treating agent of the present disclosure on the surface of the substrate and post-treating this layer as necessary, thereby forming a layer from the surface-treating agent of the present disclosure.

The layer of the surface-treating agent of the present disclosure can be formed by applying the surface-treating agent on the surface of the substrate such that the surface-treating agent coats the surface. The coating method is not limited. For example, a wet coating method and a dry coating method can be used.

Examples of the wet coating method include dip coating, spin coating, flow coating, spray coating, roll coating, gravure coating, wipe coating, squeegee coat method, die coat, inkjet, cast method, Langmuir-Blodgett method, and similar methods.

Examples of the dry coating method include deposition (usually, vacuum deposition), sputtering, CVD, and similar methods. Specific examples of the deposition method (usually, a vacuum deposition method) include resistive heating, high-frequency heating using electron beam, microwave, or the like, ion beam, and similar methods. Specific examples of the CVD method include plasma-CVD, optical CVD, thermal CVD, and similar methods.

Furthermore, coating by an atmospheric pressure plasma method can be performed.

When using the wet coating method, the surface-treating agent of the present disclosure can be applied to the substrate surface after being diluted with a solvent. From the viewpoint of the stability of the composition of the present disclosure and the volatility of the solvent, the following solvents are preferably used: aliphatic hydrocarbons such as hexane, cyclohexane, heptane, octane, nonane, decane, undecane, dodecane, and mineral spirits; aromatic hydrocarbons such as benzene, toluene, xylene, naphthalene, and solvent naphtha; esters such as methyl acetate, ethyl acetate, propyl acetate, n-butyl acetate, isopropyl acetate, isobutyl acetate, cellosolve acetate, propylene glycol methyl ether acetate, carbitol acetate, diethyl oxalate, ethyl pyruvate, ethyl 2-hydroxybutyrate, ethyl acetoacetate, amyl acetate, methyl lactate, ethyl lactate, methyl 3-methoxypropionate, ethyl 3-methoxypropionate, methyl 2-hydroxyisobutyrate, and ethyl 2-hydroxyisobutyrate; ketones such as acetone, methyl ethyl ketone, methyl isobutyl ketone, 2-hexanone, cyclohexanone, methyl amino ketone, and 2-heptanone; glycol ethers such as ethyl cellosolve, methyl cellosolve, methyl cellosolve acetate, ethyl cellosolve acetate, propylene glycol monomethyl ether, propylene glycol monoethyl ether, propylene glycol monobutyl ether, propylene glycol monomethyl ether acetate, propylene glycol monoethyl ether acetate, propylene glycol monobutyl ether acetate, dipropylene glycol dimethyl ether, and ethylene glycol monoalkyl ether; alcohols such as methanol, ethanol, iso-propanol, n-butanol, isobutanol, tert-butanol, sec-butanol, 3-pentanol, octyl alcohol, 3-methyl-3-methoxybutanol, and tert-amyl alcohol; glycols such as ethylene glycol and propylene glycol; cyclic ethers such as tetrahydrofuran, tetrahydropyran, and dioxane; amides such as N,N-dimethylformamide, N,N-dimethylacetamide, and N-methylpyrrolidone; ether alcohols such as methyl cellosolve, cellosolve, isopropyl cellosolve, butyl cellosolve, and diethylene glycol monomethyl ether; diethylene glycol monoethyl ether acetate; polyfluoroaromatic hydrocarbons (for example, 1,3-bis(trifluoromethyl)benzene); polyfluoroaliphatic hydrocarbons (for example, C₆F₁₃CH₂CH₃ (for example, ASAHIKLIN (R) AC-6000 manufactured by AGC Inc.), and 1,1,2,2,3,3,4-heptafluorocyclopentane (for example, Zeorolla® H manufactured by ZEON Corporation); ether alcohols such as hydrofluoroethers (HFE) (for example, alkyl perfluoroalkyl ethers (the perfluoroalkyl group and the alkyl group may be linear or branched), such as perfluoropropyl methyl ether (C₃F₇OCH₃) (for example, Novec™ 7000 manufactured by Sumitomo 3M Limited), perfluorobutyl methyl ether (C₄F₉OCH₃) (for example, Novec™ 7100 manufactured by Sumitomo 3M Limited), perfluorobutyl ethyl ether (C₄F₉OC₂H₅) (for example, Novec™ 7200 manufactured by Sumitomo 3M Limited), and perfluorohexyl methyl ether (C₂F₅CF(OCH₃)C₃F₇) (for example, Novec™ 7300 manufactured by SUMITOMO 3M), or CF₃CH₂OCF₂CHF₂ (for example, ASAHIKLIN® AE-3000 manufactured by AGC Inc.)) and cyclopentyl methyl ether; siloxanes such as hexamethyldisiloxane, hexaethyldisiloxane, octamethyltrisiloxane, octamethylcyclotetrasiloxane, and octamethylcyclopentasiloxane; and the like. One of these solvents may be used singly, or two or more may be used as a mixture.

In one embodiment, as the solvent when the wet coating method is used, a compound represented by R⁹⁰—OH can be used, for example.

R⁹⁰ is a monovalent organic group, preferably a C₁-2o alkyl group or a C₃₋₂₀ alkylene group, and these groups are optionally substituted with one or more substituents. Examples of the substituents may include a hydroxyl group and —OR⁹⁰¹ (where R⁹⁰¹ is a C₁₋₁₀ alkyl group, preferably a C₁₋₃ alkyl group, such as a methyl group).

When using the dry coating method, the surface-treating agent of the present disclosure may be directly subjected to the dry coating method, or may be diluted with the solvent before being subjected to the dry coating method.

A layer of the surface-treating agent is preferably formed such that the surface-treating agent of the present disclosure coexists in the layer with a catalyst for hydrolysis and dehydration condensation. Conveniently, in the case of a wet coating method, the surface-treating agent of the present disclosure is diluted with a solvent, and then, immediately before application to the substrate surface, a catalyst may be added to the diluted solution of the surface-treating agent of the present disclosure. In the case of a dry coating method, the surface-treating agent of the present disclosure to which a catalyst has been added is directly used to a deposition (usually vacuum deposition) treatment, or a pellet-like material may be used to a deposition (usually vacuum deposition) treatment, wherein the pellets are obtained by impregnating a porous body of metal such as iron or copper with the surface-treating agent of the present disclosure to which the catalyst has been added.

As the catalyst, any appropriate acids or bases, transition metals (such as Ti, Ni, Sn, Zr, Al, and B), sulfur containing compounds or nitrogen containing compounds having an unshared electron pair in the molecular structure (such as sulfoxide compounds, aliphatic amine compounds, aromatic amine compounds, phosphoric acid amide compounds, amide compounds, and urea compounds), and the like can be used. As the acid catalyst, for example, acetic acid, formic acid, trifluoroacetic acid, hydrochloric acid, nitric acid, sulfuric acid, phosphoric acid, sulfonic acid, methanesulfonic acid, p-toluenesulfonic acid, and the like can be used. Also, as the base catalyst, for example, ammonia, sodium hydroxide, potassium hydroxide, organic amines such as triethylamine and diethylamine, and the like can be used. Examples of the transition metals, aliphatic amine compounds, and aromatic amine compounds include the same as those described above.

The surface-treating layer contained in the article of the present disclosure has both high friction durability. In addition, the surface-treating layer may have not only high friction durability, but also have, depending on the compositional features of the surface-treating agent used, water-repellency, oil-repellency, antifouling property (for example, preventing fouling such as fingerprints from adhering), waterproof property (preventing water from penetrating into electronic components and the like), surface lubricity (or lubricity, such as removability of fouling including fingerprints by wiping and the like and excellent tactile sensations to the fingers), chemical resistance, and the like, and may be suitably utilized as a functional thin film.

Therefore, the present disclosure further relates to an optical material having the surface-treating layer in the outermost layer.

The optical material preferably includes a wide variety of optical materials, in addition to optical materials relating to displays and the like as exemplified below: for example, displays such as cathode ray tubes (CRTs; for example, PC monitors), liquid crystal displays, plasma displays, organic EL displays, inorganic thin-film EL dot matrix displays, rear projection displays, vacuum fluorescent displays (VFDs), field emission displays (FEDs); protective plates for such displays; and those obtained by performing an antireflection film treatment on their surfaces.

The article of the present disclosure may be, but is not limited to, an optical member. Examples of the optical member include lenses of glasses or the like; front surface protective plates, antireflection plates, polarizing plates, and anti-glare plates for displays such as PDPs and LCDs; touch panel sheets for equipment such as cell phones and portable information terminals; disc surfaces of optical discs such as Blu-ray® discs, DVD discs, CD-Rs, and MOs; optical fibers; and display surfaces of watches and clocks.

The article of the present disclosure may be medical equipment or a medical material. The article having a layer that is obtained according to the present disclosure may be an automobile interior or exterior member. Examples of the exterior material include the following: windows, light covers, and external camera covers. Examples of the interior material include the following: instrument panel covers, navigation system touch panels, and decorative interior materials.

The thickness of the layer is not limited. The thickness of the layer in the case of an optical member is in the range of 1 to 50 nm, 1 to 30 nm, and preferably 1 to 15 nm, from the viewpoint of optical performance, friction durability (abrasion resistance), and antifouling property.

While the embodiments have been described above, it will be understood that a wide variety of modifications in form and details can be made without departing from the spirit and scope of the claims.

The present disclosure provides [1] to [23] below.

[1] A fluorine atom containing silane compound represented by the following formula (1):

(Rf¹)_{α1}—X^{A}—(R^{Si})_{α2} (1)
wherein
Rf¹ each independently has at least one group selected from a monovalent organic group having A¹_{γ11}A²_{γ12}C— and a monovalent organic group containing a cyclic structure containing CF≡;
A¹ is a fluorine atom;
A² is each independently a hydrogen atom, a chlorine atom, or a bromine atom;
γ11 is each independently 1 or 2;
γ12 is each independently 1 or 2;
the sum of γ11 and γ12 is 3;
X^{A} is each independently a single bond, an oxygen atom, or a di- to decavalent organic group;
R^{Si} is a monovalent group containing a Si atom to which a hydroxyl group or a hydrolyzable group is bonded;
α1 is an integer of 1 to 9; and
α2 is an integer of 1 to 9.

[2] The fluorine atom containing silane compound according to [1], wherein Rf¹ is a group represented by the following formula:

A¹_{γ11}A²_{γ12}C—X^{B}—
wherein
A¹ is a fluorine atom;
A² is each independently a hydrogen atom, a chlorine atom, or a bromine atom;
γ11 is each independently 1 or 2;
γ12 is each independently 1 or 2;
the sum of γ11 and γ12 is 3; and
X^{B} is
   a single bond,
   a divalent group containing a polysiloxane group, or
   a group represented by —(CR^{A1}ₑ₁H₂₋ₑ₁)ₐ₁—(CFH)_{b1}—(CH₂)_{c1}—(O)_{d1}—
wherein
R^{A1} is a monovalent organic group having A¹_{γ11}A²_{y12}C—;
e1 is 1 or 2;
a1 is an integer of 0 to 200;
b1 is an integer of 0 to 200;
c1 is an integer of 0 to 200;
d1 is an integer of 0 to 200; and
the occurrence order of the respective repeating units enclosed in parentheses provided with the signs a1, b1, c1, and d1 is not limited.

[3] The fluorine atom containing silane compound according to [2], wherein X^{B} is a group represented by —(CR^{Al}ₑ₁H₂₋ₑ₁)ₐ₁—(CFH)_{b1}—(CH₂)_{c1}—(O)_{d1}—
wherein
R^{A1} is a monovalent organic group having A¹_{γ11}A²_{γ12}C—;
A¹, A², γ11, γ12, e1, a1, b1, c1, and d1 are the same as defined in [2]; and
the occurrence order of the respective repeating units enclosed in parentheses provided with the signs a1, b1, c1, and d1 is not limited.

[4] The fluorine atom containing silane compound according to [2], wherein X^{B} is a group represented by —(CFH)_{b1}—(CH₂)_{c1}—(O)_{d1}—
wherein
b1 and c1 are the same as defined in [2];
d1 is an integer of 0 to 10; and
the occurrence order of the respective repeating units enclosed in parentheses provided with the signs bl, c1, and dl is not limited.

[5] The fluorine atom containing silane compound according to [2], wherein X^{B} is a group represented by —(CH₂)_{c1}—
wherein c1 is an integer of 0 to 30.

[6] The fluorine atom containing silane compound according to [2], wherein X^{B} is a group represented by —O—(CH₂)_{c1}—
wherein c1 is an integer of 0 to 30.

[7] The fluorine atom containing silane compound according to [2], wherein X^{B} is a group represented by —(CH₂)_{g1}—SiR^{s}₂O(—SiR^{s}₂O')ₙ₁₁SiR^{s}₂—(CH₂)_{g1}—
wherein
R^{s} is each independently a hydrogen atom, a hydroxyl group, or a hydrocarbon group;
n11 is an integer of 1 to 1,500; and
g1 is each independently an integer of 0 to 30.

[8] The fluorine atom containing silane compound according to any one of [1] to [7], wherein A¹_{γ11}A²_{γ12}C— is HCF₂—.

[9] The fluorine atom containing silane compound according to any one of [1] to [8], wherein X^{A} is a single bond, —(X⁵²)₁₅—, or a group represented by the following formula (X^{A1}):

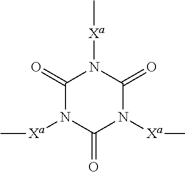

wherein
X⁵² is each independently a group selected from the group consisting of —O—, —S—, o-, m- or p-phenylene group, —CO—, —C(O)O—, —OC(O)—, —CONR⁵³—, —NR⁵³CO—, —O—CONR⁵³—, —NR⁵³CO—O—, —NR⁵³CONR⁵³—, —NR⁵³—, and —(CH₂)ₙ₅—;
R⁵³ is each independently a hydrogen atom or a monovalent organic group;
n5 is each independently an integer of 1 to 30;
l5 is an integer of 1 to 10; and
X^{a} is each independently a single bond or a divalent linking group.

[10] The fluorine atom containing silane compound according to any one of [1] to [9], wherein R^{Si} is a group represented by the following formula (S1), (S2), (S3), (S4), or (S5):

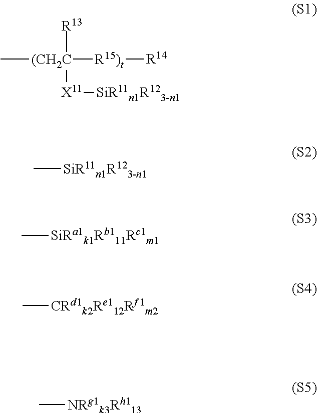

wherein
R¹¹ is each independently a hydroxyl group or a hydrolyzable group;
R¹² is each independently a monovalent organic group;
n1 is each independently an integer of 0 to 3 for each (SiR¹¹ₙ₁R¹²₃₋ₙ₁) unit;
X¹¹ is each independently a single bond or a divalent organic group;
R¹³ is each independently a hydrogen atom or a monovalent organic group;
t is each independently an integer of 2 or more;
R¹⁴ is each independently a hydrogen atom, a halogen atom, or —X¹¹—SiR¹¹ₙ₁R¹²³₃₋ₙ₁;
R¹⁵ is each independently a single bond, an oxygen atom, an alkylene group having 1 to 6 carbon atoms, or an alkyleneoxy group having 1 to 6 carbon atoms;
R^{a1} is each independently —Z¹—SiR²¹ₚ₁R²²_{q1}R²³ᵣ₁;
Z¹ is each independently a divalent organic group;
R²¹ is each independently —Z^{1′}—SiR^{21′}_{p1′}R^{22′}_{q1′}R^{23′}_{r1′;}
R²² is each independently a hydroxyl group or a hydrolyzable group;
R²³ is each independently a monovalent organic group;
p1 is each independently an integer of 0 to 3;
q1 is each independently an integer of 0 to 3;
r1 is each independently an integer of 0 to 3;
Z^{1′} is each independently a divalent organic group;
R^{21′} is each independently —Z^{1″}—SiR^{22″}_{q1″}R^{23″}_{r1″};
R^{22′} is each independently a hydroxyl group or a hydrolyzable group;
R^{23′} is each independently a monovalent organic group;
p1′ is each independently an integer of 0 to 3;
q1′ is each independently an integer of 0 to 3;
r1′ is each independently an integer of 0 to 3;
Z^{1″} is each independently a divalent organic group;
R^{22″} is each independently a hydroxyl group or a hydrolyzable group;
R^{23″} is each independently a monovalent organic group;
q1″ is each independently an integer of 0 to 3;
r1″ is each independently an integer of 0 to 3;
R^{b1} is each independently a hydroxyl group or a hydrolyzable group;
R^{c1} is each independently a monovalent organic group;
k1 is each independently an integer of 0 to 3;
l1 is each independently an integer of 0 to 3;
m1 is each independently an integer of 0 to 3;
R^{d1} is each independently —Z²—CR³¹ₚ₂R³²_{q2}R³³ᵣ₂;
Z² is each independently a single bond, an oxygen atom, or a divalent organic group;
R³¹ is each independently —Z^{2′}—CR^{32′}_{q2′}R^{33′}_{r2′;}
R³² is each independently —Z³—SiR³⁴ₙ₂R³⁵₃₋ₙ₂;
R³³ is each independently a hydrogen atom, a hydroxyl group, or a monovalent organic group;
p2 is each independently an integer of 0 to 3;
q2 is each independently an integer of 0 to 3;
r2 is each independently an integer of 0 to 3;
Z^{2′} is each independently a single bond, an oxygen atom, or a divalent organic group;
R^{32′} is each independently —Z³—SiR³⁴ₙ₂R³⁵₃₋ₙ₂;
R^{33′} is each independently a hydrogen atom, a hydroxyl group, or a monovalent organic group;
q2′ is each independently an integer of 0 to 3;
r2′ is each independently an integer of 0 to 3;
Z³ is each independently a single bond, an oxygen atom, or a divalent organic group;
R³⁴ is each independently a hydroxyl group or a hydrolyzable group;
R³⁵ is each independently a monovalent organic group;
n2 is each independently an integer of 0 to 3;
R^{e1} is each independently —Z³—SiR³⁴ₙ₂R³⁵₃₋ₙ₂;
R^{f1} is each independently a hydrogen atom, a hydroxyl group, or a monovalent organic group;
k2 is each independently an integer of 0 to 3;
l2 is each independently an integer of 0 to 3;
m2 is each independently an integer of 0 to 3;
R^{g1} and R^{h1} are each independently —Z⁴—SiR¹¹ₙ₁R¹²₃₋ₙ₁, —Z⁴—SiR^{a1}ₖ₁R^{b1}₁₁R^{c1}ₘ₁, or —Z⁴—CR^{d1}ₖ₂R^{e1}₁₂R^{f1}ₘ₂;
Z⁴ is each independently a single bond, an oxygen atom, or a divalent organic group;
k3 is 1 or 2; and
l3 is 0 or 1,
provided that in the formula (S1), (S2), (S3), (S4), or (S5), at least two Si atoms to which a hydroxyl group or a hydrolyzable group is bonded are present.

[11] A surface-treating agent comprising the fluorine atom containing silane compound according to any one of [1] to [10].

[12] The surface-treating agent according to [11], further comprising a condensed product of the fluorine atom containing silane compound according to [1].

[13] The surface-treating agent according to [11] or [12], further comprising an alcohol represented by R⁹⁰—OH wherein R⁹⁰ is a monovalent organic group.

[14] The surface-treating agent according to any one of [11] to [13], which is for vacuum deposition.

[15] The surface-treating agent according to any one of [11] to [13], which is for wet coating.

[16] A pellet comprising the surface-treating agent according to any one of [11] to [15].

[17] An article comprising a substrate and a layer on the substrate, the layer being formed from the fluorine atom containing silane compound according to any one of [1] to [10].

[18] The article according to [17], comprising an intermediate layer containing silicon oxide between the substrate and the layer.

[19] The article according to [18], wherein the intermediate layer comprises alkali metal atoms.

[20] The article according to [19], wherein at least a portion of the alkali metal atoms are sodium.

[21] The article according to any one of [17] to [20], which is an optical member.

[22] The article according to [21], which is a display.

[23] A compound represented by any of the following formulae (2a) to (2g):

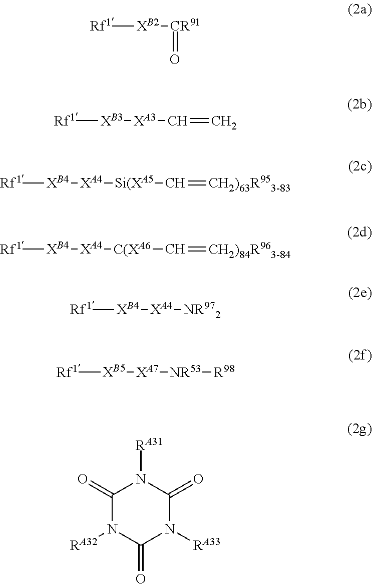

wherein
Rf^{1′}— is each independently A¹¹_{γ11}A¹²_{y12}C— or a cyclic structure containing CF≡;
   A¹¹ is a fluorine atom;
   A¹² is each independently a hydrogen atom, a chlorine atom, or a bromine atom;
   γ11 is each independently 0 or 1;
   γ12 is each independently 1 or 2; and
   the sum of γ11 and γ12 is 3;
—R⁹¹ is a hydroxyl group, —F, —Cl, or a —O-C1-3 alkyl group;
X^{B2} is (CH₂)_{c21}, (CH₂)_{c22}—O—(CH₂)_{c23}, or a divalent group containing a polysiloxane group;
   c21, c22, and c23 are each independently an integer of 0 to 200;
   provided that the sum of c22 and c23 is an integer of 0 to 200;
   Rf^{1′}—X^{B2}— is Rf¹—; and
   Rf¹— each independently has at least one group selected from a monovalent organic group having A¹_{γ11}A²_{γ12}C— and a monovalent organic group containing a cyclic structure containing CF≡;
X^{B3} is (CH₂)_{c11}, (CH₂)_{c12}—O—(CH₂)_{c13}, or a divalent group containing a polysiloxane group;
   c11, c12, and c13 are each independently an integer of 0 to 200;
   provided that the sum of c12 and c13 is an integer of 0 to 200;
X^{A3} is each independently a single bond or C(═O)NR⁵³—(CH₂)_{c14};
   R⁵³ is a hydrogen atom or a monovalent organic group; and
   c14 is an integer of 0 to 30;
X^{B4} is each independently (CH₂)_{c11}, (CH₂)_{c12}—O—(CH₂)_{c13}, or a divalent group containing a polysiloxane group;
   c11, c12, and c13 are each independently an integer of 0 to 200;
   provided that the sum of c12 and c13 is an integer of 0 to 200;
   Rf^{1′}—X^{B4}— corresponds to Rf¹; and
   Rf¹— each independently has at least one group selected from a monovalent organic group having A¹_{γ11}A²_{γ12}C— and a monovalent organic group containing a cyclic structure containing CF≡;
X^{A4} is each independently a single bond or C(═O)NR⁵³—(CH₂)_{c15};
   c15 is an integer of 0 to 30;
X^{A5} is each independently a single bond or a divalent organic group;
R⁹⁵ is each independently a hydrogen atom, a hydroxyl group, or a monovalent organic group;
δ3 is an integer of 1 to 3;
X^{A6} is each independently a single bond, an oxygen atom, or a divalent organic group;
R⁹⁶ is each independently a hydrogen atom, a hydroxyl group, or a monovalent organic group;
δ4 is an integer of 1 to 3;
—R⁹⁷ is each independently represented by —R⁹²—CH═CH₂ or —R⁹⁴-Q^{A1}(R⁹²—CH═CH₂)_{δ31}R⁹³δ32;
   R⁹² is a single bond, an oxygen atom, or a divalent organic group;
   R⁹⁴ is a single bond, an oxygen atom, or a divalent organic group;
   Q^{A1} is each independently N, Si, or C;
   R⁹³ is a hydrogen atom, a hydroxyl group, or a monovalent organic group;
   δ31 and δ32 are each independently an integer of 1 or more; and
   the sum of δ31 and δ32 is the valence of Q^{A1}−1;
X^{B5} is represented by (CH₂)_{c11}, (CH₂)_{c12}—O—(CH₂)_{c13}, or a divalent group containing a polysiloxane group;
   c11, c12, and c13 are each independently an integer of 0 to 200;
   provided that the sum of c12 and c13 is an integer of 0 to 200;
X^{A7} is a single bond or C(═O);
—R⁹⁸ is represented by —R⁹²—CH═CH₂ or —R⁹⁴-Q^{A1}(R⁹²—CH═CH₂))_{δ31}R⁹³_{δ32};
—R^{A31} is represented by —Rf¹;
Rf¹— each independently has at least one group selected from a monovalent organic group having A¹_{γ11}A²_{γ12}C— and a monovalent organic group containing a cyclic structure containing CF≡;
—RA³² is represented by —X^{A31}—CH═CH₂ or —X^{A33}-Q^{A2}(X^{A32}—CH═CH₂)_{δ41}R³⁶_{δ42};
—RA³³ is represented by —Rf¹, —X^{A31}—CH═CH₂, or —X^{A33}-Q^{A2}(X^{A32}—CH═CH₂))_{δ41}R³⁶_{δ42};
X^{A31}, X^{A32}, and X^{A33} are each independently a single bond, an oxygen atom, or a divalent organic group;
Q^{A2} is each independently N, Si, or C;
R³⁶ is a hydrogen atom, a hydroxyl group, or a monovalent organic group;
δ41 and δ42 are each independently an integer of 1 or more; and
the sum of 541 and 542 is the valence of Q^{A2}−1.

### EXAMPLES

The present disclosure will now be described more specifically by way of the Examples below, but the present disclosure is not limited to the Examples.

### Synthetic Example 1

Methyl 9-formylnonanoate (400 mg, 2 mmol) and dichloromethane (20 mL) were mixed and cooled in an ice bath, and then (diethylamino)sulfur trifluoride (DAST) (570 uL, 3.9 mmol) was slowly added dropwise. After stirring in an ice bath for 2 hours, water was slowly added dropwise, and the temperature was raised to room temperature spontaneously. Thereafter, after washing with water and saturated brine and drying over magnesium sulfate, concentration under reduced pressure was performed to obtain Compound (1) as a colorless liquid.

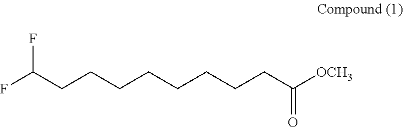 [SMILES: COC(=O)CCCCCCCCC(F)F]

¹H NMR (CDCl₃, 400 MHz) δ 5.79 (tt, J=56.7, 4.4 Hz, 1H), 3.67 (s, 3H), 2.31 (t, J=7.6 Hz, 2H), 1.80-1.74 (m, 2H), 1.65-1.59 (m, 2H), 1.48-1.40 (2H), 1.35-1.28 (m, 8H) ppm. ¹⁹F NMR (CDCl₃, 375 MHz) δ −115.6 (td, J=56.7, 18.0 Hz, 2F) ppm.

### Synthetic Example 2

Compound (1) (400 mg, 1.8 mmol) obtained in Synthetic Example 1, allylamine (1.6 mL), and 1,5,7-triazabicyclo[4.4.0]dec-5-ene dichloromethane (320 mg) were mixed and stirred at 50° C. for 2 hours, and then allowed to cool to room temperature. Thereafter, after dilution with chloroform, washing with hydrochloric acid and saturated brine, and drying over magnesium sulfate, concentration under reduced pressure was performed to obtain 0.35 g of Compound (2) as a colorless solid.

The product was then purified by silica gel column chromatography (eluent: toluene→chloroform→ethyl acetate).

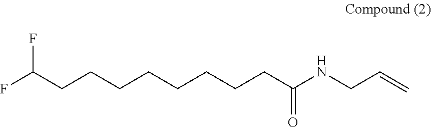 [SMILES: C=CCNC(=O)CCCCCCCCC(F)F]

¹H NMR (CDCl₃, 400 MHz) δ 5.88-5.78 (m, 1H), 5.78 (tt, J=57.0, 4.8 Hz, 1H), 5.52 (brs, 1H), 5.20-5.15 (m, 1H), 5.15-5.11 (m, 1H), 3.88 (t, J=5.2 Hz, 2H), 2.19 (t, J=8.0 Hz, 2H), 1.87-1.60 (m, 4H), 1.45-1.39 (m, 2H), 1.38-1.25 (m, 8H) ppm.

¹⁹F NMR (CDCl3, 375 MHz) δ −115.6 (td, J=57.0, 15.0 Hz, 2F) ppm.

### Synthetic Example 3

0.39 g of Compound (2) obtained in Synthetic Example 2, 8.4 mL of toluene, 0.0840 g of pyridine, and 0.5 mL of a xylene solution containing a Pt complex of 1,3-divinyl-1,1,3,3-tetramethyldisiloxane at 2% were each added, 0.64 mL of trimethoxysilane was then charged, and the mixture was stirred at room temperature overnight. Subsequent purification yielded 0.70 g of the following Compound (3).

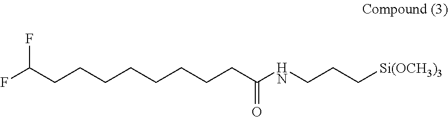

¹H NMR (CDCl₃, 400 MHz) δ [ppm]: −0.018-0.149 (m), 0.621-0.662 (m), 1.245-1.299 (m), 1.391-1.464 (m), 1.575-1.670 (m), 1.730-1.869 (m), 2.119-2.158 (t), 3.230-3.262 (m), 3.528-3.613 (m), 5.625-5.933 (tt)

### Synthetic Example 4

Compound (1) (0.5 g) obtained in Synthetic Example 1, diallylamine (0.6 g), and 1,5,7-triazabicyclo[4.4.0]dec-5-ene dichloromethane (0.3 g) were mixed and stirred at 80° C. overnight, and then allowed to cool to room temperature. Thereafter, after dilution with toluene and washing with hydrochloric acid, concentration under reduced pressure and purification by silica gel column chromatography yielded 530 mg of the following Compound (4) as a yellow liquid.

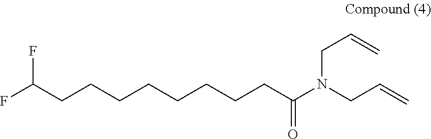 [SMILES: C=CCN(CC=C)C(=O)CCCCCCCCC(F)F]

¹H NMR (CDCl₃, 400 MHz) δ 5.79 (tt, J=59.6, 4.4 Hz, 1H), 5.81-5.71 (m, 2H), 5.22-5.09 (m, 4H), 3.99 (d, J=6.0 Hz, 2H), 3.87 (d, J=4.8 Hz, 2H), 2.30 (t, J=8.0 Hz, 2H), 1.88-1.74 (m, 2H), 1.68-1.59 (m, 2H), 1.48-1.39 (2H), 1.38-1.28 (m, 8H) ppm.

¹⁹F NMR (CDCl₃, 375 MHz) δ −115.6 (td, J=59.6, 18.0 Hz, 2F) ppm.

### Synthetic Example 5

0.52 g of Compound (4) obtained in Synthetic Example 4, 9.0 mL of toluene, 0.0603 g of pyridine, and 0.5 mL of a xylene solution containing a Pt complex of 1,3-divinyl-1,1,3,3-tetramethyldisiloxane at 2% were each added, 1.4 mL of trimethoxysilane was then charged, and the mixture was stirred at room temperature overnight. Thereafter, purification was performed, thereby obtaining 0.71 g of the following Compound (5), which has trimethoxysilyl groups at ends.

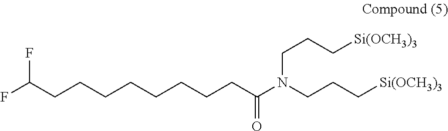

¹H NMR (CDCl₃, 400 MHz) δ [ppm]: 0.011-0.203 (m), 0.493-0.635 (m), 1.208-1.851 (m), 2.251-2.396 (m), 3.145-3.301 (m), 3.471-3.660 (m), 5.618-5.926(tt)

### Synthetic Example 6

0.5 g of Compound (1) obtained in Synthetic Example 1, 2,2-bis(1-propenyl)-4-pentanamine (1.1 g), and 1,5,7-triazabicyclo[4.4.0]dec-5-ene dichloromethane (0.3 g) were mixed and stirred at 50° C. overnight, and then allowed to cool to room temperature. Thereafter, after dilution with toluene and washing with hydrochloric acid, concentration under reduced pressure and purification by silica gel column chromatography yielded 680 mg of the following Compound (6) as a yellow liquid.

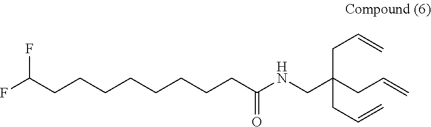 [SMILES: C=CCC(CC=C)(CC=C)CNC(=O)CCCCCCCCC(F)F]

¹H NMR (CDCl₃, 400 MHz) δ 5.94-5.63 (m, 4H), 5.52 (t, J=6.4 Hz, 1H), 5.21-5.07 (m, 6H), 3.20 (d, J=6.4 Hz, 2H), 2.33 (t, J=7.6 Hz, 2H), 2.03 (d, J=7.6 Hz, 6H), 1.88-1.73 (m, 2H), 1.66-1.54 (m, 2H), 1.48-1.38 (2H), 1.38-1.28 (m, 8H) ppm.

¹⁹F NMR (CDCl₃, 375 MHz) δ −115.6 (td, J=56.3, 17.6 Hz, 2F) ppm.

### Synthetic Example 7

0.69 g of Compound (6) obtained in Synthetic Example 6, 9.7 mL of toluene, 0.0703 g of pyridine, and 0.5 mL of a xylene solution containing a Pt complex of 1,3-divinyl-1,1,3,3-tetramethyldisiloxane at 2% were each added, 2.4 mL of trimethoxysilane was then charged, and the mixture was stirred at room temperature overnight. Thereafter, purification was performed, thereby obtaining 1.30 g of the following Compound (7), which has trimethoxysilyl groups at ends.

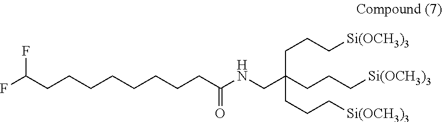

¹H NMR (CDCl₃, 400 MHz) δ [ppm]: 0.025-0.154 (m), 0.537-0.654 (m), 1.168-1.459 (m), 2.269-2.361 (m), 3.551-3.656 (m), 3.471-3.660(m), 5.636-5.944(tt)

### Synthetic Example 8

10-Undecenal (4 g, 24 mmol) and dichloromethane (200 mL) were mixed and cooled in an ice bath, and then (diethylamino)sulfur trifluoride (DAST) (7 mL, 48 mmol) was slowly added dropwise. After stirring in an ice bath for 2 hours, water was slowly added dropwise and the temperature was raised to room temperature spontaneously. Thereafter, after washing with water and saturated brine and drying over magnesium sulfate, concentration under reduced pressure was performed to obtain 4.3 g of the following Compound (8) as a colorless oily substance.

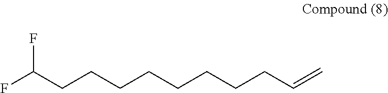

¹H NMR (CDCl₃, 400 MHz) δ 5.86-5.79 (m, 1H), 5.79 (tt, J=57.0, 4.4 Hz, 1H), 5.03-4.96 (m, 1H), 4.95-4.91 (m, 1H), 2.07-2.01 (m, 2H), 1.88-1.74 (m, 2H), 1.48-1.30 (12H) ppm.

¹⁹F NMR (CDCl₃, 375 MHz) δ −115.3 (td, J=57.18 Hz, 2F) ppm.

### Synthetic Example 9

0.95 g of Compound (8) obtained in Synthetic Example 8, 25 mL of toluene, 0.2 mL of pyridine, and 1.5 mL of a xylene solution containing a Pt complex of 1,3-divinyl-1,1,3,3-tetramethyldisiloxane at 2% were each added, 2.0 mL of trimethoxysilane was then charged, and the mixture was stirred at room temperature overnight. Thereafter, purification was performed, thereby obtaining 2.07 g of the following Compound (9), which has a trimethoxysilyl group at an end.

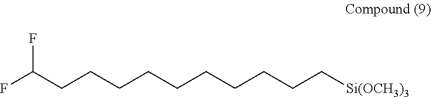

¹H NMR (CDCl₃, 400 MHz) δ [ppm]: −0.014-0.131 (m), 0.615-0.656 (m), 1.212-1.465 (m), 1.730-1.869 (m), 3.534-3.634 (m), 5.624-5.933 (tt)

### Synthetic Example 10

To a flask were added 18-bromo-1-octadecene (5 g), Pd₂ (dba)₃ (0.69 g), dppf (0.86 g), copper(I) iodide (2.87 g), cesium fluoride (9.09 g), difluoromethyltrimethylsilane (7.49 g), and dimethylformamide (50 mL), and the mixture was stirred at 60° C. for 6 hours. Toluene and silica gel were added to the reaction solution, which was filtered, and the filtrate was then washed with an aqueous ammonium chloride solution and water in this order. This solution was concentrated under reduced pressure, and the residue was purified by silica gel column chromatography (eluent: hexane) to yield 1.88 g of Compound (10) as a colorless liquid.

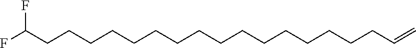 [SMILES: C=CCCCCCCCCCCCCCCCCC(F)F]

¹H-NMR (400 MHz, chloroform-D) δ [ppm]: 1.26-1.46 (m, 28H), 1.72-1.88 (m, 2H), 2.01-2.09 (m, 2H), 4.91-5.01 (m, 2H), 5.63-5.94 (m, 2H)

¹⁹F-NMR (376 MHz, chloroform-D) δ [ppm]: −115.6 (dt, 2F, J=56.8, 17.7 Hz)

### Synthetic Example 11

To a flask were added Compound (10) (0.88 g) obtained in Synthetic Example 10, Karstedt's catalyst (0.19 g, xylene solution containing platinum at 2%), trimethoxysilane (1.07 g), pyridine (0.03 g), and toluene (5 mL), the mixture was stirred at room temperature for 4 hours, and then concentrated under reduced pressure to obtain 1.20 g of Compound (11) as a yellow liquid.

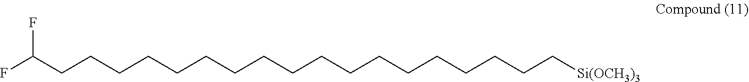

¹H-NMR (400 MHz, chloroform-D) δ [ppm]: 0.62-0.66 (m, 2H), 1.25-1.47 (m, 34H), 1.74-1.88 (m, 2H), 3.54-3.62 (m, 11H), 5.79 (tt, 1H, J=56.9, 4.6 Hz)

¹⁹F-NMR (376 MHz, chloroform-D) δ [ppm]: −115.6 (dt, 2F, J=56.8, 17.7 Hz)

### Synthetic Example 12

To a flask were added Compound (10) (0.93 g) obtained in Synthetic Example 10, trichlorosilane (2.50 g), triacetoxymethylsilane (0.03 g), Karstedt's catalyst (0.60 g, xylene solution containing platinum at 2%), and toluene (20 mL), the mixture was stirred at 60° C. for 2 hours. After concentrating the reaction solution under reduced pressure, tetrahydrofuran (10 mL) was added, and while cooling to 5° C. or lower, allylmagnesium chloride (23 mL, 0.8 mol/L tetrahydrofuran solution) was added dropwise, and the mixture was warmed to room temperature and stirred for 12 hours. Toluene and an aqueous hydrochloric acid solution were added to the reaction solution, which was stirred, allowed to stand still, and then the aqueous layer was removed. The remaining organic layer was washed with water, concentrated under reduced pressure, and the residue was then purified by silica gel column chromatography (eluent: hexane) to yield 1.25 g of Compound (12) as a colorless liquid.

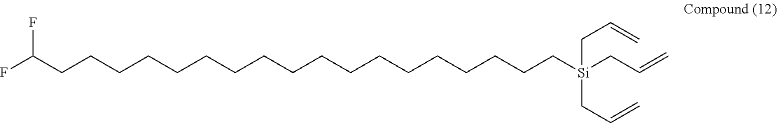 [SMILES: C=CC[Si](CC=C)(CC=C)CCCCCCCCCCCCCCCCCCC(F)F]

¹H-NMR (400 MHz, chloroform-D) δ [ppm]: 0.52-0.59 (m, 2H), 0.83-0.95 (m, 2H), 1.26-1.29 (m, 30H), 1.57-1.61 (m, 6H), 1.71-1.92 (m, 2H), 4.84-4.90 (m, 6H), 5.63-5.94 (m, 4H) 19F-NMR (376 MHz, chloroform-D) δ [ppm]: −115.6 (dt, 2F, J=56.8, 17.7 Hz)

### Synthetic Example 13

To a flask were added Compound (12) (1.25 g) obtained in Synthetic Example 12, Karstedt's catalyst (0.05 g, containing platinum at 20%), trimethoxysilane (3.02 g), pyridine (0.09 g), and toluene (15 mL), the mixture was stirred at room temperature for 4 hours, and then concentrated under reduced pressure to obtain 1.52 g of Compound (13) as a yellow liquid.

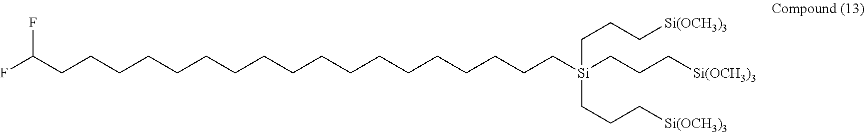

¹H-NMR (400 MHz, chloroform-D) δ [ppm]: 0.39-0.50 (m, 2H), 0.54-0.62 (m, 6H), 0.65-0.72 (m, 6H), 1.25-1.46 (m, 38H), 1.74-1.88 (m, 2H), 3.51-3.63 (m, 27H), 5.78 (tt, 1H, J=56.9, 4.6 Hz) 19F-NMR (376 MHz, chloroform-D) δ [ppm]: −115.6 (dt, 2F, J=56.8, 17.7 Hz)

### Synthetic Example 14

To a flask were added 22-tricosenoic acid (0.5 g), thionyl chloride (1.5 mL), and dimethylformamide (1 drop), and the mixture was stirred at 60° C. for 4 hours. After concentrating the reaction solution under reduced pressure, chloroform (1 mL) and 2,2-difluoroethanol (1 mL) were added, and while cooling to 5° C. or lower, pyridine (0.17 g) was added dropwise, and the mixture was warmed to room temperature and stirred for 12 hours. Chloroform and an aqueous hydrochloric acid solution were added to the reaction solution, which was stirred, allowed to stand still, and then the aqueous phase was removed. The remaining organic phase was washed with water, dehydrated over anhydrous sodium sulfate, and concentrated under reduced pressure to yield 0.50 g of Compound (14) as a pale yellow solid.

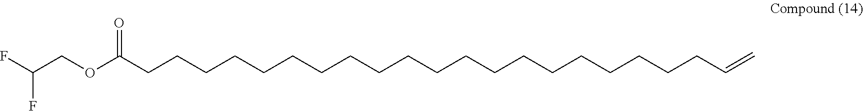 [SMILES: C=CCCCCCCCCCCCCCCCCCCCCC(=O)OCC(F)F]

¹H-NMR (400 MHz, chloroform-D) δ [ppm]: 1.25-1.37 (m, 36H), 2.01-2.22 (m, 2H), 2.33-2.39 (m, 2H), 4.27 (td, 2H, J=13.7, 4.1 Hz), 4.91-5.02 (m, 2H), 5.76-6.08 (m, 2H)

¹⁹F-NMR (376 MHz, chloroform-D) δ [ppm]: −125.5 (dt, 2F, J=53.8, 15.0 Hz)

### Synthetic Example 15

To a flask were added Compound (14) (0.88 g) obtained in Synthetic Example 14, Karstedt's catalyst (0.19 g, xylene solution containing platinum at 2%), trimethoxysilane (1.07 g), pyridine (0.03 g), and toluene (5 mL), the mixture was stirred at room temperature for 4 hours, and then concentrated under reduced pressure to obtain 1.20 g of Compound (15) as a yellow liquid.

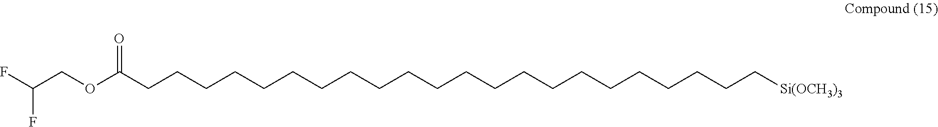

¹H-NMR (400 MHz, chloroform-D) δ [ppm]: 0.62-0.66 (m, 2H), 1.25-1.47 (m, 34H), 1.74-1.88 (m, 2H), 3.54-3.62 (m, 11H), 5.79 (tt, 1H, J=56.9, 4.6 Hz)

¹⁹F-NMR (376 MHz, chloroform-D) δ [ppm]: −115.6 (dt, 2F, J=56.8, 17.7 Hz)

### Synthetic Example 16

Stearoyl chloride (5 g), allylamine (2.5 mL), and dichloromethane (15 mL) were mixed and stirred at room temperature overnight. The mixed solution was diluted with dichloromethane, washed with hydrochloric acid and water, and then concentrated under reduced pressure to obtain Compound (16): C₁₇H₃₅—CONH—CH₂CH═CH₂ (5.0 g).

### Compound (16)

¹H NMR (CDCl₃, 400 MHz) δ [ppm]: 0.85-0.88 (m, 3H), 1.23-27 (m, 28H), 1.60-1.70 (m, 2H), 2.15-2.22 (m, 2H), 3.85-3.89 (m, 2H), 5.01-5.15 (m, 2H), 5.78-5.86 (m, 1H).

C₁₇H₃₅—CONH—CH₂CH═CH₂ (5 g), toluene (70 mL), a solution of Karstedt's catalyst in xylene (2%, 3.5 mL), aniline (0.5 g), and trimethoxysilane (5.9 mL) were mixed and stirred at room temperature overnight, and then concentrated under reduced pressure to obtain Compound B: C₁₇H₃₅—CONH—CH₂CH₂CH₂Si(OCH₃)₃ (6.3 g).

### Compound B

¹H NMR (CDCl₃, 400 MHz) δ [ppm]: 0.53-0.65 (m, 2H) 0.85-0.91 (m, 3H), 1.24-27 (m, 28H), 1.60-1.648 (m, 4H), 2.12-2.24 (m, 2H), 3.21-3.26 (m, 2H) 3.56-3.60 (m, 9H)

### Synthetic Example 17

R—COOH (7.2 g), allylamine (0.4 g), 1-(3-dimethylaminopropyl)-3-ethylcarbodiimide hydrochloride (1.36 g), 4-dimethylaminopyridine (60 mg), and dichloromethane (30 mL) were mixed and stirred at room temperature overnight. The mixed solution was diluted with dichloromethane, washed with hydrochloric acid and water, and then concentrated under reduced pressure to obtain Compound (17): R—CONHCH₂CH═CH₂ (7.0 g). Note that R— is (CH₃)₃Si—(OSi(CH₃)₂)ₙ—(CH₂)₁₀—. The average value of the number of repeating units, n, is 19.

### Compound (17)

¹H NMR (CDCl₃, 400 MHz) δ [ppm]: -0.01-0.30 (m), 0.49-0.53 (m, 2H), 1.20-1.40 (m, 14H), 1.55-1.68 (m, 2H), 2.13-2.35 (m, 2H) 3.86-3.89 (m, 2H), 5.05-5.23 (m, 2H), 5.68-5.84 (m, 1H).

R—CONHCH₂CH═CH₂ (5 g), toluene (20 mL), a solution of Karstedt's catalyst in xylene (2%, 0.7 mL), aniline (0.12 g), and trimethoxysilane (1.20 mL) were mixed and stirred at room temperature overnight, and then concentrated under reduced pressure to obtain Compound C: R—CONH—CH₂CH₂CH₂Si(OCH₃)₃ (4.7 g). Note that R is (CH₃)₃Si—(OSi(CH₃)₂)ₙ—(CH₂)₁₀—. The average value of the number of repeating units, n, is 19.

### Compound C

¹H NMR (CDCl₃, 400 MHz) δ [ppm]: −0.01-0.30 (m), 0.509-0.55 (m, 2H), 1.23-1.44 (m, 14H), 1.49-1.60 (m, 4H), 2.13-2.35 (m, 2H), 3.17-3.25 (m, 2H), 3.55-59 (m, 9H).

### Synthetic Example 18

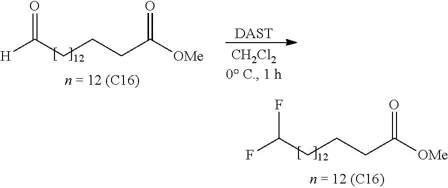

Methyl 16-formylhexadecanoate (5.7 g, 20 mmol), synthesized based on The Journal of Organic Chemistry 2019, 84, 8019-8026, was dissolved in dichloromethane (120 mL), the reaction vessel was cooled to 0° C. in an ice bath, and then DAST (diethylaminosulfur trifluoride) (3.8 mL, 90%, 26 mmol) was slowly added to the solution. After stirring at 0° C. for 1 hour, the reaction was terminated by the addition of water. The contents were transferred to a separatory funnel, diluted with chloroform, extracted, and dried over anhydrous magnesium sulfate. Thereafter, purification by silica gel column chromatography was performed to obtain Compound (18) as a colorless oily substance (2.9 g, 48%).

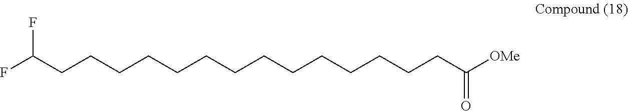 [SMILES: COC(=O)CCCCCCCCCCCCCCC(F)F]

¹H NMR (400 MHz, CDCl₃) δ [ppm]: 5.78 (tt, J=4.8, 49.1 Hz, 1H), 3.67 (s, 3H), 2.23 (t, J=7.0 Hz, 2H), 1.88-1.72 (m, 2H), 1.70-1.54 (m, 2H), 1.49-1.37 (m, 2H), 1.38-1.22 (brs, 20H).

¹⁹F NMR (375 MHz, CDCl₃) δ [ppm]: −115.6 (td, J=18.0, 49.1 Hz, 2F).

### Synthetic Example 19

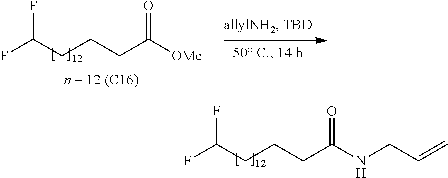

Compound (18) (900 mg, 2.9 mmol) obtained in Synthetic Example 18, allylamine (allyl NH₂) (500 mg, 8.8 mmol), and 1,5,7-triazabicyclo[4.4.0]dec-5-ene (TBD) (400 mg, 2.9 mmol) were mixed, and the reaction vessel was heated and stirred at 50° C. for 14 hours. After cooling, the volatile components were removed under reduced pressure, and the residue was purified by silica gel column chromatography to obtain Compound (19) as a colorless solid (950 mg, 100%).

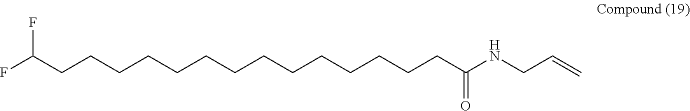 [SMILES: C=CCNC(=O)CCCCCCCCCCCCCCC(F)F]

¹H NMR (400 MHz, CDCl₃) δ [ppm]: 5.95-5.61 (m, 2H), 5.44 (s, 1H), 5.23-5.08 (m, 2H), 3.90-3.85 (m, 2H), 2.19 (t, J=7.8 Hz, 2H), 1.88-1.72 (m, 2H), 1.70-1.60 (m, 2H), 1.49-1.39 (m, 2H), 1.38-1.22 (brs, 20H).

¹⁹F NMR (375 MHz, CDCl₃) δ [ppm]: −115.6 (td, J=37.3, 19.9 Hz, 2F).

### Synthetic Example 20

0.703 g of CF₂H(CH₂)₁₄CONHCH₂CH═CH₂, which is Compound (19) obtained in Synthetic Example 19, 10.6 mL of toluene, 0.0843 g of pyridine, and 0.5 mL of a xylene solution containing a Pt complex of 1,3-divinyl-1,1,3,3-tetramethyldisiloxane at 2% were each added, 0.81 mL of trimethoxysilane was then charged, and the mixture was stirred at room temperature overnight. Thereafter, purification was performed, thereby obtaining 1.13 g of the following Compound (20), CF₂H(CH₂)₁₄CONHCH₂CH₂CH₂Si(OCH₃)₃, which has a trimethoxysilyl group at an end.

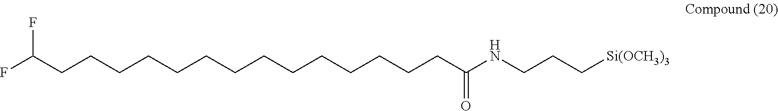

¹H NMR (CDCl₃, 400 MHz) δ [ppm]: 0.232-0.407 (m), 0.689-0.731 (m), 1.249-1.726 (m), 2.086-2.474 (m), 3.555-3.675 (m), 5.448-5.754 (tt)

### Synthetic Example 21

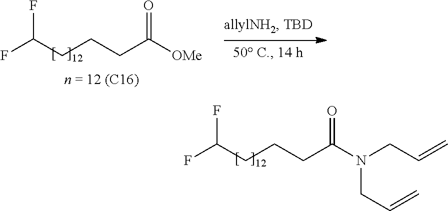

Compound (18) (900 mg, 2.9 mmol) obtained in Synthetic Example 18, diallylamine (allyl₂ NH) (630 mg, 6.5 mmol), and 1,5,7-triazabicyclo[4.4.0]dec-5-ene (400 mg, 2.9 mmol) were mixed, and the reaction vessel was heated and stirred at 50° C. for 14 hours. After cooling, the volatile components were removed under reduced pressure, and the residue was purified by silica gel column chromatography to obtain Compound (21) as an orange liquid (460 mg, 43%).

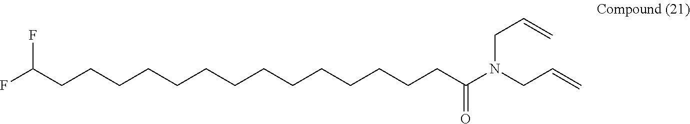 [SMILES: C=CCN(CC=C)C(=O)CCCCCCCCCCCCCCC(F)F]

¹H NMR (400 MHz, CDCl₃) δ [ppm]: 5.95-5.63 (m, 3H), 5.27-5.07 (m, 4H), 3.99 (d, J=5.9 Hz, 2H), 3.87 (d, J=5.0 Hz, 2H), 2.30 (t, J=7.8 Hz, 2H), 1.89-1.74 (m, 2H), 1.66-1.53 (m, 2H), 1.48-1.40 (m, 2H), 1.27, (d, J=11.4 Hz, 20H).

¹⁹F NMR (375 MHz, CDCl₃) δ [ppm]: −115.62 (td, J=38.0, 18.9 Hz, 2F).

### Synthetic Example 22

0.46 g of CF₂H(CH₂)₁₄CON(CH₂CH═CH₂)₂, which is Compound (21) obtained in Synthetic Example 21, 6.2 mL of toluene, 0.0489 g of pyridine, and 0.28 mL of a xylene solution containing a Pt complex of 1,3-divinyl-1,1,3,3-tetramethyldisiloxane at 2% were each added, 1.4 mL of trimethoxysilane was then charged, and the mixture was stirred at room temperature overnight. Thereafter, purification was performed, thereby obtaining 0.96 g of the following Compound (22), CF₂H(CH₂)₁₄CON(CH₂CH₂CH₂Si(OCH₃)₃)₂, which has trimethoxysilyl groups at ends.

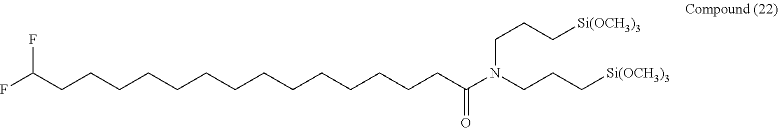

¹H NMR (CDCl₃, 400 MHz) δ [ppm]: 0.217-0.282 (m), 0.599-0.784 (m), 1.268-1.379 (m), 1.677-1.800 (m), 2.078-2.669 (m), 3.379-3.418 (m), 3.536-3.616 (m), 5.468-5.766 (tt)

### Synthetic Example 23

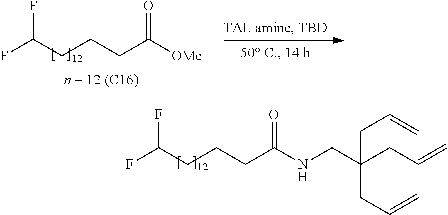

Compound (18) (750 mg, 2.4 mmol) obtained in Synthetic Example 18, 2,2-diallyl-4-penten-1-amine (800 mg, 4.8 mmol), and 1,5,7-triazabicyclo[4.4.0]dec-5-ene (400 mg, 2.9 mmol) were mixed, and the reaction vessel was heated and stirred at 50° C. for 14 hours. After cooling, the volatile components were removed under reduced pressure, and the residue was purified by silica gel column chromatography to obtain Compound (23) as an orange liquid (460 mg, 43%).

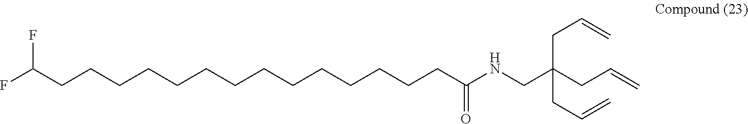 [SMILES: C=CCC(CC=C)(CC=C)CNC(=O)CCCCCCCCCCCCCCC(F)F]

¹H NMR (400 MHz, CDCl₃) δ [ppm]: 5.95-5.62 (m, 4H), 5.51 (s, 1H), 5.15-5.05 (m, 6H), 3.20 (d, J=6.4 Hz, 2H), 2.16 (d, J=7.5 Hz, 2H), 2.03 (d, J=7.3 Hz, 6H), 1.90-1.71 (m, 2H), 1.66-1.57 (m, 2H), 1.48-1.40 (m, 2H), 1.30-1.18 (m, 20H) ¹⁹F NMR (375 MHz, CDCl₃) δ [ppm]: -115.6 (td, J=37.3, 18.9 Hz, 2F).

### Synthetic Example 24

0.66 g of CF₂H(CH₂)₁₄CONHCH₂C(CH₂CH═CH₂)₃, which is Compound (23) obtained in Synthetic Example 23, 7.5 mL of toluene, 0.0558 g of pyridine, and 0.4 mL of a xylene solution containing a Pt complex of 1,3-divinyl-1,1,3,3-tetramethyldisiloxane at 2% were each added, 1.2 mL of trimethoxysilane was then charged, and the mixture was stirred at room temperature overnight. Thereafter, purification was performed, thereby obtaining 0.97 g of the following Compound (24), CF₂H(CH₂)₁₄CONHCH₂C(CH₂CH₂CH₂Si(OCH₃)₃)₃, which has trimethoxysilyl groups at ends.

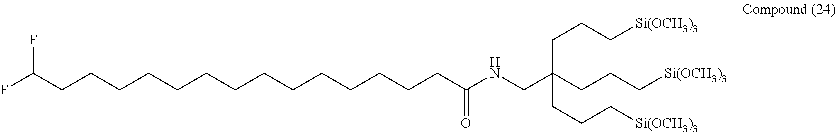

¹H NMR (CDCl₃, 400 MHz) δ [ppm]: 0.225-0.382 (m), 0.739-0.800 (m), 1.271-1.791 (m), 2.132-2.502 (m), 3.286-3.337 (m), 3.545-3.701 (m), 5.493-5.801 (tt)

### COMPARATIVE EXAMPLES

The following Compounds (A) to (C) were used.
Compound (A): KBM-3183E manufactured by Shin-Etsu Chemical Co., Ltd.
Compound (B): Compound B
Compound (C): Compound C

### <Formation of Formed Product 1 (Na Containing Intermediate Layer-Forming Material)>

2.2 g of sodium hydroxide (manufactured by FUJIFILM Wako Pure Chemical Corporation) was dissolved in 24 g of distilled water to obtain an 8.4 mass % aqueous sodium hydroxide solution. 24 g of this 8.4 mass % aqueous sodium hydroxide solution and 20 g of M.S.GEL (M.S.GEL D-100-60A (manufactured by AGC Si-Tech Co., Ltd.)) were mixed to allow the aqueous sodium hydroxide solution to be absorbed into M.S.GEL. M.S.GEL that absorbed the aqueous sodium hydroxide solution was dried at 25° C. for 8 hours, then formed with a tablet forming machine (4 MPa for 1 minute), and baked at 1,000° C. for 1 hour to obtain Formed Product 1 (pellets).

### <Formation of Surface-Treating Layer>

Surface-treating agents were synthesized by combining solvents and compounds as shown in Table 1 below. The compound concentration was set to 20 wt %. In the table below, EtOH represents ethanol and HMDSO represents hexamethyldisiloxane.

TABLE 1

| Ex./Comp. Ex. No. | Solvent | Compound No. |
|---|---|---|
| Ex. 1 | EtOH | 5 |
| Ex. 2 | EtOH | 7 |
| Ex. 3 | EtOH | 9 |
| Ex. 4 | EtOH | 11 |
| Ex. 5 | EtOH | 13 |
| Ex. 11 | EtOH | 20 |
| Ex. 12 | EtOH | 22 |
| Ex. 13 | EtOH | 24 |
| Comp. Ex. 1 | EtOH | A |
| Comp. Ex. 2 | EtOH | B |
| Comp. Ex. 3 | HMDSO | C |

The surface-treating agents were vacuum-deposited on a chemically tempered glass (“Gorilla” glass, manufactured by Corning Incorporated, thickness 0.7 mm). Specifically, a molybdenum boat in the vacuum deposition device was filled with 0.1 g of the surface-treating agent, and the vacuum deposition device was evacuated to a pressure of 3.0×10⁻³ Pa or lower. Thereafter, a silicon dioxide film with a thickness of 7 nm was formed, followed by heating the boat by the resistance heating scheme to form a surface-treating layer. Thereafter, a heating treatment was performed in an oven at 150° C. for 30 minutes to obtain a surface-treating layer.

Surface-treating agents were synthesized by combining solvents and compounds as shown in Table 2 below. The compound concentration was set to 20 wt %.

TABLE 2

| Ex./Comp. Ex. No. | Solvent | Compound No. |
|---|---|---|
| Ex. 6 | EtOH | 5 |
| Ex. 7 | EtOH | 7 |
| Ex. 8 | EtOH | 9 |
| Ex. 9 | EtOH | 11 |
| Ex. 10 | EtOH | 13 |
| Ex. 14 | EtOH | 20 |
| Ex. 15 | EtOH | 22 |
| Ex. 16 | EtOH | 24 |
| Comp. Ex. 4 | EtOH | A |
| Comp. Ex. 5 | EtOH | B |
| Comp. Ex. 6 | HMDSO | C |

The surface-treating agents were vacuum-deposited on a chemically tempered glass (“Gorilla” glass, manufactured by Corning Incorporated, thickness of 0.7 mm). Specifically, a molybdenum boat in the vacuum deposition device was filled with 0.1 g of the surface-treating agent, and the vacuum deposition device was evacuated to a pressure of 3.0×10⁻³ Pa or lower. Thereafter, using Formed Product 1, deposition was performed by the electron beam deposition scheme to form a Na containing silicon dioxide film with a thickness of 7 nm, followed by heating the boat by the resistance heating scheme to form a surface-treating layer. Thereafter, a heating treatment was performed in an oven at 150° C. for 30 minutes to obtain a surface-treating layer.

### <Evaluation>

### [Evaluation of Fingerprint Removability by Wiping]

For the surface-treating layers formed as described above, fingerprint adherability and fingerprint removability by wiping were evaluated according to the following procedures.

Haze (%) was used as an index for fingerprint adherability and fingerprint removability by wiping. Lower haze indicates that fingerprints are less visible. For the haze measurement, a haze meter NDH 7000SP manufactured by NIPPON DENSHOKU INDUSTRIES CO., LTD. was used. The substrate was placed such that the entire artificial fingerprint stamp region fell within the measurement region (Φ20 mm), and the average value of three measurements was used.

### (Initial Evaluation)

After the surface-treating layer was formed, the excess on the surface was wiped off with ethanol, and then haze was measured. This was defined as Ti.

### (Evaluation of Fingerprint Adherability)

An artificial fingerprint solution was stamped on the surface-treating layer after the initial evaluation, and the haze of the stamped section was measured. This was defined as T0, and T0−Ti was defined as fingerprint adherability.

Note that the compositional features of the artificial fingerprint solution and the stamping conditions are shown below.

### (Method for Preparing Artificial Fingerprint Solution)

The preparation of the artificial fingerprint solution was performed as follows, referring to JP 2006-120317 A.

1.6 g of KANTO (Japanese) loam (JIS Test Powders 1 (Class 11), The Association of Powder Process Industry and Engineering, Japan) and 32 g of methoxypropanol (manufactured by Tokyo Chemical Industry Co., Ltd.) were mixed. In addition, 4 g of triolein (manufactured by Tokyo Chemical Industry Co., Ltd.) was added and the mixture was stirred.

### (Method for Preparing Artificial Fingerprint Sheet)

A glass plate (“Gorilla” glass, manufactured by Corning Incorporated, thickness of 0.7 mm) was UV cleaned for 10 minutes. The glass plate was spin-coated (5,000 rpm for 10 seconds) with 1.1 mL of the artificial fingerprint solution prepared as described above. Thereafter, the glass was heated in a drying oven at 60° C. for 3 minutes.

### (Stamping Conditions)

### Stamp: Silicone Rubber (Stamping Surface 016 mm)

The stamp was pressed onto the artificial fingerprint sheet prepared as described above with a load of 5 kgw for 10 seconds to transfer the artificial fingerprint. The stamp on which the artificial fingerprint had been transferred was pressed against a sample for evaluating removability by wiping with a load of 5 kgw for 10 seconds to allow the artificial fingerprint solution to adhere to the sample.

### (Method for Testing Fingerprint Removability by Wiping)

For the formed surface-treating layer, a rubbing tester (manufactured by Imoto machinery Co., LTD) was used to perform a wiping operation 10 times under the following conditions. The haze of the stamped section was then measured. This was defined as T10, and T10−Ti was defined as fingerprint removability by wiping.

### Wiping Operation:

Friction block: BEMCOT M-3II (product name, manufactured by Asahi Kasei Corp.)
Moving distance (one way): 60 mm
Moving speed: 8,400 mm/min
Load: 1,000 g/3 cm²

The criteria for evaluation of fingerprint adherability and fingerprint removability by wiping are as follows.

### (Evaluation of Fingerprint Adherability)

Value of T0−Ti:
   Less than 5: 3 (excellent)
   5 or more and less than 10: 2 (good)
   10 or more: 1 (fair)

### (Evaluation of Fingerprint Removability by Wiping)

Value of T10−Ti:
   Less than 1: 3 (excellent)
   1 or more and less than 2.5: 2 (good)
   2.5 or more: 1 (fair)

### [Evaluation of Abrasion Resistance]

### (Method for Testing Abrasion Resistance)

After the surface-treating layer was formed, the excess on the surface was wiped off. Then, the following friction block was brought into contact with the formed surface-treating layer, a load of 5 N was applied thereon, and the friction block was reciprocated at a speed of 40 mm/second while applying the load. The static water contact angle (°) was measured at 100 friction times.

For the measurement of contact angle, a fully automatic contact angle meter DropMaster 700 (manufactured by Kyowa Interface Science Co., Ltd) was used under an environment of 25° C. Specifically, the measurement target, substrate having the surface-treating layer, was placed horizontally, 2 μL of water was dropped from a micro syringe onto its surface, and a static image was taken one second after the dropping with a video microscope to thereby measure the static contact angle.

The static contact angle was measured at five different points on the surface-treating layer of the substrate, and the average value calculated therefrom was used.

### Measurement Criteria

80° or higher: 4 (excellent)
65° or higher and lower than 80°: 3 (good)
50° or higher and lower than 65°: 2 (fair)
Lower than 50⁰: 1 (poor)

### Friction Block

The surface of the silicone rubber processed product shown below was covered with cotton soaked in artificial sweat having the compositional features shown below, and the product was used as a friction block.

### Silicone Rubber Processed Product:

Silicone rubber stopper SR-51 made of Tigers Polymer Corporation processed into a cylindrical shape having a diameter of 1 cm and a thickness of 1 cm.

### Compositional Features of Artificial Sweat:

Anhydrous disodium hydrogen phosphate: 2 g
Sodium chloride: 20 g
85% Lactic acid: 2 g
Histidine hydrochloride: 5 g
Distilled water: 1 kg

Table 3 and Table 4 below show the evaluation results of fingerprint adherability and fingerprint removability by wiping, as well as the evaluation results of abrasion resistance.

TABLE 3

| | Evaluation | Evaluation | Evaluation |
|---|---|---|---|
| Ex./Comp. | before wiping | after wiping | after abrasion |
| Ex. No. | T0-Ti | T10-Ti | resistance test |
| Ex. 1 | 2 | 2 | 2 |
| Ex. 2 | 3 | 3 | 2 |
| Ex. 3 | 3 | 3 | 2 |
| Ex. 4 | 2 | 2 | 3 |
| Ex. 5 | 3 | 3 | 3 |
| Ex. 11 | 3 | 3 | 2 |
| Ex. 12 | 3 | 3 | 2 |
| Ex. 13 | 3 | 3 | 3 |
| Comp. Ex. 1 | 1 | 1 | 3 |
| Comp. Ex. 2 | 1 | 1 | 3 |
| Comp. Ex. 3 | 2 | 2 | 1 |

TABLE 4

| | Evaluation | Evaluation | Evaluation |
|---|---|---|---|
| Ex./Comp. | before wiping | after wiping | after abrasion |
| Ex. No. | T0-Ti | T10-Ti | resistance test |
| Ex. 6 | 2 | 2 | 2 |
| Ex. 7 | 3 | 3 | 3 |
| Ex. 8 | 3 | 3 | 3 |
| Ex. 9 | 2 | 2 | 4 |
| Ex. 10 | 3 | 3 | 4 |
| Ex. 14 | 3 | 3 | 3 |
| Ex. 15 | 3 | 3 | 4 |
| Ex. 16 | 3 | 3 | 4 |
| Comp. Ex. 4 | 1 | 1 | 3 |
| Comp. Ex. 5 | 1 | 1 | 4 |
| Comp. Ex. 6 | 2 | 2 | 1 |

### INDUSTRIAL APPLICABILITY

The compound of the present disclosure can be suitably utilized in a variety of diverse applications.

1. A fluorine atom containing silane compound represented by the following formula (1):
(Rf¹)_{α1}—X^{A}—(R^{Si})_{α2} (1)
wherein
Rf¹ each independently has at least one group selected from a monovalent organic group represented by A¹_{γ11}A²_{γ12}C—X^{B}— and having a monovalent organic group containing a cyclic structure containing CF≡;
A¹ is a fluorine atom;
A² is each independently a hydrogen atom, a chlorine atom, or a bromine atom;
γ11 is each independently 1 or 2;
γ12 is each independently 1 or 2;
the sum of γ11 and γ12 is 3;
X^{B} is
a single bond,
a divalent group containing a polysiloxane group, or
a group represented by —(CR^{A}ₑ₁H₂₋ₑ₁)ₐ₁—(CFH)_{b1}—(CH₂)_{c1}—(O)_{d1}—,
R^{A1} is a monovalent organic group having A¹_{γ11}A²_{γ12}C—;
e1 is 1 or 2;
a1 is an integer of 0 to 200;
b1 is an integer of 0 to 200;
c1 is an integer of 0 to 200;
d1 is an integer of 0 to 200;
the occurrence order of the respective repeating units enclosed in parentheses provided with the signs a1, b1, c1, and d1 is not limited;
X^{A} is each independently a single bond, an oxygen atom, —(X⁵²)₁₅—R⁵²— or a group represented by the following formula (X^{A1}): 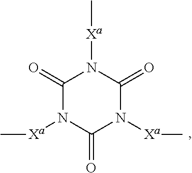
X⁵² is each independently a group selected from the group consisting of —O—, —S—, o-, m- or p-phenylene group, —CO—, —C(O)O—, —OC(O)—, —CONR⁵³—, —NR⁵³CO—, —O—CONR⁵³—, —NR⁵³CO—O—, —NR⁵³CONR⁵³—, —NR⁵³—, and —(CH₂)ₙ₅—;
R⁵³ is each independently a hydrogen atom or a monovalent organic group;
n5 is each independently an integer of 1 to 200;
l5 is an integer of 1 to 10; and
X^{a} is each independently a single bond or a divalent linking group;
expecting for X^{A} and X^{B} are single bonds;
R^{Si} is a monovalent group containing a Si atom to which a hydroxyl group or a hydrolyzable group is bonded and a group represented by the following formula (S1), (S2), (S3), (S4), or (S5): 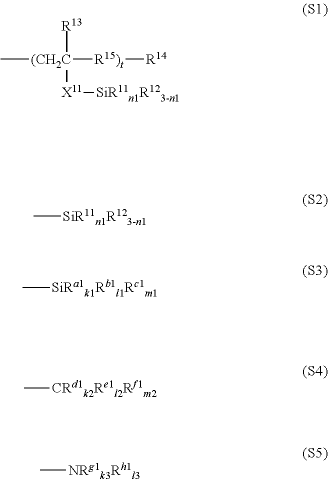
wherein
R¹¹ is each independently a hydroxyl group or a hydrolyzable group;
R¹² is each independently a monovalent organic group;
n1 is each independently an integer of 0 to 3 for each (SiR¹¹ₙ₁R¹²₃₋ₙ₁) unit;
X¹¹ is each independently a single bond or a divalent organic group;
R¹³ is each independently a hydrogen atom or a monovalent organic group;
t is each independently an integer of 2 or more;
R¹⁴ is each independently a hydrogen atom, a halogen atom, or —X¹¹—SiR¹¹ₙ₁R¹²₃₋ₙ₁;
R¹⁵ is each independently a single bond, an oxygen atom, an alkylene group having 1 to 6 carbon atoms, or an alkyleneoxy group having 1 to 6 carbon atoms;
R^{a1} is each independently —Z^{1′}—SiR^{21′}_{p1′}R^{22′}_{q1′}R^{23′}_{r1′};
Z¹ is each independently a divalent organic group;
R²¹ is each independently —Z^{1′}—SiR^{21′}_{p1′}R^{22′}_{q1′}R^{23′}_{r1′};
R²² is each independently a hydroxyl group or a hydrolyzable group;
R²³ is each independently a monovalent organic group;
p1 is each independently an integer of 0 to 3;
q1 is each independently an integer of 0 to 3;
r1 is each independently an integer of 0 to 3;
Z^{1′} is each independently a divalent organic group;
R^{21′} is each independently —Z^{1″}—SiR^{22″}_{q1″}R^{23″}_{r1″};
R^{22′} is each independently a hydroxyl group or a hydrolyzable group;
R^{23′} is each independently a monovalent organic group;
p1′ is each independently an integer of 0 to 3;
q1′ is each independently an integer of 0 to 3;
r1′ is each independently an integer of 0 to 3;
Z^{1″} is each independently a divalent organic group;
R^{22″} is each independently a hydroxyl group or a hydrolyzable group;
R^{23″} is each independently a monovalent organic group;
q1″ is each independently an integer of 0 to 3;
r1″ is each independently an integer of 0 to 3;
R^{b1} is each independently a hydroxyl group or a hydrolyzable group;
R^{c1} is each independently a monovalent organic group;
k1 is each independently an integer of 0 to 3;
l1 is each independently an integer of 0 to 3;
m1 is each independently an integer of 0 to 3;
R^{d1} is each independently —Z²—CR³¹ₚ₂R³²_{q2}R³³ᵣ₂;
Z² is each independently a single bond, an oxygen atom, or a divalent organic group;
R³¹ is each independently —Z^{2′}—CR^{32′}_{q2′}R^{33′}_{r2′};
R³² is each independently —Z³—SiR³⁴ₙ₂R³⁵₃₋ₙ₂;
R³³ is each independently a hydrogen atom, a hydroxyl group, or a monovalent organic group;
p2 is each independently an integer of 0 to 3;
q2 is each independently an integer of 0 to 3;
r2 is each independently an integer of 0 to 3;
Z^{2′} is each independently a single bond, an oxygen atom, or a divalent organic group;
R^{32′} is each independently —Z³—SiR³⁴ₙ₂R³⁵₃₋ₙ₂;
R^{33′} is each independently a hydrogen atom, a hydroxyl group, or a monovalent organic group;
q2′ is each independently an integer of 0 to 3;
r2′ is each independently an integer of 0 to 3;
Z³ is each independently a single bond, an oxygen atom, or a divalent organic group;
R³⁴ is each independently a hydroxyl group or a hydrolyzable group;
R³⁵ is each independently a monovalent organic group;
n2 is each independently an integer of 0 to 3;
R^{e1} is each independently —Z³—SiR³⁴ₙ₂R³⁵₃₋ₙ₂;
Rf¹ is each independently a hydrogen atom, a hydroxyl group, or a monovalent organic group;
k2 is each independently an integer of 0 to 3;
l2 is each independently an integer of 0 to 3;
m2 is each independently an integer of 0 to 3;
R^{g1} and R^{h1} are each independently —Z⁴—SiR¹¹ₙ₁R¹²₃₋ₙ₁, —Z⁴—SiR^{a1}ₖ₁R^{b1}₁₁R^{c1}ₘ₁, or —Z⁴—CR^{d1}ₖ₂R^{e1}₁₂R^{f1}ₘ₂;
Z⁴ is each independently a single bond, an oxygen atom, or a divalent organic group;
k3 is 1 or 2; and
l3 is 0 or 1,
provided that in the formula (S1), (S2), (S3), (S4), or (S5), at least two Si atoms to which a hydroxyl group or a hydrolyzable group is bonded are present; and
provided that
X^{A} is a single bond, an oxygen atom, —(X⁵²)₁₅—R⁵²—, α1 and α2 is 1, and
X^{A} is represented by formula (X^{A1}), α1 is 1 or 2, α2 is 1 or 2, and the sum of α1 and α2 is 3.

2. The fluorine atom containing silane compound according to claim 1, wherein X^{B} is a group represented by —(CR^{A1}ₑ₁H₂₋ₑ₁)ₐ₁—(CFH)_{b1}—(CH₂)_{c1}—(O)_{d1}—
wherein
R^{A1} is a monovalent organic group having A¹_{γ11}A²_{γ12}C—;
A¹, A², γ11, γ12, e1, a1, b1, c1, and d1 are the same as defined in claim 1; and
the occurrence order of the respective repeating units enclosed in parentheses provided with the signs a1, b1, c1, and d1 is not limited.

3. The fluorine atom containing silane compound according to claim 1, wherein X^{B} is a group represented by —(CFH)_{b1}—(CH₂)_{c1}—(O)_{d1}—
wherein
b1 and c1 are the same as defined in claim 1;
d1 is an integer of 0 to 10; and
the occurrence order of the respective repeating units enclosed in parentheses provided with the signs b1, c1, and d1 is not limited.

4. The fluorine atom containing silane compound according to claim 1, wherein X^{B} is a group represented by —(CH₂)_{c1}—
wherein c1 is an integer of 0 to 30.

5. The fluorine atom containing silane compound according to claim 1, wherein X^{B} is a group represented by —O—(CH₂)_{c1}—
wherein c1 is an integer of 0 to 30.

6. The fluorine atom containing silane compound according to claim 1, wherein X^{B} is a group represented by —(CH₂)_{g1}—SiR^{s}₂O(—SiR^{s}₂O—)ₙ₁₁SiR^{s}₂—(CH₂)_{g1}—
wherein
R^{s} is each independently a hydrogen atom, a hydroxyl group, or a hydrocarbon group;
n11 is an integer of 1 to 1,500; and
g1 is each independently an integer of 0 to 30.

7. The fluorine atom containing silane compound according to claim 1, wherein A¹_{y11}A²_{y12}C— is HCF₂—.

8. The fluorine atom containing silane compound according to claim 1, wherein X^{A} is a single bond, —(X⁵²)₁₅—, or a group represented by the following formula (X^{A1}): 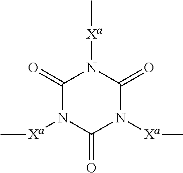
wherein
X⁵² is each independently a group selected from the group consisting of —O—, —S—, o-, m- or p-phenylene group, —CO—, —C(O)O—, —OC(O)—, —CONR⁵³—, —NR⁵³CO—, —O—CONR⁵³—, —NR⁵³CO—O—, —NR⁵³CONR⁵³—, —NR⁵³—, and —(CH₂)ₙ₅—;
R⁵³ is each independently a hydrogen atom or a monovalent organic group;
n5 is each independently an integer of 1 to 30;
l5 is an integer of 1 to 10; and
X^{a} is each independently a single bond or a divalent linking group.

9. A surface-treating agent comprising the fluorine atom containing silane compound according to claim 1.

10. The surface-treating agent according to claim 9, further comprising a condensed product of the fluorine atom containing silane compound.

11. The surface-treating agent according to claim 9, further comprising an alcohol represented by R⁹⁰—OH wherein R⁹⁰ is a monovalent organic group.

12. The surface-treating agent according to claim 9, which is for vacuum deposition.

13. The surface-treating agent according to claim 9, which is for wet coating.

14. A pellet comprising the surface-treating agent according to claim 9.

15. An article comprising a substrate and a layer on the substrate, the layer being formed from the fluorine atom containing silane compound according to claim 1.

16. The article according to claim 15, comprising an intermediate layer containing silicon oxide between the substrate and the layer.

17. The article according to claim 16, wherein the intermediate layer comprises alkali metal atoms.

18. The article according to claim 17, wherein at least a portion of the alkali metal atoms are sodium.

19. The article according to claim 15, which is an optical member.

20. The article according to claim 19, which is a display.
